(19) United States
(12) Patent Application Publication
(10) Pub. No.: US 2013/0286160 A1
(43) Pub. Date: Oct. 31, 2013

(54) VIDEO ENCODING DEVICE, VIDEO ENCODING METHOD, VIDEO ENCODING PROGRAM, VIDEO PLAYBACK DEVICE, VIDEO PLAYBACK METHOD, AND VIDEO PLAYBACK PROGRAM

(71) Applicants: Taiji Sasaki, Osaka (JP); Hiroshi Yahata, Osaka (JP); Tomoki Ogawa, Osaka (JP); Tadamasa Toma, Osaka (JP)

(72) Inventors: Taiji Sasaki, Osaka (JP); Hiroshi Yahata, Osaka (JP); Tomoki Ogawa, Osaka (JP); Tadamasa Toma, Osaka (JP)

(73) Assignee: Panasonic Corporation, Osaka (JP)

(21) Appl. No.: 13/979,945

(22) PCT Filed: Feb. 15, 2012
(86) PCT No.: PCT/JP2012/000988

§ 371 Date: Jul. 16, 2013

Related U.S. Application Data
(60) Provisional application No. 61/443,804, filed on Feb. 17, 2011.

(51) Int. Cl. H04N 13/00

(52) U.S. Cl. CPC H04N 13/0048
USPC 348/43

(57) ABSTRACT

Provided is a video encoding device and a video playback device, the video encoding device encoding 3D video images in a manner that suppresses an increase in the necessary band, while maintaining playback compatibility with playback devices configured for the MPEG-2 standard. A data creation device 5601 as a video encoding device includes: a 2D compatible video encoder 5602 generating a stream in the MPEG-2 format by compression-encoding left-view video images pertaining to multi-view video images; an extended video encoder 5606 generating a stream conforming to the MPEG-4 AVC format by compression-encoding pictures of right-view video images pertaining to the multi-view video images, each picture of the right-view video images being compression-encoded with reference to a picture, from among pictures in the stream in the MPEG-2 format, to be presented at the same time as the picture of the right-view video images; and a multiplexer 5607 multiplexing the generated streams.

### TECHNICAL FIELD

The present invention relates to a technology for encoding and decoding 3D video images, and in particular to a technology for maintaining playback compatibility with 2D video images.

### BACKGROUND ART

In recent years, opportunities for viewing 3D video images in locations such as movie theaters have increased. Accordingly, there has been an increased demand for viewing of 3D video images on household digital televisions and the like. In order to broadcast 3D video images for household digital televisions and the like, it is necessary to collectively compression-encode video images from multiple viewpoints such as left-view video images and right-view video images. Use of a revised MPEG-4 AVC/H.264 standard (Non-Patent Literature 1), referred to as MPEG-4 MVC (Moving Picture Experts Group-4 Multiview Video Coding), can collectively encode such video images from multiple viewpoints.

However, playback devices for digital television broadcasting that are prevalent in the market handle video images that are compression-encoded according to the MPEG-2 standard. This poses a problem of playback compatibility where such playback devices cannot receive and play back broadcast video images that are compression-encoded according to the MPEG-4 MVC standard. This problem of playback compatibility can be avoided by: compression-encoding regular 2D video images according to MPEG-2; compression-encoding 3D video images according to MPEG-4; multiplexing these compression-encoded video images; and broadcasting the multiplexed video images.

### CITATION LIST

### Non-Patent Literature

### [Non-Patent Literature 1]

ISO/IEC 14496-10 “MPEG-4 Part 10 Advanced Video Coding”

### SUMMARY OF INVENTION

### Technical Problem

However, suppose that a set of video images encoded according to MPEG-2 and a set of video images encoded according to MPEG-4 are simply multiplexed and broadcast. In this case, the necessary broadcast band is the sum of the bands necessary to broadcast these sets of video images. This broadcast band is larger than the band necessary to broadcast only one of the sets of video images. This does not only apply to the case of broadcasting, but also to the case of storing a set of video images encoded according to MPEG-2 and a set of video images encoded according to MPEG-4 onto a single recording medium or the like. In this case, the necessary storage capacity for the recording medium is the sum of the storage capacities necessary to store these sets of video images. This storage capacity is larger than the storage capacity necessary to store only one of the sets of video images.

The present invention has been achieved in view of the above problems, and an aim thereof is to provide a video encoding device and a video playback device, the video encoding device encoding 3D video images in a manner that suppresses an increase in the amount of necessary data, while maintaining playback compatibility with playback devices configured for the MPEG-2 standard.

### Solution to Problem

In order to solve the above problems, the present invention provides a video encoding device for compression-encoding multi-view video images including first view video images and second view video images, comprising: a first encoding unit configured to generate a stream in an MPEG-2 format by compression-encoding the first view video images; a second encoding unit configured to generate a stream conforming to an MPEG-4 AVC format by compression-encoding pictures of the second view video images, each picture of the second view video images being compression-encoded with reference to a picture, from among pictures in the stream in the MPEG-2 format, to be presented at the same time as the picture of the second view video images; and a transmission unit configured to transmit the streams generated by the first encoding unit and the second encoding unit.

### Advantageous Effects of Invention

With the above structure, the video encoding device according to the present invention can compression-encode multi-view video images (e.g., 3D video images) in a manner that suppresses an increase in the amount of necessary data as compared to conventional technologies, while maintaining playback compatibility with first view video images (e.g., 2D video images) played back by a playback device configured for the MPEG-2 standard.

### BRIEF DESCRIPTION OF DRAWINGS

FIG. 1 illustrates the reference relationship for pictures in a video stream.

FIG. 2 illustrates an encoding method in an MPEG-4 MVC format.

FIG. 3 illustrates picture reference in a case where a codec for base-view differs from a compression encoding method for dependent-view.

FIG. 4 illustrates an example of generating parallax images from a 2D video image and a depth map, the parallax images consisting of a left-view video image and a right-view video image.

FIGS. 5A to 5D illustrate usage forms of playback devices.

FIG. 6 illustrates the structure of a digital stream in a transport stream format.

FIG. 7 illustrates the structure of a video stream.

FIG. 8 illustrates cropping region information and scaling information.

FIG. 9 illustrates an example of a method for designating cropping region information and scaling information.

FIG. 10 illustrates the structure of a PES packet.

FIG. 11 illustrates the data structure of TS packets constituting a transport stream.

FIG. 12 illustrates the data structure of a PMT.

FIG. 13 illustrates an example of display of a stereoscopic video image.

FIG. 14 illustrates a Side-by-Side method.

FIG. 15 illustrates a stereoscopic method in a multi-view encoding format.

FIG. 16 illustrates the internal structure of a video access unit in the video stream.

FIG. 17 illustrates the structure of the video access unit in each picture of the base-view video stream and each picture of the right-view video image video stream.

FIG. 18 illustrates the relationship between a PTS and a DTS allocated to each video access unit in the base-view video stream and the dependent-view video stream.

FIG. 19 illustrates the GOP structure in the base-view video stream and the dependent-view video stream.

FIG. 20 illustrates the structure of the video access units included in a dependent GOP.

FIG. 21 illustrates the data structure of the transport stream.

FIG. 22 illustrates video attributes that are made identical, as well as the names of the fields for the video attributes, when the codec used is MPEG-2 video for the 2D compatible video stream and MPEG-4 MVC for the multi-view video stream.

FIG. 23 illustrates an example of the relationship between the picture type and the PTS and DTS allocated to each video access unit in the 2D compatible video stream, the base-view video stream, and the dependent-view video stream in the transport stream.

FIG. 24 illustrates a picture type relationship, between the 2D compatible video stream, the base-view video stream, and the dependent-view video stream, that is beneficial for facilitating trickplay.

FIG. 25 illustrates the GOP structure in the 2D compatible video stream, the base-view video stream, and the dependent-view video stream.

FIG. 26 illustrates a data creation device according to Embodiment 1.

FIG. 27 illustrates a data creation flow of the data creation device according to Embodiment 1.

FIG. 28 illustrates the structure of a playback device for playing back 3D video images according to Embodiment 1.

FIG. 29 illustrates a video decoder and a multi-view video decoder.

FIG. 30 illustrates the flow of decoding and output of 3D video images in the playback device according to Embodiment 1.

FIG. 31 illustrates management of an inter-view reference buffer in the 3D video image playback device according to Embodiment 1.

FIG. 32 illustrates a modification to management of the inter-view reference buffer in the 3D video image playback device according to Embodiment 1.

FIG. 33 illustrates a method for sharing a buffer in the 3D video image playback device according to Embodiment 1.

FIG. 34 illustrates a modification to video image output in the 3D video image playback device according to Embodiment 1.

FIG. 35 illustrates a modification to the method of assigning the PTS and the DTS to the transport stream for 3D video images according to Embodiment 1.

FIG. 36 illustrates the relationship between the structure of the transport stream and PMT packets.

FIG. 37 illustrates the structure of a 3D information descriptor.

FIG. 38 illustrates the playback format in the 3D information descriptor.

FIG. 39 illustrates the structure of a 3D stream descriptor.

FIG. 40 illustrates a switching method that conforms to the playback format of the 3D video image playback device according to the present embodiment.

FIG. 41 illustrates the relationship between the playback format, an inter-codec reference switch, and a plane selector.

FIG. 42 illustrates a 2D transition interval for a smooth transition when switching the playback format.

FIG. 43 illustrates an encoding device in a case where a high-definition filter is applied to the results of decoding the 2D compatible video stream.

FIG. 44 illustrates a playback device in a case where a high-definition filter is applied to the results of decoding the 2D compatible video stream.

FIG. 45 illustrates the structure of the 3D video image playback device according to the present embodiment in a case where the base-view video and the dependent-view video are transmitted in the same stream.

FIG. 46 illustrates the playback device in a case where the base-view video is MPEG-4AVC.

FIG. 47 illustrates the data structure of the transport stream according to Embodiment 2.

FIG. 48 illustrates a method for generating differential video images and a method for decompressing 3D video images using differential video images.

FIG. 49 illustrates a usage form according to Embodiment 2.

FIG. 50 illustrates the relationship between the structure of the transport stream and PMT packets according to Embodiment 2.

FIG. 51 illustrates the structure of a 3D information descriptor according to Embodiment 2.

FIG. 52 illustrates a playback format according to Embodiment 2.

FIG. 53 illustrates the structure of a 3D stream descriptor according to Embodiment 2.

FIG. 54 illustrates a method of assigning the PTS and the DTS to the transport stream for 3D video images according to Embodiment 2.

FIG. 55 illustrates the GOP structure of the 2D compatible video stream and the extended video stream according to Embodiment 2.

FIG. 56 illustrates the structure of a data creation device according to Embodiment 2.

FIG. 57 illustrates a data creation flow of the data creation device according to Embodiment 2.

FIG. 58 shows the structure of a playback device according to Embodiment 2.

FIG. 59 illustrates the flow of playback of 3D video images by the playback device according to Embodiment 2.

FIG. 60 illustrates a switching method in the playback device according to Embodiment 2.

FIG. 61 illustrates the operations of a differential video image combination switch according to the playback format in the playback device according to Embodiment 2.

FIG. 62 is a modification of Embodiment 2 and illustrates a method for generating differential video images from left-view original video images and right-view original video images.

FIG. 63 illustrates the structure in which a high-definition filter is applied to the data creation device according to Embodiment 2.

FIG. 64 illustrates the structure in which a high-definition filter is applied to the playback device according to Embodiment 2.

FIG. 65 is a modification of Embodiment 2 and illustrates a data creation method and a data playback method in a case where each of the differential video images is divided into two video images.

FIG. 66 illustrates a generation method and a decoding method for the differential video images according to Embodiment 2.

FIG. 67 illustrates the generation method and the decoding method for the differential video images according to Embodiment 2.

FIG. 68 illustrates the generation method and the decoding method for the differential video images according to Embodiment 2.

FIG. 69 illustrates the generation method and the decoding method for the differential video images according to Embodiment 2.

FIG. 70 illustrates the generation method and the decoding method for the differential video images according to Embodiment 2.

FIG. 71 is a modification of Embodiment 2 and illustrates a data structure allowing for provision of higher definition to the 2D video images.

FIG. 72 illustrates a method for generating differential video images by shifting video images according to a modification of Embodiment 2.

FIG. 73 illustrates a playback device according to a modification of Embodiment 2.

FIG. 74 illustrates the structure of a video stream according to a modification of Embodiment 2.

FIG. 75 illustrates an outline of the structures of an encoding device and a playback device according to a modification of Embodiment 2.

### DESCRIPTION OF EMBODIMENTS

### 1. Embodiment 1

<1-1. Overview>

A broadcast system pertaining to Embodiment 1 of the present invention generates, as 2D video images, streams in the MPEG-2 format, which is the conventional technology, and, as 3D video images, base-view video streams and dependent-view video streams in a new format (referred to as a format conforming to the MPEG-4 MVC format in the present description) obtained by extending the MPEG-4 MVC format, and transmits these streams.

At a receiving end, a 2D playback unit included in the playback device decodes the streams in the MPEG-2 format by using a conventional decoding method for playback, and a 3D playback unit included in the playback device decodes the base-view video streams and the dependent-view video streams in the format conforming to the MPEG-4 MVC format by using a decoding method supporting the new encoding method for playback.

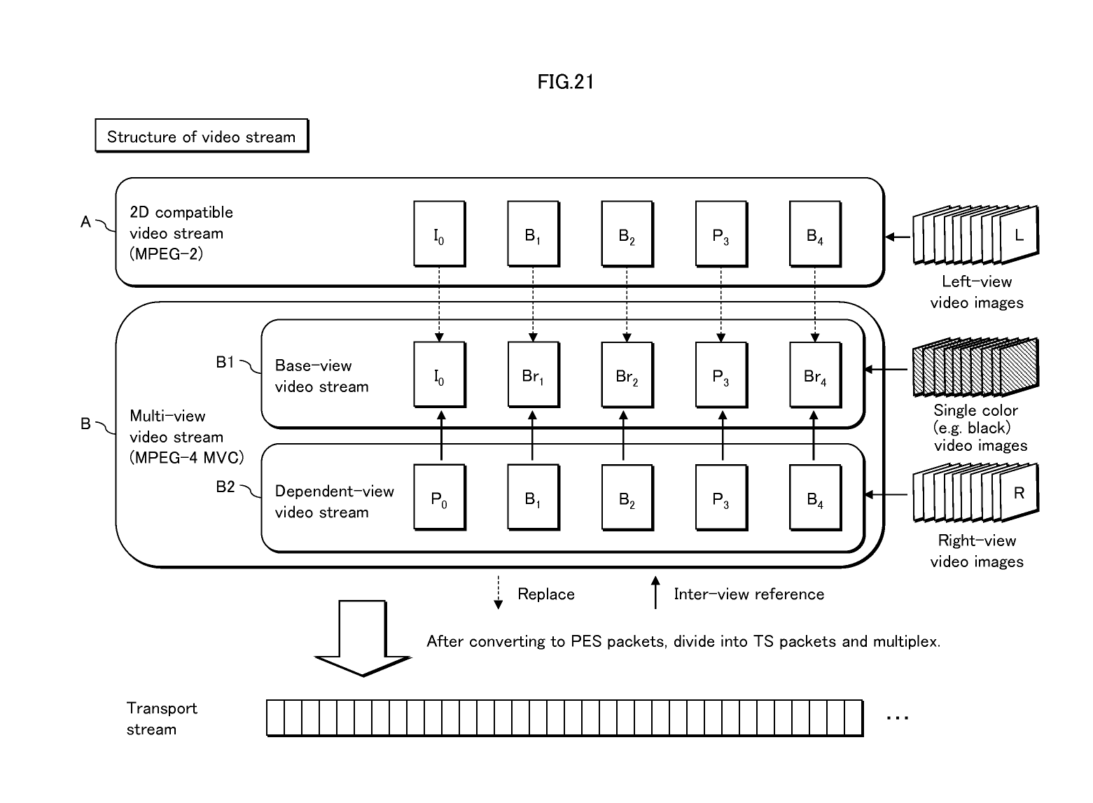

FIG. 21 illustrates the data structure of a transport stream generated by the broadcast system pertaining to Embodiment 1. As illustrated in FIG. 21, the transport stream includes a 2D compatible video stream A and a multi-view video stream B. The multi-view video stream B includes a base-view video stream B1 and a dependent-view video stream B2. The 2D compatible video stream A is generated by performing compression encoding on left-view images, and the base-view video stream B1 is generated by performing compression encoding on images of a single color, such as black, (hereinafter, referred to as “black images”). Furthermore, the dependent-view video stream B2 is generated by performing compression encoding on the difference between the left-view images and right-view images. The base-view video stream B1 cannot be used as reference images for generating the dependent-view video stream B2, as the base-view video stream B1 has been generated by performing compression encoding on the black images as described above. The format conforming to the MPEG-4 MVC is different from the existing MPEG-4 MVC format in this respect, and the reference images are set to frame images, at the same time, of the 2D compatible video stream A.

By using such streams in the format conforming to the MPEG-4 MVC format, it is possible to transmit both of the 2D video images and the 3D video images, and to reduce the bit rate significantly as the base-view video stream B1 has been generated by performing compression encoding on the black images. As a result, both of the 2D video images and the 3D video images can be transmitted within a conventionally allocated frequency band. When streams generated by performing compression encoding in the MPEG-4 MVC format are decoded, the dependent-view video stream is decoded by referring to the frame images of the base-view video stream. In Embodiment 1, however, the dependent-view video stream is decoded by using the frame images of the MPEG-2 compatible stream, i.e. left-view images, as the reference images. Specifically, the format conforming to the MPEG-4 MVC stipulates a descriptor and the like for instructing a playback end to switch a reference target for decoding from the base-view video stream to the MPEG-2 compatible video stream.

The following describes a data creation device and a playback device pertaining to Embodiment 1 of the present invention with reference to the drawings.

<1-2. Data Creation Device>

<1-2-1. Structure>

The following describes the data creation device pertaining to Embodiment 1 of the present invention with reference to the drawings.

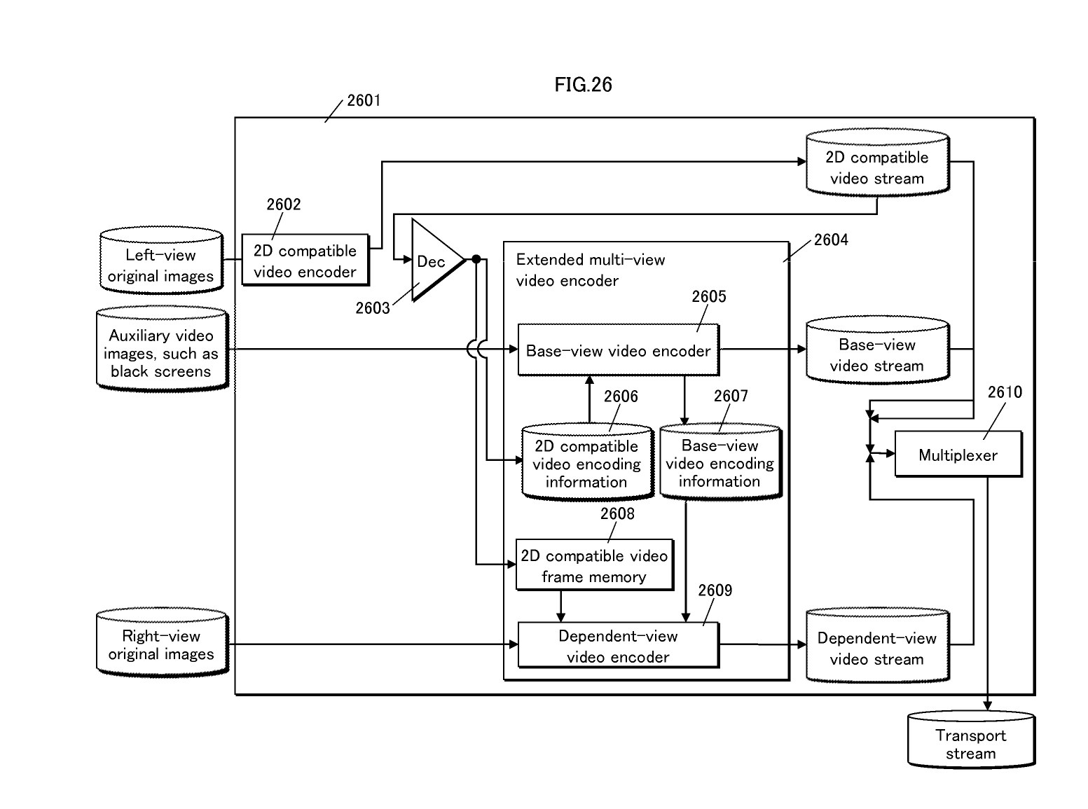

FIG. 26 is a block diagram showing the functional structure of a data creation device 2601 pertaining to Embodiment 1.

The data creation device 2601 receives input of left-view images and right-view images constituting 3D video images, and black images, and outputs a transport stream including a 2D compatible video stream, a base-view video stream, and a dependent-view video stream in a data format described later.

The data creation device 2601 includes a 2D compatible video encoder 2602, a Dec (2D compatible video decoder) 2603, an extended multi-view video encoder 2604, and a multiplexer 2610.

The extended multi-view video encoder 2604 includes a base-view video encoder 2605, a 2D compatible video frame memory 2608, and a dependent-view video encoder 2609.

The 2D compatible video encoder 2602 receives input of left-view images, performs compression encoding on the left-view images in the MPEG-2 format to generate a 2D compatible video stream, and outputs the 2D compatible video stream.

The Dec 2603 decodes compression-encoded pictures in the 2D compatible video stream, and outputs the resulting decoded pictures and 2D compatible video encoding information 2606. Pictures refer to images constituting a frame or a field, and are units of encoding. The decoded pictures are stored in the 2D compatible video frame memory 2608 included in the extended multi-view video encoder 2604. The 2D compatible video encoding information 2606 is input into the base-view video encoder 2605.

The 2D compatible video encoding information 2606 includes therein attribute information on the decoded 2D compatible video stream (resolution, aspect ratio, frame rate, progressive/interlaced, and the like), picture attribute information for the picture (picture type and the like), GOP (Group of Pictures) structure, 2D compatible video frame memory management information, and the like.

The 2D compatible video frame memory management information is information for associating a memory address of each decoded picture stored in the 2D compatible video frame memory 2608 with information on a presentation order of the picture (PTS (Presentation Time Stamp) or temporal_reference) and information on an encoding order (encoding order of the file or a DTS (Decoding Time Stamp))”.

The extended multi-view video encoder 2604 receives input of the decoded pictures and the 2D compatible video encoding information output from the Dec 2603, right-view images, and black images, performs compression encoding, and outputs the base-view video stream and the dependent-view video stream.

The base-view video encoder 2605 has a function to output, as the base-view video stream, data generated by performing compression encoding in the format conforming to the MPEG-4 MVC format. The base-view video encoder 2605 performs compression encoding on the black images in accordance with the 2D compatible video encoding information 2606, and outputs the base-view video stream and base-view video encoding information 2607.

The base-view video encoding information 2607 includes therein attribute information (resolution, aspect ratio, frame rate, progressive/interlaced, and the like) on the base-view video stream, picture attribute information for the picture (picture type and the like), GOP structure, base-view video frame memory management information, and the like.

When outputting the base-view video encoding information 2607, the base-view video encoder 2605 sets, as a value of the attribute information on the base-view video stream, the same value as the attribute information on a video included in the 2D compatible video encoding information 2606. Furthermore, in accordance with the picture attribute information (picture type and the like) and the GOP structure included in the 2D compatible video encoding information 2606, the base-view video encoder 2605 determines the picture type when compression encoding is performed on pictures at the same presentation time and performs compression encoding on the black images. For example, if the picture type of a picture indicated by the 2D compatible video encoding information 2606 at time “a” is an I picture and the picture is at the top of a GOP, the base-view video encoder 2605 performs compression encoding on a black image having the same presentation time so that the black image is an I picture and a video access unit at the top of a GOP in the base-view video stream.

If, for example, the picture type of a picture indicated by the 2D compatible video encoding information 2606 at time “b” is a B picture, the base-view video encoder 2605 performs compression encoding on a black image having the same presentation time so that the black image is a B picture. In this case, the DTS and the PTS of the base-view video stream are respectively made identical to the DTS and the PTS of pictures corresponding to a view having the same presentation time in the 2D compatible video stream.

The base-view video frame memory management information is information obtained by converting syntax elements indicating a memory address of the frame memory 2608 storing therein the decoded pictures obtained by decoding the 2D compatible video stream based on the 2D compatible video frame memory management information and the information on a presentation order and an encoding order of the decoded pictures into syntax elements conforming to the compression encoding method for the base-view video stream, and associating these elements with each other. The syntax elements stipulate attribute information necessary for encoding in the compression encoding method in the MPEG-2 format and the MPEG-4 MVC format, and indicate, for example, header information, a motion vector, a conversion factor, and the like of a macroblock type etc.

The dependent-view video encoder 2609 has a function to perform compression encoding in the format conforming to the MPEG-4 MVC format to generate the dependent-view video stream. The dependent-view video encoder 2609 performs compression encoding on right-view images based on information included in the base-view video encoding information 2607, and outputs the dependent-view video stream. In this case, the dependent-view video encoder 2609 performs compression encoding by using the decoded pictures stored in the 2D compatible video frame memory as inter-view reference. The inter-view reference indicates reference of a picture showing a view from a different viewpoint.

The dependent-view video encoder 2609 determines reference picture IDs for inter-view reference based on the base-view video frame memory management information in the base-view video encoding information 2607. The dependent-view video encoder 2609 also sets, as a value of the video attribute information on the dependent-view video stream, the same value as the attribute information on the base-view video stream in the base-view video encoding information 2607.

Furthermore, the dependent-view video encoder 2609 determines the picture type of an image as a target of encoding, based on the picture attribute information (picture type and the like) and the GOP structure included in the base-view video encoding information 2607, and performs compression encoding on right-view images. For example, if the picture type of a picture indicated by the base-view video encoding information 2607 at time “a” is an I picture and the picture is at the top of a GOP, then the dependent-view video encoder 2609 performs compression encoding on the right-view images by setting the picture type of the picture at the same time “a” to an anchor picture so that the anchor picture is the video access unit at the top of a dependent GOP. The anchor picture is a picture that does not refer to a picture earlier than itself, i.e. a picture from which interrupt playback is possible. If, for example, the picture type of a picture indicated by the base-view video encoding information 2607 at time “b” is a B picture, the dependent-view video encoder 2609 performs compression encoding on the right-view images by setting the picture type of the picture at the same time “b” to a B picture.

In this case, the DTS and the PTS of the dependent-view video stream are respectively made identical to the DTS and the PTS of pictures corresponding to a view to be displayed at the same presentation time in the base-view video stream.

The multiplexer 2610 converts the output 2D compatible video stream, base-view video stream, and dependent-view video stream into PES (Packetized Elementary Stream) packets, divides the PES packets into TS packets, and outputs the TS packets as a multiplexed transport stream.

Separate PIDs are set to the 2D compatible video stream, the base-view video stream, and the dependent-view video stream, so that the playback device can identify each of the video streams from data of the multiplexed transport stream.

<1-2-2. Data Format>

The following describes a data format with reference to the drawings.

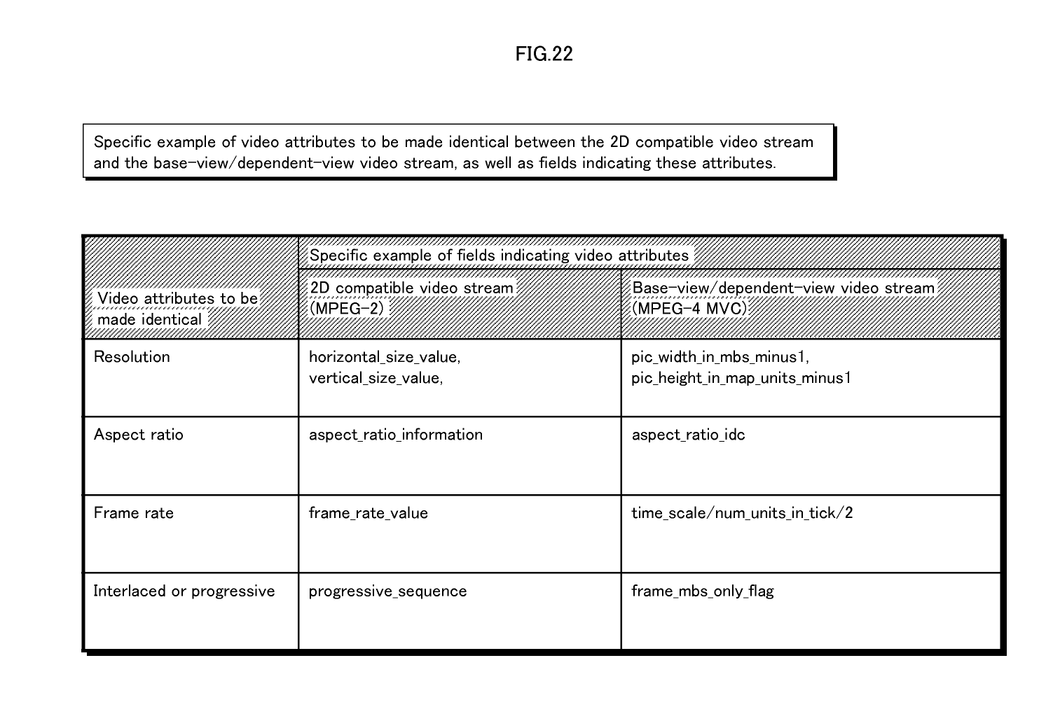

FIG. 22 illustrates video attributes that are made identical in each compression encoding format in compression encoding in the MPEG-2 format and in the MPEG-4 MVC format, and the names of the fields for the video attributes.

Video attributes indicating resolution, aspect ratio, frame rate, and progressive/interlaced of the video stream shown in FIG. 22 are set to have the same value among pictures in different encoding methods, so that, when pictures in the dependent-view video stream are decoded, pictures in the 2D compatible video stream in a different compression encoding format are easily referred to.

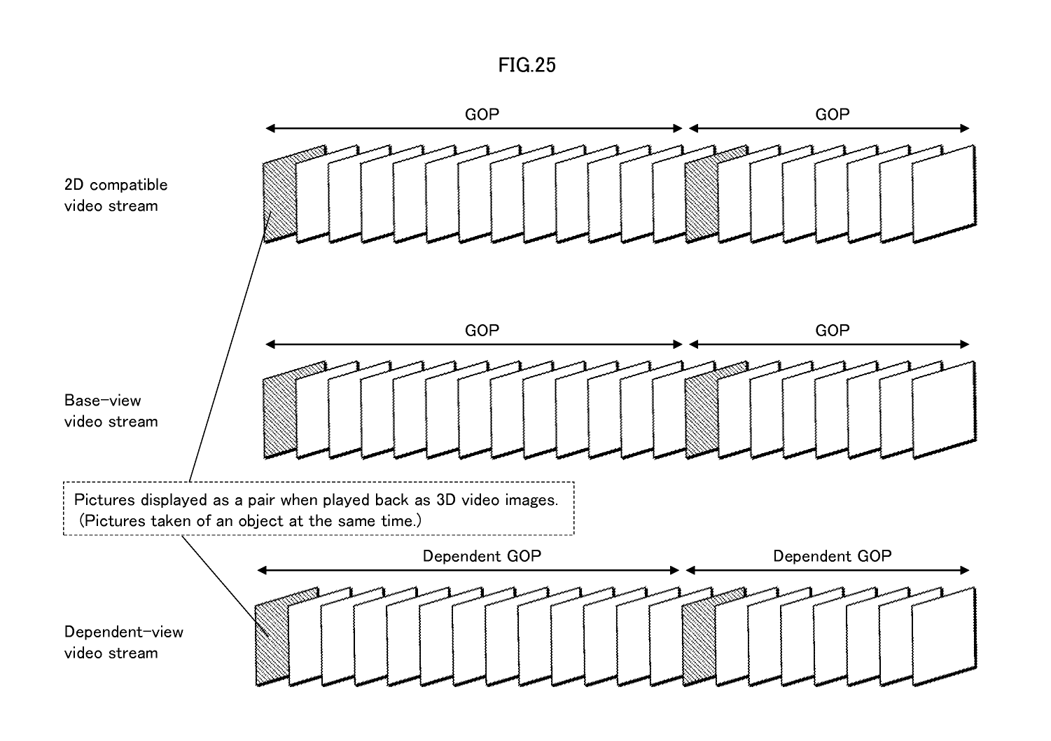

FIG. 25 illustrates the GOP structure of the 2D compatible video stream, the base-view video stream, and the dependent-view video stream in Embodiment 1.

As illustrated in FIG. 25, GOPs in the 2D compatible video stream, the base-view video stream, and the dependent-view video stream are configured to have the same number of pictures. In other words, when a picture in the 2D compatible video stream is at the top of a GOP, a picture in the base-view video stream having the same PTS and a picture in the dependent-view video stream having the same PTS must be at the top of the respective GOP and dependent GOP.

With this structure, when interrupt playback is performed, decoding of all of the video streams is possible starting from a certain presentation time if the 2D compatible video stream is an I picture, thus simplifying the processing for interrupt playback.

When the transport stream is stored as a file, entry map information may be stored as management information to indicate where the picture at the top of a GOP is stored in the file. For example, in the Blu-ray Disc format, the entry map information is stored in a separate file as a management information file.

In the transport stream of Embodiment 1, when the position of the picture at the top of each GOP in the 2D compatible video stream is registered in an entry map, the position of the base view and the dependent view at the same presentation time is also registered in the entry map. With this structure, interrupt playback of 3D video images is made simple by referring to the entry map.

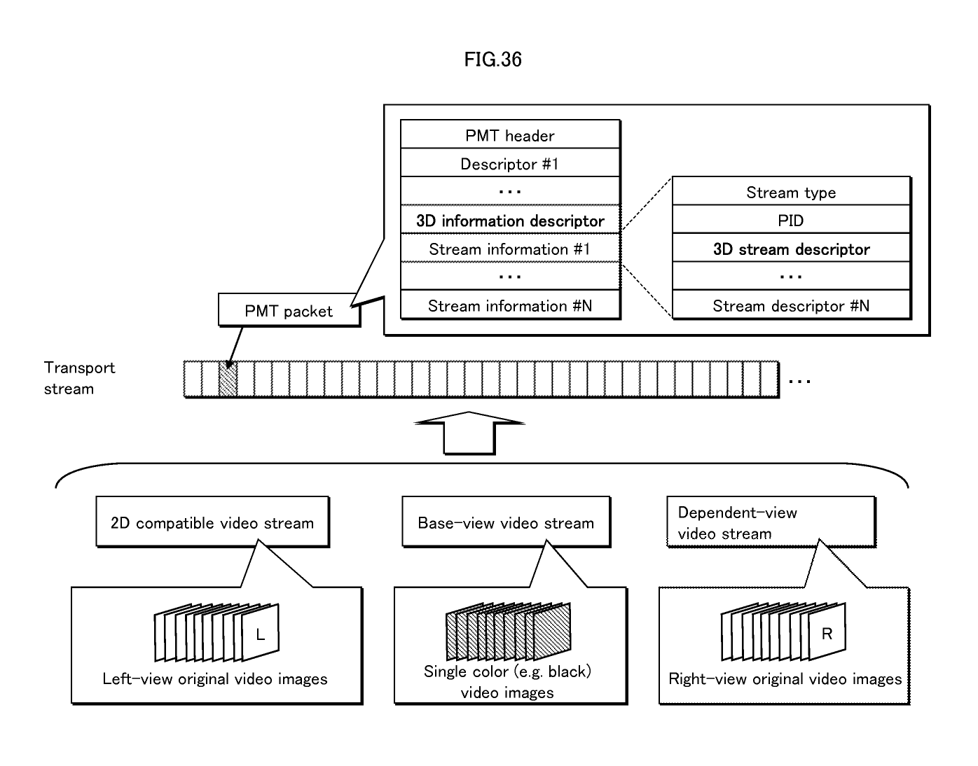

FIG. 36 illustrates the relationship between the structure of the transport stream and PMT (Program Map Table) packets. In the transport stream including a stream for 3D video images, signaling information for decoding of the 3D video images is included in system packets, such as PMT packets. As shown in FIG. 36, descriptors include a 3D information descriptor for signaling the relationship between video streams, the start and end of 3D video images playback under the present format and a 3D stream descriptor set for each video stream, and the like.

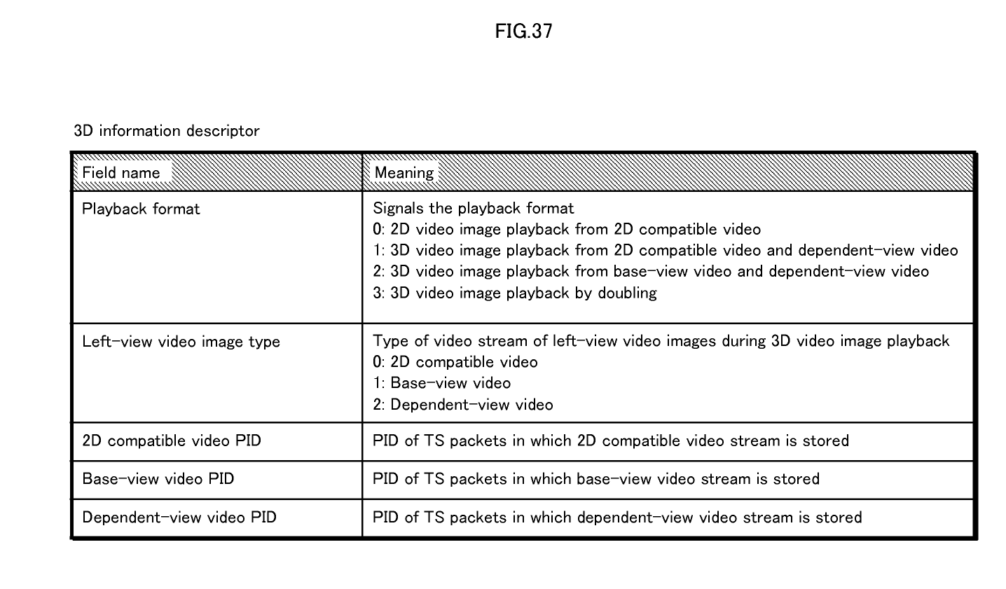

FIG. 37 illustrates the structure of the 3D information descriptor.

The 3D information descriptor includes a playback format, a left-view video image type, a 2D compatible video PID, a base-view video PID, and a dependent-view video PID.

The playback format is information for signaling the playback method of the playback device.

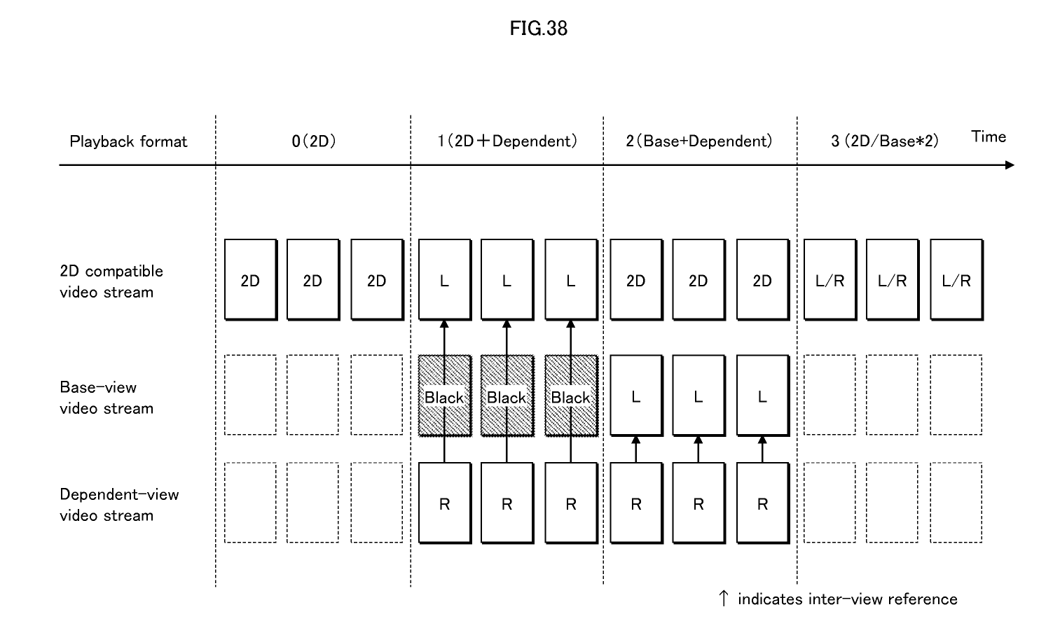

The playback format is described with reference to FIG. 38.

A playback format of “0” indicates playback of 2D video images from 2D compatible videos. In this case, the playback device performs 2D video image playback of the 2D compatible video stream only.

A playback format of “1” indicates playback of 3D video images from 2D compatible videos and the dependent-view videos (i.e., the 3D video image playback format described in Embodiment 1). In this case, the playback device performs 3D video image playback of the 2D compatible video stream, the base-view video stream, and the dependent-view video stream using the playback method described in Embodiment 1. The 3D video image playback method of Embodiment 1 is described below.

A playback format of “2” indicates 3D video image playback from the base-view video stream and the dependent-view video stream. In other words, a value of “2” indicates that the 2D compatible video stream and the multi-view video stream constituting the 3D video images have been generated by performing compression encoding on different video images, and are not in a reference relationship. In this case, the playback device performs 3D video image playback of the video stream as the video stream compression-encoded in the regular MPEG-4 MVC format.

A playback format of “3” indicates doubling playback of the 2D compatible video stream or the base-view video stream. The playback device performs doubling playback. Doubling playback refers to outputting one of a right-view picture and a left-view picture at a given time “a” to both the L and R planes. Doubling playback is equivalent to 2D video image playback in terms of the screen the viewer sees. Since no change occurs in the frame rate during 3D video image playback, however, doubling playback has advantages that no reauthentication occurs when the playback device is connected to a display and the like via an HDMI (High-Definition Multimedia Interface) or the like, thus allowing for a seamless playback connection between a 2D video playback section and a 3D video playback section.

The left-view video image type is information indicating which stream, between the multi-view video streams, includes the compression-encoded left-view video images (the other video stream including the right-view video images). If the playback format is “0”, there is no need to refer to this field. If the playback format is “1”, this field indicates which of the 2D compatible video and the dependent-view video represents the left-view video images. That is to say, the playback format of “1” and the left-view video image type of “0” indicate that the 2D compatible video stream corresponds to the left-view video images. When the playback format is “2” or “3”, the playback device can determine the video stream corresponding to the left-view video images in a similar manner by referring to the left-view video image type.

The 2D compatible video PID, the base-view video PID, and the dependent-view video PID indicate the PID of each video stream included in the transport stream. This information allows for identification of the stream to be decoded.

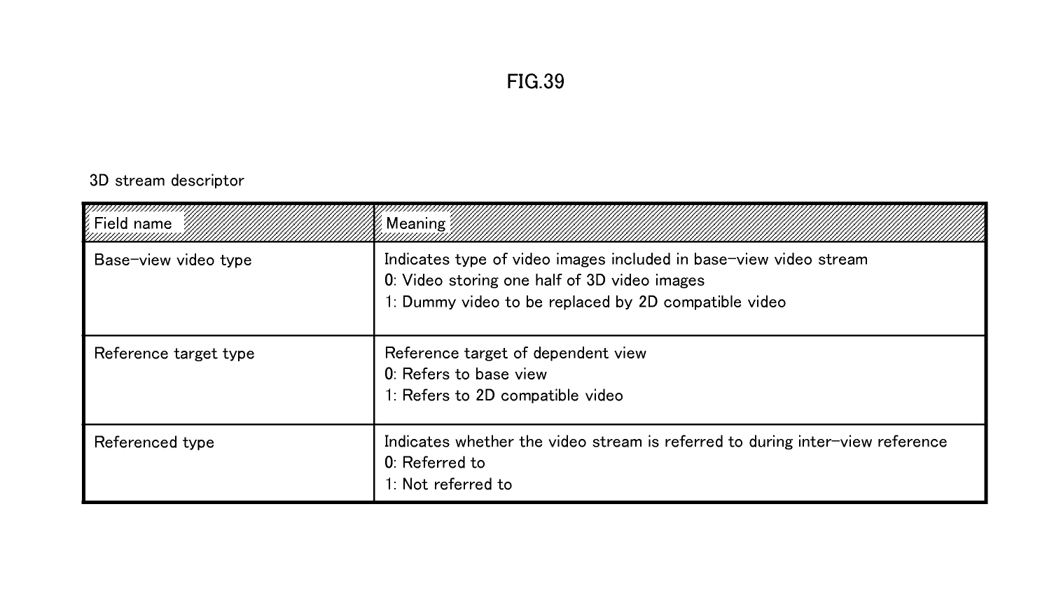

FIG. 39 illustrates the 3D stream descriptor.

The names of fields for the 3D descriptor include a base-view video type, a reference target type, and a referenced type.

The base-view video type indicates the type of video images compression-encoded in the base-view video stream. A base-view video type of “0” indicates that either left-view video images or right-view video images of 3D video images are compression-encoded. A base-view video type of “1” indicates that black images are compression-encoded as dummy images that are replaced by the 2D compatible video stream and are not output to a plane.

The reference target type indicates the type of the video stream that the dependent-view video stream refers to for inter-view reference. A reference target type of “0” indicates that pictures in the base-view video stream are referred to for inter-view reference, whereas a reference target type of “1” indicates that pictures in the 2D compatible video stream are referred to for inter-view reference. In other words, the reference target type of “1” indicates the reference method in the 3D video image format of the present embodiment.

The referenced type indicates whether the video stream is referred to in inter-view reference. If the video stream is not referred to, processing for inter-view reference can be skipped, thus reducing the burden of decoding processing. Note that all or a portion of the information in the 3D information descriptor and the 3D stream descriptor may be stored in supplementary data or the like for each video stream rather than being stored in PMT packets.

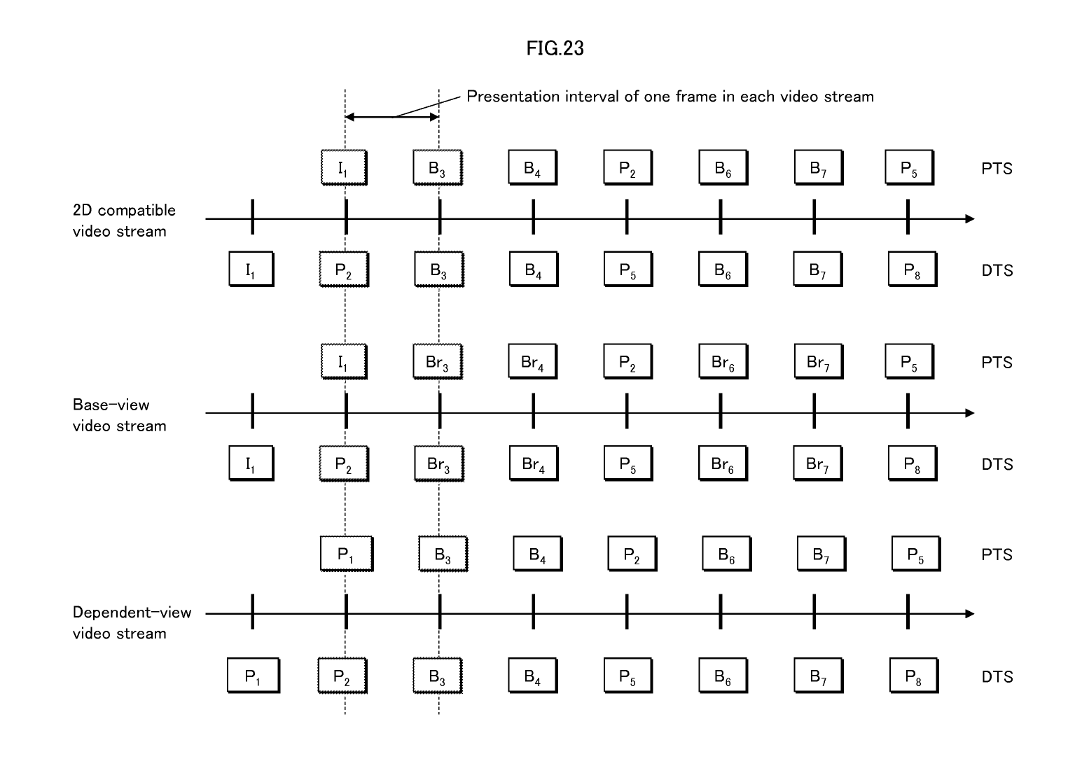

FIG. 23 illustrates an example of the relationship between a picture type, and the PTS and the DTS allocated to each video access unit in the 2D compatible video stream, the base-view video stream, and the dependent-view video stream in the transport stream.

The data creation device 2601 sets pictures in the 2D compatible video stream and pictures in the dependent-view video stream having been generated by performing compression encoding on the left-view images at the same presentation time to have the same DTS/PTS. The pictures in the base-view video stream to be played back at the same time are provided with the same PTS/DTS/POC as the pictures in the dependent-view video stream.

During inter-view reference of the pictures in the dependent-view video stream, the pictures in the base-view video stream provided with the same PTS/DTS/POC are referred to. Specifically, during inter-view reference of the pictures in the dependent-view video stream, the picture reference ID (ref_idx_{—}10 or ref_idx_{—}11) designated by each macroblock in the picture of the dependent-view video stream is configured to indicate the base-view picture with the same POC.

<1-2-3. Operations>

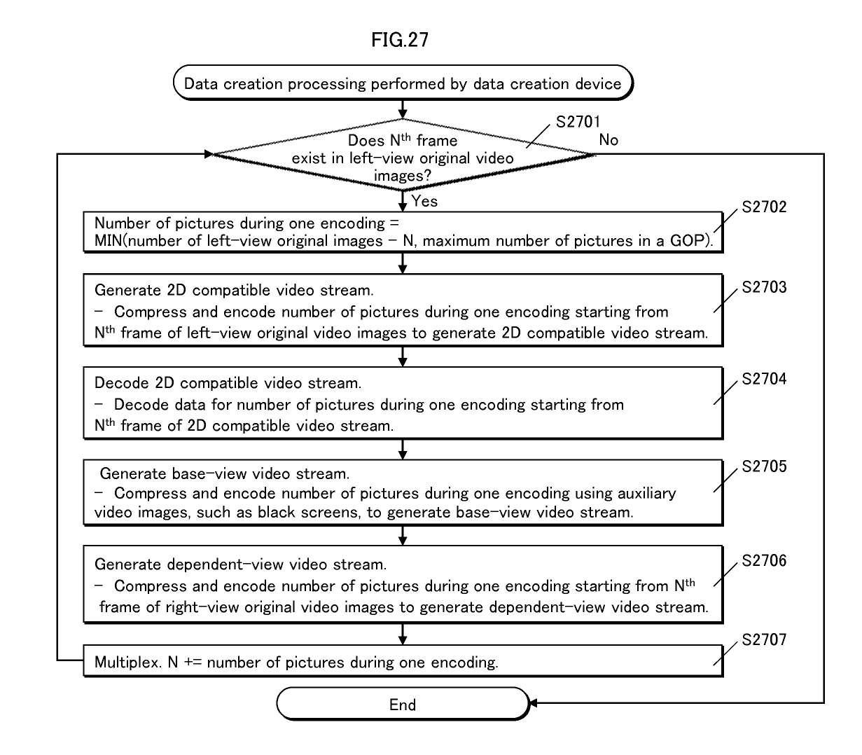

FIG. 27 illustrates the data creation flow of the data creation device 2601. The following describes the data creation flow.

N is a variable for storing the frame number of the frame image as the target of encoding.

First, the variable N is initialized (N=0). The data creation device 2601 then checks whether the N^{th} frame exists in the left-view video images (step S2701). If not (step S2701: No), the data creation device 2601 determines that no more data requiring compression encoding exists, and terminates processing.

If Yes in step S2701, the data creation device 2601 determines the number of pictures (hereinafter, referred to as “the number of pictures in one encoding”) to be compression-encoded in one compression encoding flow (steps S2702 to S2706) (step S2702). The maximum number of video access units included in one GOP (the maximum number of frames in one GOP, e.g. 30 frames) is set as the number of pictures in one encoding. Depending on the length of the video stream to be input, it is expected that the number of frames included in the last GOP in the video stream is less than the maximum number of frames in one GOP. In such a case, the remaining number of frames is set as the number of pictures in one encoding.

The 2D compatible video encoder 2602 then generates a portion of the 2D compatible video stream for the number of pictures in one encoding (step S2703). Starting from the N^{th} frame of the left-view video images, the 2D compatible video encoder 2602 performs compression encoding on the number of pictures in one encoding in accordance with the compression encoding method for the 2D compatible video stream to generate and output the 2D compatible video stream.

Furthermore, the 2D compatible video decoder 2603 decodes a portion of the 2D compatible video stream for the number of pictures in one encoding (step S2704). The 2D compatible video decoder 2603 decodes the number of pictures in one encoding starting from the N^{th} frame in the 2D compatible video stream output in step S2703, and then outputs decoded pictures, which are obtained by decoding compressed picture data, and 2D compatible video encoding information.

The base-view video encoder 2605 generates a portion of the base-view video stream for the number of pictures in one encoding (step S2705). Specifically, based on the 2D compatible video encoding information, the attribute information on the base-view video stream (resolution, aspect ratio, frame rate, progressive/interlaced, and the like), the picture attribute information (picture type and the like) for each picture in the GOP, the GOP structure, 2D compatible video frame memory management information, and the like are set as the base-view encoding information 2607, and black images are compression-encoded for the number of pictures in one encoding to generate the base-view video stream. The set base-view encoding information 2607 is output.

The dependent-view video encoder 2609 then generates a portion of the dependent-view video stream for the number of pictures in one encoding (step S2706). Specifically, based on the base-view video encoding information output in step S2705, the attribute information on the dependent-view video stream (resolution, aspect ratio, frame rate, progressive/interlaced, and the like), the picture attribute information (picture type and the like) for each picture in the GOP, the GOP structure, 2D compatible video frame memory management information, and the like are set.

Furthermore, when encoding is performed using inter-picture predictive encoding, the dependent-view video stream encoder 2609 performs compression encoding on the right-view video images starting from the N^{th} frame using inter-picture predictive encoding by referring to pictures obtained by decoding the 2D compatible video stream provided with the same presentation time in the 2D compatible video frame memory 2608, rather than referring to pictures in the base-view video stream, to generate the dependent-view video stream.

The multiplexer 2610 converts the 2D compatible video stream, base-view video stream, and dependent-view video stream into PES packets. The multiplexer 2610 then divides the resulting PES packets into TS packets, and multiplexes the TS packets into a transport stream. N is then incremented by the number of pictures in one encoding (S2707).

When processing in step S2707 terminates, processing is repeated, starting from step S2701.

Note that the number of pictures may be changed for each flow. When the number of pictures is to be reduced, it suffices to set the number of pictures in one encoding in step S2702 to a lower value. For example, if the number of pictures reordered in video encoding is two, then setting the number of pictures in compression encoding to four eliminates the effect of reordering. Suppose that, for example, in the compression encoding method, the number of reordered pictures is two, and that the picture types are I1, P4, B2, B3, P7, B5, B6, . . . (the numbers indicating a presentation order). If the number of pictures in one encoding is three, then the P4 picture cannot be processed, thus preventing compression encoding on pictures B2 and B3. If on the other hand the number of pictures in one encoding is set to four, then the P4 picture can be processed, thus allowing encoding of the pictures B2 and B3. Depending on image characteristics, the number of pictures may be set, for each compression encoding flow, to the optimum number as long as the number of pictures in one encoding does not exceed the maximum number of frames in one GOP.

<1-3. Playback Device>

<1-3-1. Structure>

The following describes the structure of a playback device 2823, pertaining to the present embodiment, that plays back 3D video images, with reference to the drawings.

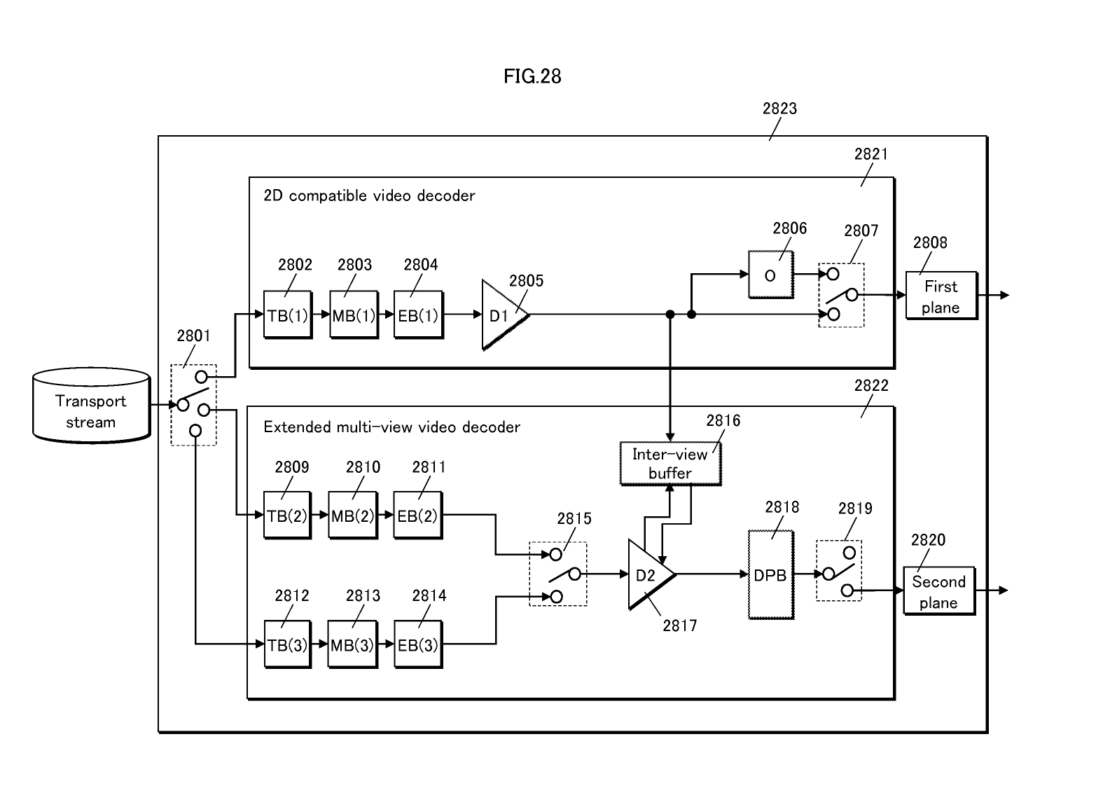

FIG. 28 is a block diagram showing the functional structure of the playback device 2823.

The playback device 2823 includes a PID filter 2801, a 2D compatible video decoder 2821, an extended multi-view video decoder 2822, a first plane 2808, and a second plane 2820.

The PID filter 2801 filters an input transport stream. From among the TS packets, the PID filter 2801 transmits TS packets whose PID matches a PID necessary for playback to the 2D compatible video decoder 2821 and the extended multi-view video decoder 2822 in accordance with the PID.

Stream information on the PMT packet indicates which stream corresponds to which PID. For example, if the PID of the 2D compatible video stream is 0x1011, the PID of the base-view video stream in the multi-view video stream is 0x1012, and the PID of the dependent-view video stream in the multi-view video stream is 0x1013, then, the PID filter 2801 refers to the PID of the TS packet and, if the PID of the TS packet matches one of the predetermined PIDs shown above, transmits the TS packet to the corresponding decoder.

The first plane 2808 is a plane memory storing a picture that the 2D compatible video decoder 2821 decodes and outputs in accordance with the PTS.

The second plane 2820 is a plane memory storing a picture that the extended multi-view video decoder 2822 decodes and outputs in accordance with the PTS.

Next, the 2D compatible video decoder 2821 and the extended multi-view video decoder 2822 are described.

The 2D compatible video decoder 2821 has basically the same decoding function as a decoder in the MPEG-2 format, which is a compression encoding method for 2D video images. The extended multi-view video decoder 2822 has basically the same decoding function as a decoder in the MPEG-4 MVC format, which is a compression encoding method for the 3D video images for achieving inter-view reference. In this embodiment, a regular decoder in the MPEG-2 format is referred to as a video decoder 2901, and a regular decoder in the MPEG-4 MVC format is referred to as a multi-view video decoder 2902.

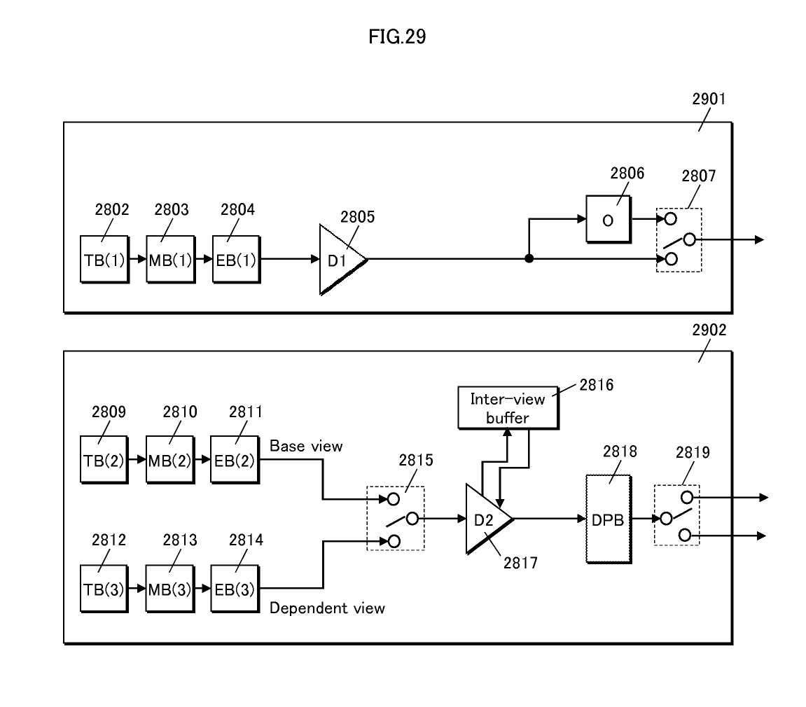

The video decoder 2901 and the multi-view video decoder 2902 are first described with reference to FIG. 29. Subsequently, description focuses on the differences between the 2D compatible video decoder 2821 and the video decoder 2901 and between the extended multi-view video decoder 2822 and the multi-view video decoder 2902.

As illustrated in FIG. 29, the video decoder 2901 includes a TB (Transport Stream Buffer) (1) 2802, a MB (Multiplexing Buffer) (1) 2803, an EB (Elementary Stream Buffer) (1) 2804, D1 (2D compatible video compressed image decoder) 2805, and an O (Re-ordering Buffer) 2806.

The TB(1) 2802 is a buffer that temporarily stores TS packets constituting the video stream when the TS packets are output from the PID filter 2801.

The MB(1) 2803 is a buffer for temporarily storing PES packets when the video stream is output from the TB(1) 2802 to the EB(1) 2804. When data is transferred from the TB(1) 2802 to the MB(1) 2803, the TS header and adaptation field are removed from TS packets.

The EB(1) 2804 is a buffer in which compression-encoded pictures (I pictures, B pictures, and P pictures) are stored. When data is transferred from the MB(1) 2803 to the EB(1) 2804, the PES headers are removed.

The D1 2805 creates pictures of frame images by decoding each video access unit in the video elementary stream at a time of the DTS.

The pictures decoded by the D1 2805 are output to the plane 2808 or to the O 2806. When the DTS and the PTS differ from each other, as with P pictures and I pictures, the pictures are output to the O 2806. When the DTS and the PTS are the same, as with B pictures, the pictures are directly output to the plane 2808.

The O 2806 is a buffer for reordering when the DTS and the PTS of decoded pictures differ from each other, i.e. when the decoding order and the presentation order of decoded pictures differ from each other. The D1 2805 performs decoding by referring to the picture data stored in the O 2806.

When decoded pictures are output to the plane 2808, a switch 2807 performs switching between outputting buffered images to the O 2806 and directly outputting the pictures from the D1 2805.

The multi-view video decoder 2902 is described next.

As illustrated in FIG. 29, the multi-view video decoder 2902 includes a TB(2) 2809, a MB(2) 2810, an EB(2) 2811, a TB(3) 2812, a MB(3) 2813, an EB(3) 2814, a decoding switch 2815, an inter-view buffer 2816, a D2 (multi-view video compressed image decoder) 2817, a DPB (Decoded Picture Buffer) 2818, and an output plane switch 2819.

The TB(2) 2809, the MB(2) 2810, and the EB(2) 2811 respectively have the same functions as the TB(1) 2802, the MB(1) 2803, and the EB(1) 2804, but differ from these buffers in that the buffered data is from the base-view video stream.

The TB(3) 2812, the MB(3) 2813, and the EB(3) 2814 respectively have the same functions as the TB(1) 2802, the MB(1) 2803, and the EB(1) 2804, but differ from these buffers in that the buffered data is from the dependent-view video stream.

In accordance with a DTS, the switch 2815 extracts data from the EB(2) 2811 and the EB(3) 2814 for the video access unit bearing the DTS in order to construct a 3D video access unit, and transfers the 3D video access unit to the D2 2817.

The D2 2817 decodes the 3D video access units transferred via the switch 2815 to create pictures of frame images.

Pictures in the base-view video, decoded by the D2 2817, are temporarily stored in the inter-view buffer 2816. The D2 2817 decodes pictures in the dependent-view video stream by referring to decoded pictures from the base-view video stream having the same PTSs and stored in the inter-view buffer 2816.

The multi-view video decoder 2902 creates a reference picture list for designating pictures to perform inter-view reference based on the picture type and syntax elements of the pictures in the base-view video stream and the pictures in the dependent-view video stream.

The D2 2817 transfers the decoded picture for the base-view, stored in the inter-view buffer 2816, and the decoded picture for the dependent-view to the DPB 2818, and outputs the pictures via the output plane switch 2819 in accordance with the PTS.

The DPB 2818 is a buffer for temporarily storing the decoded pictures. When decoding a video access unit for a P picture, a B picture, or the like using an inter-picture predictive encoding mode, the D2 2817 uses the DPB 2818 to refer to pictures that have already been decoded.

The output plane switch 2819 outputs the decoded pictures to an appropriate plane. For example, if the base-view video stream represents left-view video images and the dependent-view video stream represents right-view video images, the output plane switch 2819 outputs pictures in the base-view video stream to the plane for left-view video images and outputs pictures in the dependent-view video stream to the plane for right-view video images.

Next, the 2D compatible video decoder 2821 and the extended multi-view video decoder 2822 are described.

The 2D compatible video decoder 2821 has basically the same structure as the video decoder 2901. Therefore, a description of common functions is omitted, and only the differences are described.

The 2D compatible video decoder 2821 as illustrated in FIG. 28 transfers pictures decoded by the D1 2805 not only to the O 2806 or the switch 2807 but also to the inter-view buffer 2816 of the extended multi-view video decoder 2822 in accordance with the DTS.

The extended multi-view video decoder 2822 has basically the same structure as the multi-view video decoder 2902. Therefore, a description of common functions is omitted, and only the differences are described.

The extended multi-view video decoder 2822 overwrites decoded pictures in the base-view video stream having the same PTS/DTS, which are stored in a region within the inter-view buffer 2816, with pictures transferred from the 2D compatible video decoder 2821 in accordance with the DTS. With this structure, when pictures in the dependent-view video stream are decoded, the extended multi-view decoder 2822 can refer to the decoded pictures in the 2D compatible video stream as though they were decoded pictures in the base-view video stream. Address management of the inter-view buffer 2816 is not necessarily made different from management of decoded pictures in a conventional base-view video stream.

The extended multi-view video decoder 2822 controls the output plane switch 2819 so as to output only pictures from the dependent-view video stream, among the video images stored in the DPB 2818, to the second plane 2820 in accordance with the PTS. Pictures in the base-view video stream are not output to any plane as they have nothing to do with display.

With this structure, pictures in the 2D compatible video stream are output from the 2D compatible video decoder 2821 to the first plane 2808 in accordance with the PTS, and pictures in the dependent-view video stream in the multi-view video stream are output from the extended multi-view video decoder 2822 to the second plane 2820 in accordance with the PTS.

Adopting such structure allows for decoding of the dependent-view video stream in the multi-view video stream by referring to pictures in the 2D compatible video stream with a different video compression encoding method.

<1-3-2. Operations>

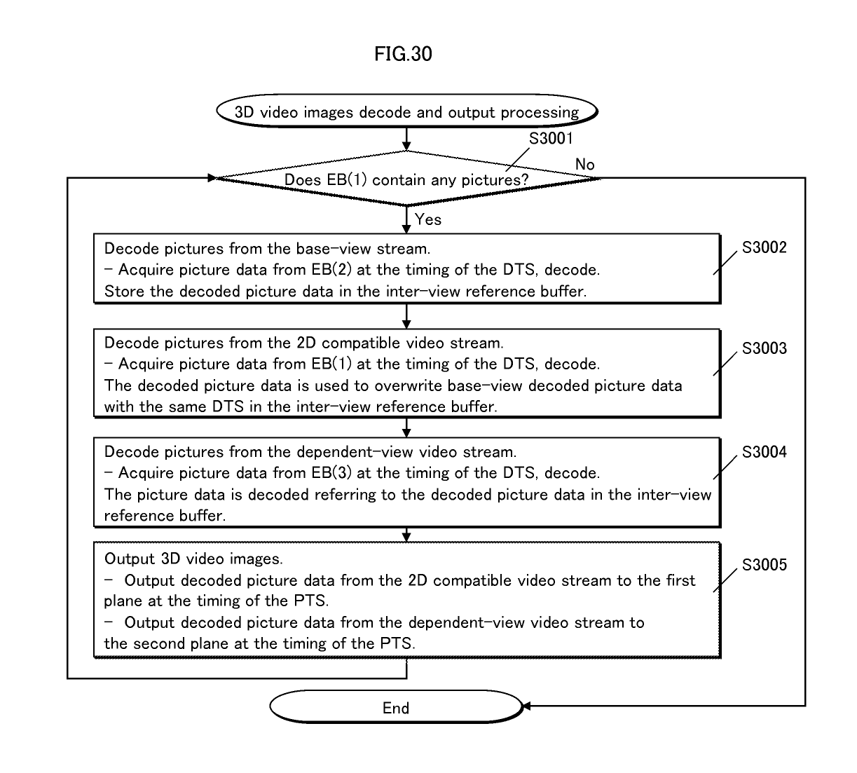

FIG. 30 illustrates the flow of decoding and output of 3D video images in the playback device 2823.

The playback device 2823 determines whether or not there is a picture in the EB(1) 2804 (step S3001). If there is no picture (step S3001: No), the playback device 2823 determines that transfer of the video stream has terminated, and processing terminates.

If there is any picture in the EB(1) (step S3002: Yes), the playback device 2823 uses the extended multi-view video decoder 2822 to decode the base-view video stream (step S3002). Specifically, in accordance with each DTS, the picture bearing the DTS is extracted from the EB (2) and decoded to be stored in the inter-view buffer 2816. Since management of the pictures in the inter-view buffer 2816 is the same as conventional management in the MPEG-4 MVC format, a description thereof is omitted. For example, pictures are managed by internally storing, as management information for creation of a reference picture list, table information associating PTSs/POCs with data addresses of the inter-view buffer 2816 showing a reference target of a decoded picture.

The playback device 2823 uses the 2D compatible video decoder 2821 to decode the 2D compatible video stream (step S3003). Specifically, in accordance with each DTS, the 2D compatible video decoder 2821 extracts a picture bearing the DTS from the EB (1) and decodes the picture. In this case, the decoded picture is transferred to the O 2806 and the switch 2807. The decoded picture is also transferred to the inter-view buffer 2816.

The extended multi-view video decoder overwrites the base-view picture bearing the same DTS/PTS in the inter-view buffer 2816 with the transferred picture.

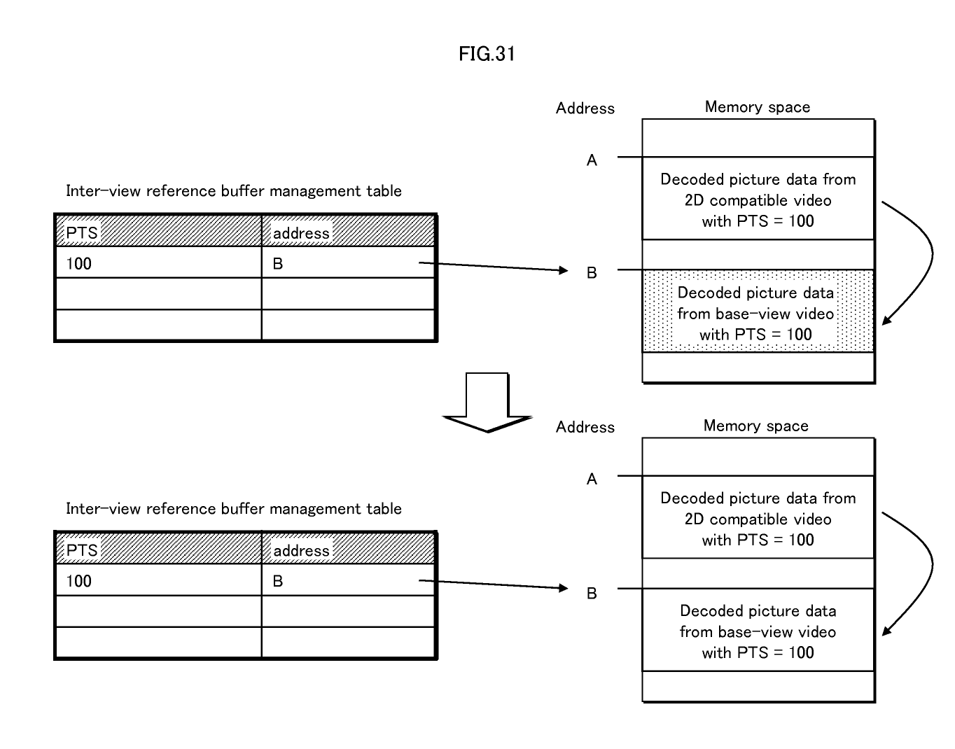

Details of the overwriting are described with reference to FIG. 31.

As in the upper tier of FIG. 31, pictures in the inter-view buffer 2816 are managed by, for example, PTSs and memory addresses in the Inter-view buffer 2816. The upper tier of FIG. 31 illustrates the state immediately after the picture in the base-view video stream whose PTS=100 has been decoded, and indicates that the decoded picture for the base-view whose PTS=100 is stored in a memory region starting from an address B.

When the processing in step S3003 is performed, the management table becomes as shown in the lower tier of FIG. 31. The base-view video picture whose PTS=100 and which is stored at address B is overwritten with the decoded picture in the 2D compatible video stream having the same PTS. This allows for the picture data alone to be overwritten, without a need to change the management information (e.g. the PTS) for managing pictures in the buffer. As a result, D2 2817 can perform decoding while referring to a picture obtained by decoding the 2D compatible video stream in the same manner as conventional decoding of the dependent-view video stream in the MPEG-4 MVC format.

The extended multi-view video decoder 2822 then decodes the dependent-view video stream (step S3004). Specifically, in accordance with each DTS, the extended multi-view video decoder 2822 extracts the picture bearing the DTS from the EB (3) and decodes the picture in the dependent-view video stream while referring to pictures stored in the inter-view buffer 2816.

The pictures to be referred to are not the pictures in the base-view video stream, but rather the pictures in the 2D compatible video stream yielded by the overwriting in step S3003.

The playback device 2823 outputs the decoded picture in the 2D compatible video stream in accordance with the PTS to the first plane 2808 and outputs the decoded picture data in the dependent-view video stream in accordance with the PTS to the second plane 2820 (step S3005).

Since decoding performed by the D1 2805 included in the playback device 2823 is the same as conventional decoding of the video stream in the MPEG-2 format, an LSI (Large Scale Integration) and software of a conventional playback device for videos in the MPEG-2 format can be used. Since decoding in the MPEG-4 MVC format performed by the D2 2817 is also the same as conventional decoding in the MPEG-4 MVC format, an LSI and software of a conventional playback device for videos in the MPEG-4 MVC format can be used.

<Example of Use of Playback Device 2823>

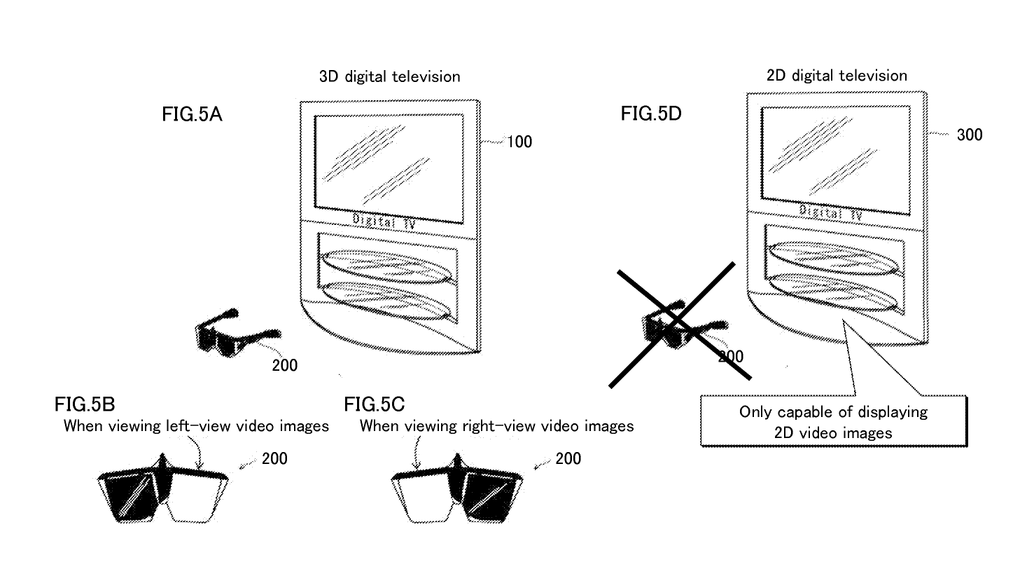

Use of the playback device is described with reference to FIGS. 5A through 5D by taking, as examples, a 3D digital television 100 that can play back 3D video images in the video stream created by the data creation device 2823 and a 2D digital television 300 that can only play back 2D video images and does not support playback of 3D video images.

As illustrated in FIG. 5A, a user views 3D video images by using the 3D digital television 100 and 3D glasses 200.

The 3D digital television 100 is capable of displaying both 2D video images and 3D video images, and displays video images by playing back a stream included in received broadcast waves. Specifically, the 3D digital television 100 plays back the 2D compatible video stream compression-encoded in the MPEG-2 format, and the base-view video stream and the dependent-view video stream compression-encoded in the format conforming to the MPEG-4 MVC format.

The 3D digital television 100 alternately displays a left-view image obtained by decoding the 2D compatible video stream and a right-view image obtained by decoding the dependent-view video stream.

Video images thus played back can be viewed as stereoscopic images by having the viewer wear the 3D glasses 200.

FIG. 5B illustrates the state of the 3D glasses 200 upon presentation of left-view images.

At the moment at which a left-view image is displayed on the screen, the 3D glasses 200 cause the liquid crystal shutter corresponding to the left eye to be transparent, while causing the liquid crystal shutter corresponding to the right eye to block light.

FIG. 5C illustrates the state upon presentation of right-view images.

At the moment at which a right-view image is displayed on the screen, the 3D glasses 200 conversely cause the liquid crystal shutter corresponding to the right eye to be transparent, while causing the liquid crystal shutter corresponding to the left eye to block light.

The 2D digital television 300 illustrated in FIG. 5D supports playback of 2D video images, and can play back 2D video images obtained by decoding the 2D compatible video stream among video streams included in the transport stream created by the data creation device 2601.

<1-4. Modifications>

Embodiments of the data creation device and the playback device pertaining to the present invention have been described thus far, but the present invention is in no way limited to the data creation device and the playback device as described in the above-mentioned embodiments. The exemplified data creation device and the playback device may be modified as described below.

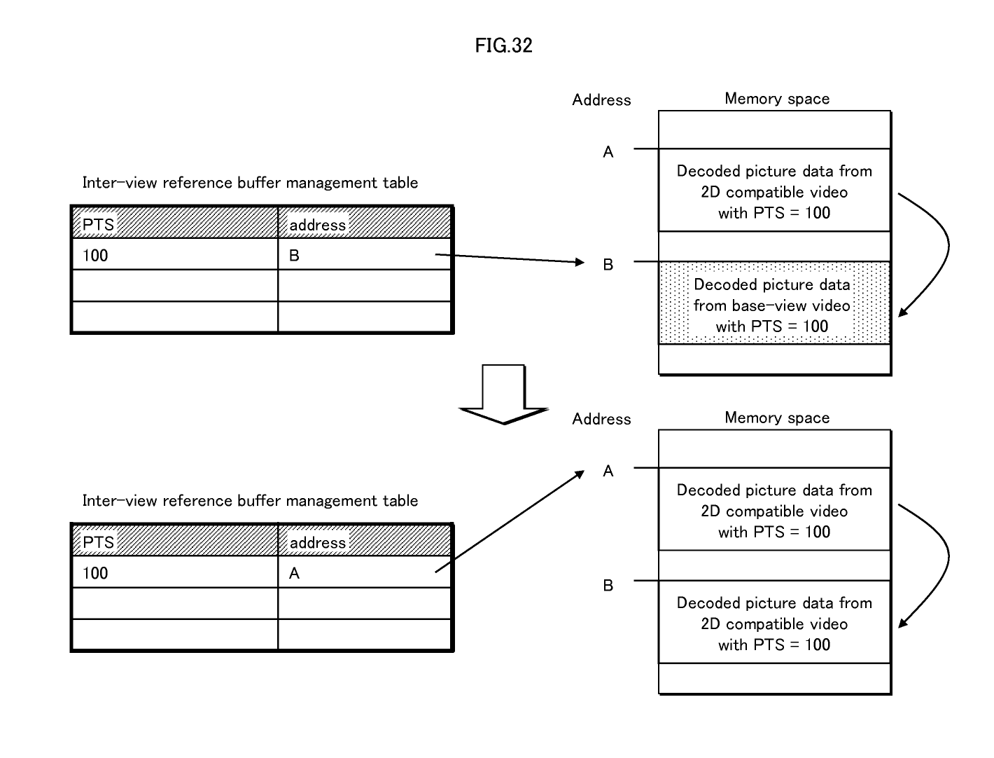

(1) In the playback device in the present embodiment, in step S3003, the decoded picture from the base-view video stream in the inter-view buffer 2816 is overwritten with the decoded picture in the 2D compatible video stream having the same PTS. As shown in the lower tier of FIG. 32, however, a reference target address may be changed without performing overwriting.

Performing processing in this way reduces the burden as overwriting can be omitted.

(2) In the playback device in the present embodiment, the decoded picture data for the base-view is stored in the DPB 2818. However, the decoded picture for the base-view video stream needs not be stored in the DPB 2818 as it is not referred to. This allows for a reduction in the size of the DPB 2818 corresponding to the amount of memory used for storage of pictures from the base-view video stream.

(3) In the present embodiment, the transport stream is generated so as to include the base-view video stream, and pictures in the base-view video stream are then decoded. Decoding of the pictures in the base-view video stream, however, may be omitted.

The extended multi-view video decoder 2822 analyzes the header information (for example, acquires the POC, the picture type, the View ID, information on referencing, and the like) and reserves a region in the inter-view buffer 2816 for storage of one picture, without decoding pictures in the base-view video stream. The extended multi-view video decoder 2822 stores, in the region, the decoded pictures output from the 2D compatible video decoder that have the same PTS/DTS obtained by the analysis of the header information.

This allows for decoding of pictures to be skipped, thus reducing the overall burden of playback processing.

The 2D compatible video stream may be generated so as to include information necessary for performing inter-view reference from pictures in the dependent-view video stream to pictures in the 2D compatible video stream, i.e. information allowing the extended multi-view video decoder to manage the inter-view buffer 2816.

Specifically, all or some of the syntax elements of the base-view video stream are stored in the supplementary data in the 2D compatible video stream. That is to say, information for management of pictures in the inter-view buffer 2816 (in the case of MPEG-4 MVC, POC to indicate a presentation order, slice_type to indicate the picture type, nal_ref_idc to indicate reference to/by a picture, ref_pic_list_mvc_modification, which is information for creating a base reference picture list, the View ID of the base-view video stream, and MMCO commands) is stored in the supplementary data for each picture in the 2D compatible video stream.

If a structure to directly refer to data in the 2D compatible video stream from the dependent-view video stream is thus adopted, the base-view video stream need not be multiplexed into the transport stream.

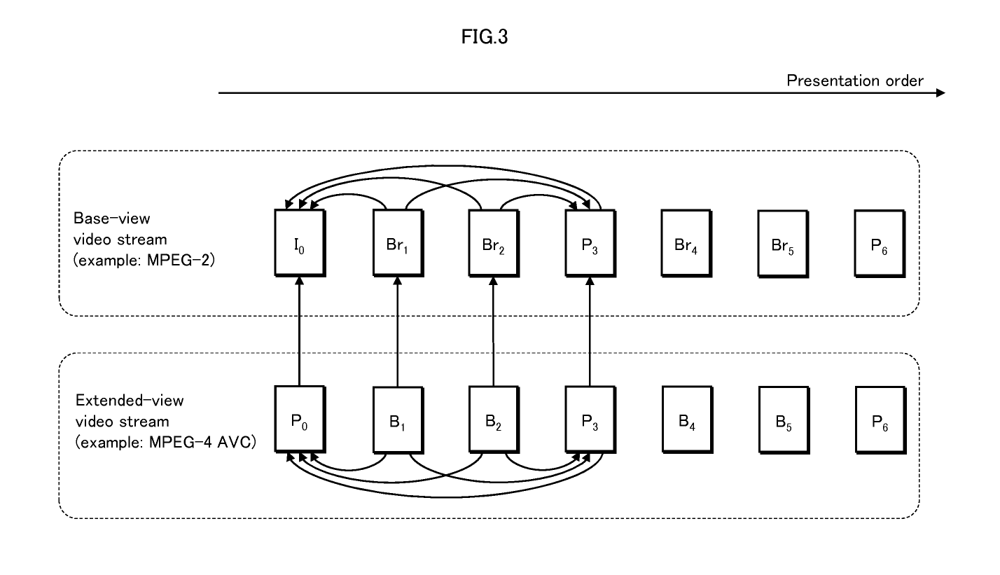

In this case, as illustrated in FIG. 3, pictures in the dependent-view video stream in the MPEG-4 MVC format directly refer to pictures in the video stream in the MPEG-2 format.

When the base-view video stream in the MPEG-4 MVC format is multiplexed into the transport stream, however, resulting data has a high degree of compatibility with the conventional encoding device and playback device supporting the MPEG-4 MVC format as the data format is substantially the same. Therefore, the encoding device and the playback device supporting the video stream data in the present embodiment can be implemented with a little improvement.

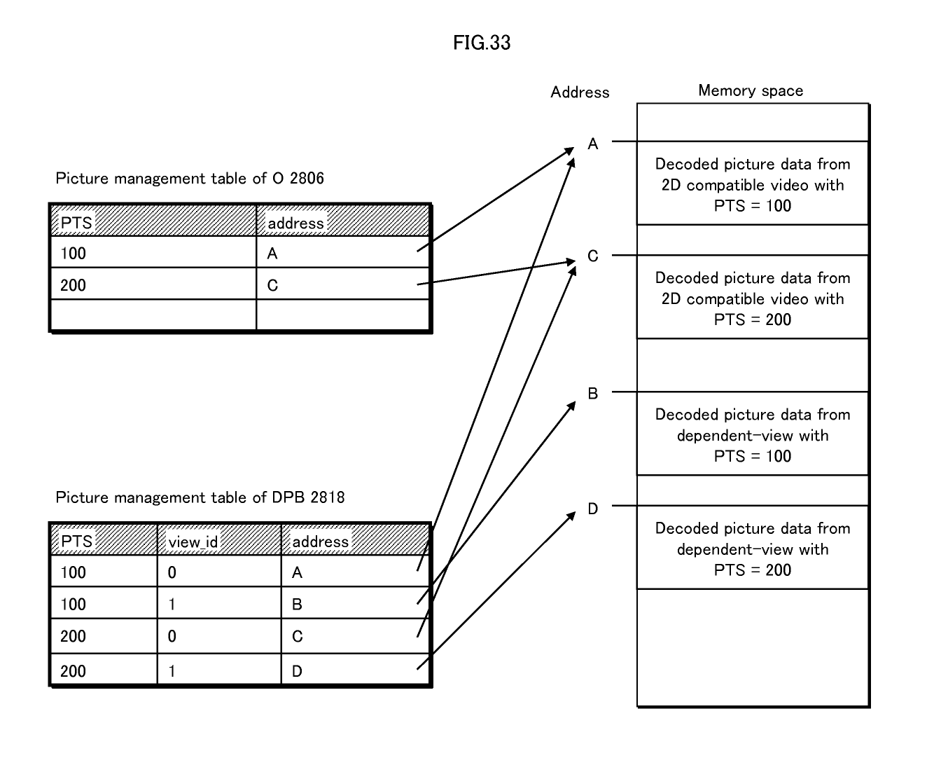

(4) In the playback device in the present embodiment, the O 2806 and the DPB 2818 are treated as separate memory regions. As shown in FIG. 33, however, these may share the same memory space. For example, in the example shown in FIG. 33, 2D compatible video pictures with PTS=100 and PTS=200 are overwritten in step S3003 with base-view pictures in the inter-view buffer 2816 that have the same PTS. In this case, data is stored in the DPB 2818 only by setting addresses of pictures to be referred to in the management table of the DPB 2818, and overwriting can be omitted. Specifically, in the example in FIG. 33, in the picture management table of the DPB 2816, the addresses of base-view (having the smallest View_ID value) pictures with PTS=100 and PTS=200 are configured to point to the addresses of decoded picture data for the 2D compatible video with PTS=100 and PTS=200 as pointed to by the addresses in the management table of the O 2806.

This structure allows for a reduction in the amount of memory used for storage of pictures.

(5) In the playback device in the present embodiment, the inter-view buffer 2816 and the DPB 2818 are treated as separate buffers, but these may be the same buffer. For example, if these buffers are consolidated in the DPB 2818, it suffices to replace the decoded pictures from the base-view video stream with the same PTS and same View ID within the DPB 2818 with the decoded pictures from the 2D compatible video stream.

(6) In compression encoding processing in the present embodiment, such constraint may be imposed that among a picture in the 2D compatible video stream, a picture in the base-view video stream having the same presentation time, and a picture in the dependent-view video stream having the same presentation time, if at least one picture is a B picture (including a Br picture), then the types of all of the picture in the 2D compatible video stream, the picture in the base-view video stream, and the picture in the dependent-view video stream having the same presentation time must be B pictures (including Br pictures). When a playback device performs trickplay by selecting only an I picture and a P picture, this structure facilitates processing for trickplay.

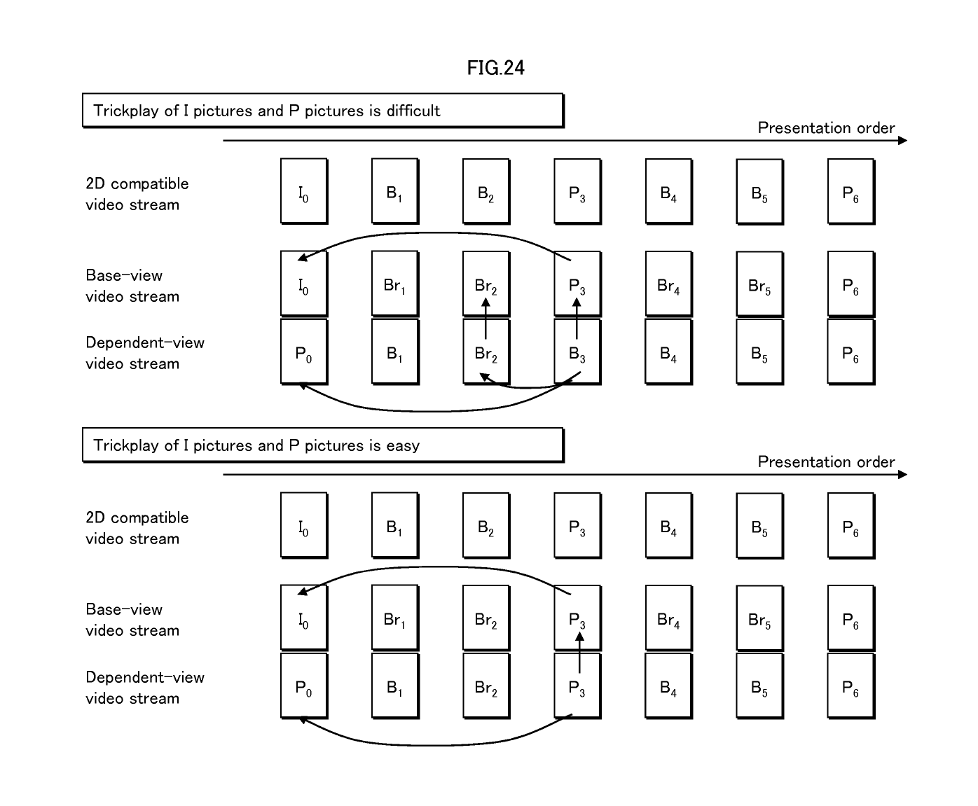

FIG. 24 is used to describe the trickplay. The upper tier of FIG. 24 illustrates a case where the above constraint is not imposed. In this case, the third picture in the presentation order is a P picture (P3) in the 2D compatible video stream and in the base-view video stream, whereas the third picture is a B picture (B3) in the dependent-view video stream.

As a result, in order to decode the dependent-view video stream, it is necessary to decode the picture Br2 in the dependent-view video stream as well as the picture Br2 in the base-view video stream. On the other hand, the lower tier of FIG. 24 illustrates a case where the above constraint is imposed.

In this case, the third picture in the presentation order is a P picture in all of the streams, i.e. the 2D compatible video stream, the base-view video stream, and the dependent-view video stream. It therefore suffices to decode only the I pictures and the P pictures in each of the video streams, thus facilitating trickplay processing that selects I pictures and P pictures.

(7) In the data creation device in the present embodiment, although the video streams are set to have different PIDs in multiplexing into the transport stream, the same PID may be allocated to the base-view video stream and the dependent-view video stream.

With this structure, in accordance with the specifications of the compression encoding method for the multi-view video stream, access units of the video streams may be merged and transferred.

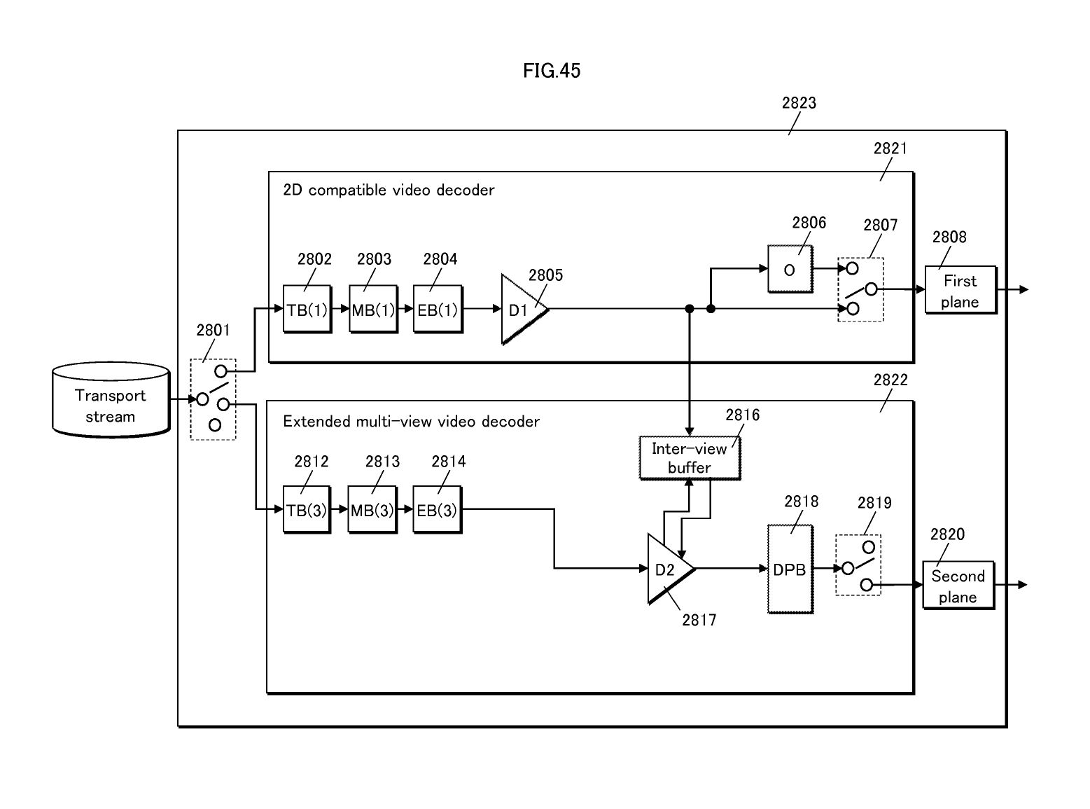

In this case, the base-view video stream and the dependent-view stream are merged in accordance with the specifications of the compression encoding method. The playback device then adopts a structure as shown in FIG. 45 to unify the data transfer line in the extended multi-view video decoder.

The base-view video stream and the dependent-view video stream may share header (e.g. a sequence header and a picture header) information of each access unit storing therein pictures at the same presentation time. That is to say, only the base-view video stream may be provided with the header information, and, when the dependent-view video stream is decoded, the header information necessary for decoding may be decoded while referring to the header information of the base-view video stream. Therefore, in the dependent-view video stream, addition of the header information necessary for decoding can be omitted.

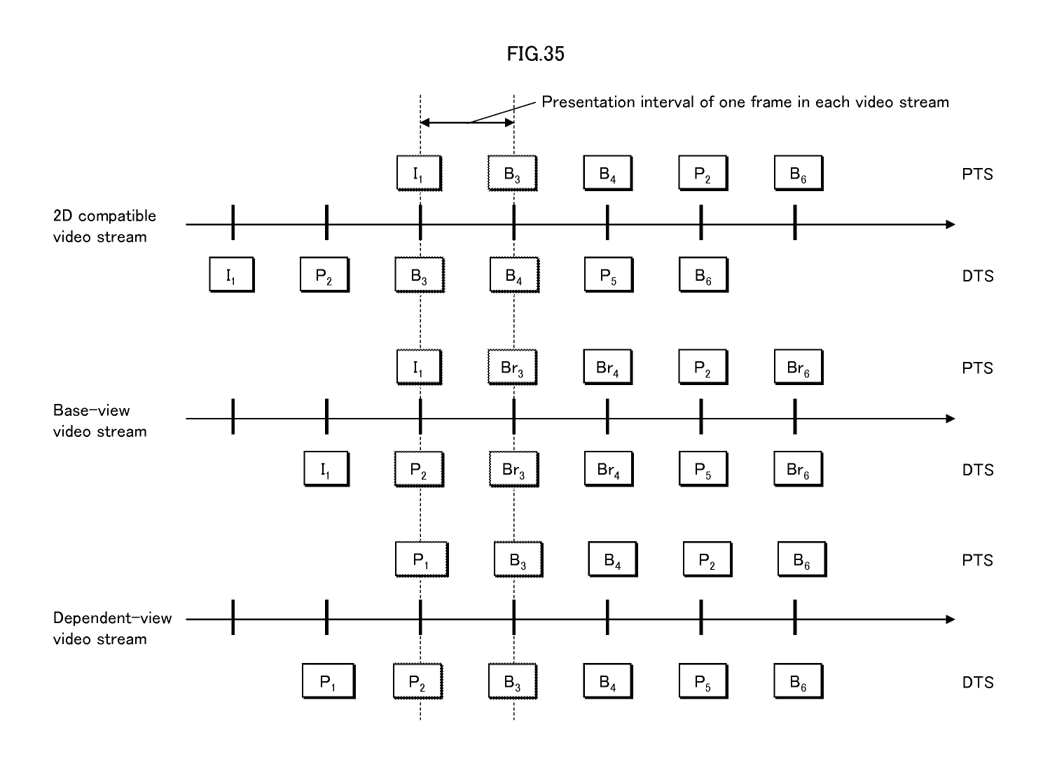

(8) In the data creation device in the present embodiment, as described with reference to FIG. 23, the pictures in the 2D compatible video stream and the dependent-view video stream at the same presentation time are provided with the same DTS, and the pictures in the dependent-view video stream and the base-view video stream are also provided with the same DTS. The pictures in the video streams at the same presentation time, however, may not be provided with the same DTS. For example, as shown in FIG. 35, the DTS of the 2D compatible video stream may be set so that the 2D compatible video stream is decoded before the base-view/dependent-view video streams (for example, one frame before).

Adopting this structure allows for decoding of the 2D compatible video stream to be performed in advance, thus providing for leeway when overwriting the inter-view buffer or when decoding pictures in the dependent-view video stream.

Note that, in FIG. 35, the PTS of the pictures in the 2D compatible video stream that store parallax images at the same presentation time have the same value as that of the PTS of the pictures in the dependent-view video stream. In order to perform decoding of the 2D compatible video stream in advance, however, the PTS of the pictures in the 2D compatible video stream that store parallax images at the same presentation time may be set to be before the base-view/dependent-view video streams (for example, one frame before).

If the value of the PTS is thus set differently between the 2D compatible video stream and the multi-view video stream, for example, by setting the PTS of pictures in the 2D compatible video stream to be one frame before the PTS of pictures in the dependent-view video stream, then when pictures of the base-view video stream in the inter-view buffer are replaced, pictures in the base-view video stream may be replaced with pictures in the 2D compatible video stream whose PTS is one frame less.

Note that even if the values of the PTS/DTS allocated to actual data are set as shown in FIG. 23, decoding processing may be configured to correct the values internally, so that the DTS/PTS of pictures in the 2D compatible video stream are moved up.

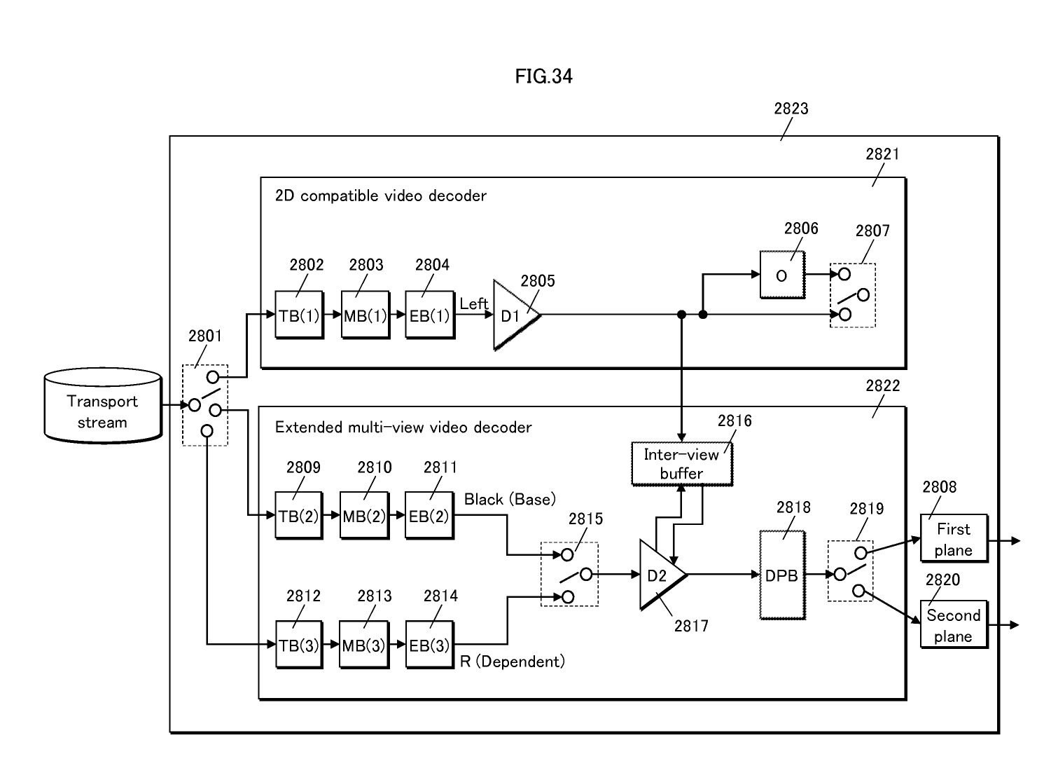

(9) In the playback device in the present embodiment, in step S3005, the 2D compatible video decoder 2821 outputs a decoded picture from the 2D compatible video stream to the first plane 2808 in accordance with each PTS. As shown in FIG. 34, however, the extended multi-view video decoder 2822 may output both video images using the output plane switch 2819.

Adopting this structure allows for direct use of the mechanism for plane output to play back 3D video images using the existing multi-view video stream.

(10) In the present embodiment, the multiplex format has been described as a transport stream, but the multiplex format is not limited in this way.

For example, the MP4 system format may be used as the multiplex format. A file multiplexed in MP4, as an input in FIG. 34, is separated into the 2D compatible video stream, the base-view video stream, and the dependent-view video stream and decoded. The pictures in the dependent-view video stream are decoded with reference to the pictures obtained by overwriting the pictures in the 2D compatible video stream with the pictures in the base-view video stream in the inter-view buffer 2816. Since the MP4 system format does not involve PTSs, header information (stts, stsz, and the like) in the MP4 system format may be used to identify time information for each access unit.

(11) In the base-view video stream and the dependent-view video stream of the present embodiment, the pictures referred to by the dependent-view video stream are the decoded pictures for the 2D compatible video stream, which differs from the structure of a regular multi-view video stream. In this case, the stream type or the stream_id assigned to the PES packet header may be set to a different value than in a conventional multi-view video stream.

By adopting this structure, the playback device can determine the playback method for 3D video images in the present embodiment by referring to the stream type or the stream_id, and change the playback method accordingly.

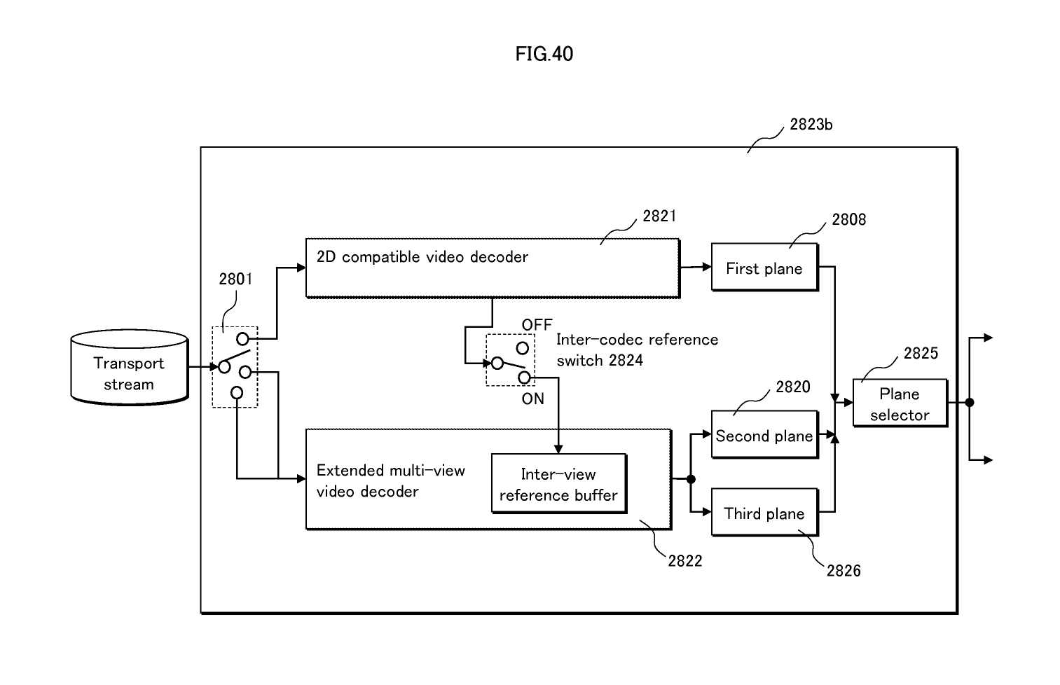

(12) Described in the present embodiment is the playback format stored in the descriptor explained with reference to FIG. 38. The method of switching the playback format, however, may be achieved as shown in FIG. 40.

A playback device 2823b illustrated in FIG. 40 has basically the same structure as the playback device 2823 described with reference to FIG. 28. An inter-codec reference switch 2824, a plane selector 2825, and a third plane 2826, however, have been added to the playback device 2823b.

When the inter-codec reference switch 2824 is ON as illustrated in FIG. 40, the data transfer described in step S3003 from the 2D compatible video decoder to the inter-view buffer in the extended multi-view video decoder is performed. When inter-codec reference switch 2824 is OFF, the data transfer is not performed.

The plane selector 2825 selects which of the following planes to output for the 2D video images, or left-view images or right-view images of 3D video images: the first plane 2808, to which the 2D compatible video decoder outputs pictures; the second plane 2820, to which the extended multi-view video decoder outputs pictures in the base-view video stream; and the third plane 2826, to which the extended multi-view video decoder outputs pictures in the dependent-view video stream.

By switching outputs by the inter-codec reference switch 2824 and the plane selector 2825 in accordance with the playback format, the playback device 2823b can change the playback mode.

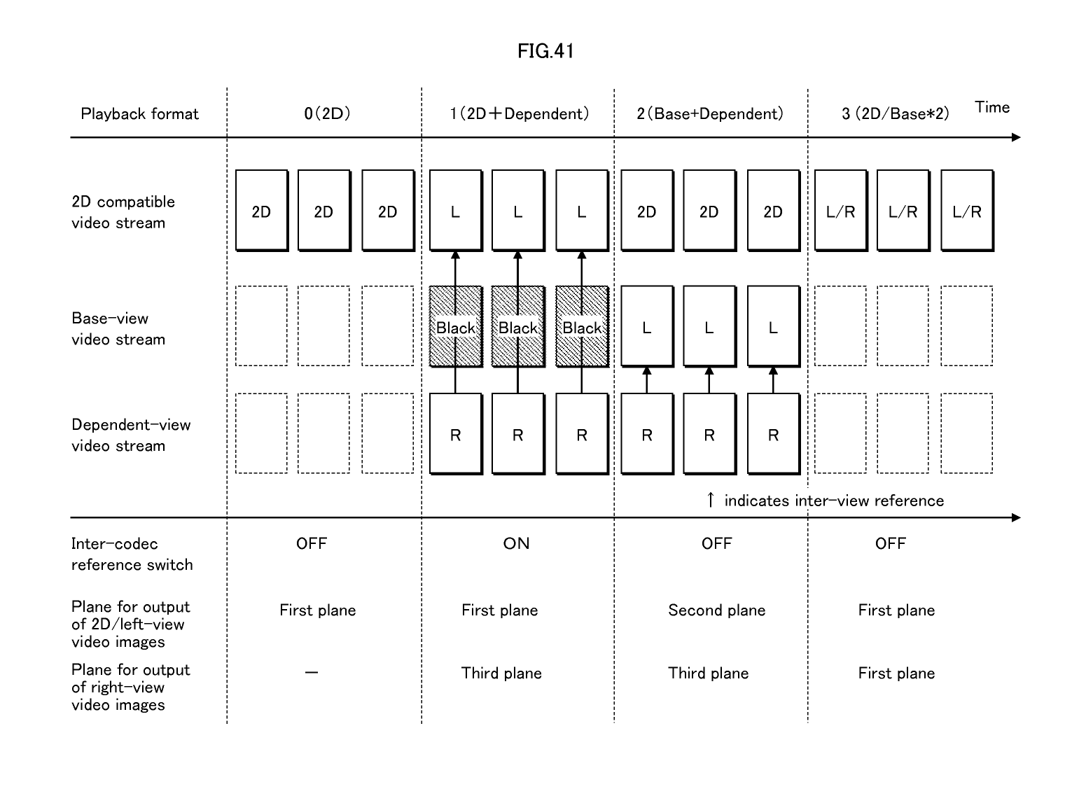

A specific process to change the playback method for the example of the playback format in FIG. 38 is described with reference to FIG. 41.

The lower tier of FIG. 41 illustrates ON-OFF switching performed by the inter-codec reference switch 2824 and examples of a plane selected by the plane selector 2825.

When the playback format is “0”, the playback device 2823b turns the inter-codec reference switch 2824 OFF. The plane selector 2825 selects the first plane 2808 for 2D video images.

When the playback format is “1”, the playback device 2823b turns the inter-codec reference switch 28240N. The plane selector 2825 selects the first plane 2808 or the second plane 2820 for left-view video images and the third plane 2826 for right-view video images.

When the playback format is “2”, the playback device 2823b turns the inter-codec reference switch 2824 OFF. The plane selector 2825 selects the second plane 2820 for left-view video images and the third plane 2826 for right-view video images.

When the playback format is “3”, the playback device 2823b turns the inter-codec reference switch 2824 OFF. The plane selector 2825 selects the first plane 2808 for left-view video images and the first plane 2808 for right-view video images.

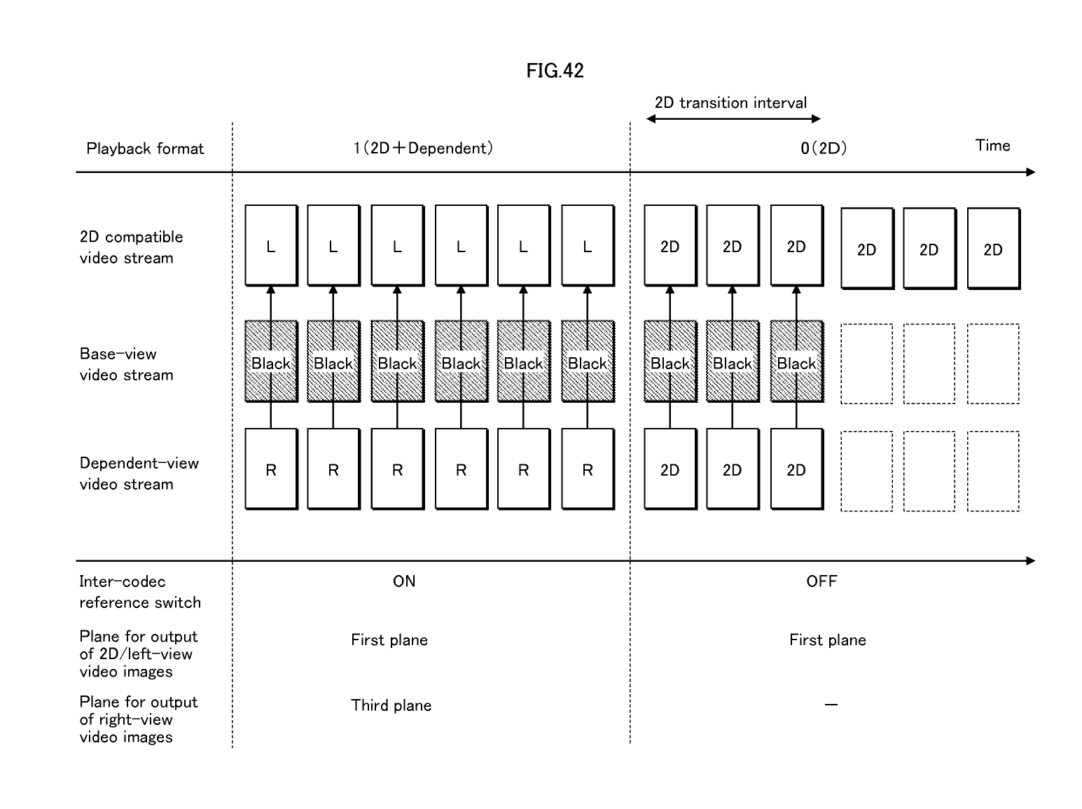

(13) In the present embodiment, when a transport stream is generated in which the playback format is switched from 3D video image playback using the 2D compatible video stream and the dependent-view video stream to 2D video image playback using the 2D compatible video stream, as shown in FIG. 42, the same images as the 2D compatible video stream may be compression-encoded in the dependent-view video stream at the point at which the playback format changes, considering delay in decoding. Such an interval during which the same images as the 2D compatible stream are compression-encoded in the dependent-view video stream is denoted as a 2D transition interval, as shown in the upper tier of FIG. 42. During the 2D transition interval, 2D video images are played back regardless of which format is used, thus presenting a smooth image transition to the viewer. The 2D transition interval may be adopted when transitioning from 2D video image playback to 3D video image playback. Furthermore, the 2D transition interval may be adopted when the value of “playback format” indicating the signaling information shown in FIG. 37 is switched from “0” to any of “1”, “2”, and “3”.

(14) The value of temporal_reference, included in each picture in compression encoding in the MPEG-2 format to indicate the presentation order, may be configured to be the same as the POC of a picture in the dependent-view video stream having the same presentation time.

This allows for compression encoding and decoding of the video stream in the MPEG-2 format using values in the video ES, without using the PTS.

Furthermore, the POC of the dependent-view video stream having the same presentation time may be included in user data in each picture in the 2D compatible video stream.

This allows for the value of temporal_reference to be set independently, thus increasing the degree of freedom during compression encoding.

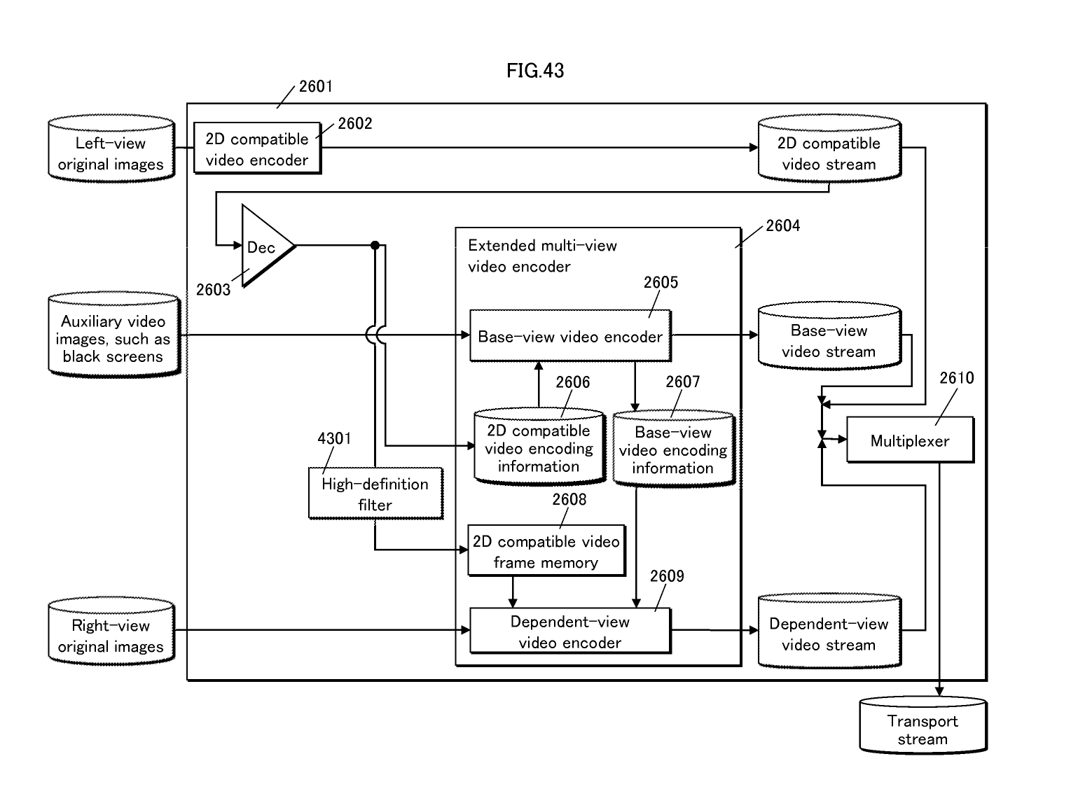

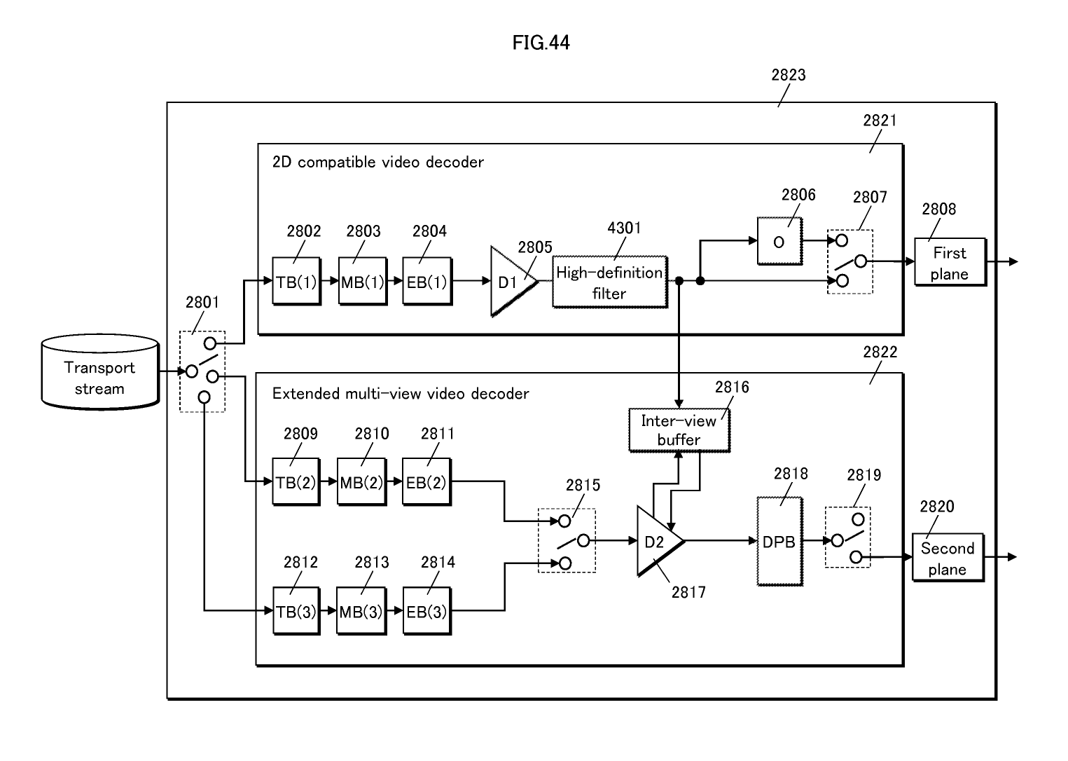

(15) In the present embodiment, a high-definition filter 4301 may be applied to the decoding results for the 2D compatible video stream, as shown in FIGS. 43 and 44.

The high-definition filter 4301 is, for example, a deblocking filter to reduce block noise as stipulated by MPEG-4 AVC. A flag is prepared to indicate whether the high-definition filter 4301 is applied. For example, when the flag is ON, the high-definition filter 4301 is applied, and, when the flag is set OFF, the high-definition filter 4301 is not applied.

The flag may be included in a descriptor of the PMT, in supplementary data of the stream, or the like.

If the flag is ON, the playback device applies the filter to the decoding results before transmitting data to the inter-view buffer 2816.

Adopting this structure increases definition of 2D video images in the 2D compatible video stream. Furthermore, decoding of the dependent-view video stream is performed while referring to the high-definition pictures. As a result, definition of 3D video images is also increased. Note that a plurality of high-definition filters 4301 may be adopted. Instead of a flag, the type of the filter may then be designated according to use.

(16) In the present embodiment, the case of one dependent-view video stream has been described, but there may be a plurality of dependent-view video streams.

In this case, the extended multi-view video stream may be configured to allow processing of a plurality of dependent-view streams. When replacing pictures in the inter-view buffer 2816 with pictures from the 2D compatible video stream, pictures in the base-view that have the same PTS may then be replaced. The 2D compatible video stream may be configured to specify the replaced View ID. In this way, the base-view pictures are not necessarily replaced; rather, pictures that are replaced may be selected from among a plurality of views.

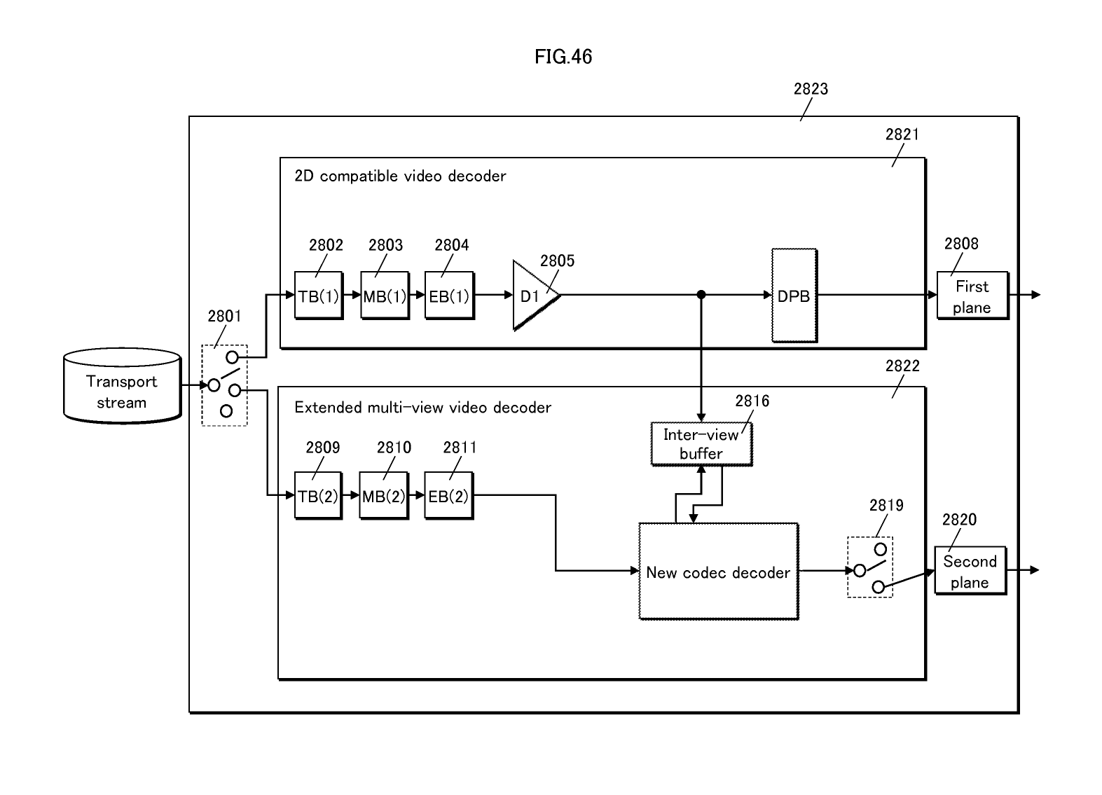

(17) In the present embodiment, the 2D compatible video stream has been described as MPEG-2 video, and the multi-view video stream (the base-view video stream and the dependent-view video stream) as MPEG-4 MVC video, but the type of codec is of course not limited to these examples. The playback device and data encoding device of the present embodiment can be adapted to the characteristics of a codec by changing the structure as necessary. For example, if the 2D compatible video stream is MPEG-4AVC, and the multi-view video stream is a “new codec”, then as seen in the playback device in FIG. 46, the O 2806 and the switch 2807 in FIG. 34 may be replaced with the DPB, and picture data in the inter-view reference buffer 2816 may be managed according to the “new codec”.

(18) As an example of a method for viewing 3D video images using the video stream of the present embodiment, a method of having the viewer wear the 3D glasses provided with liquid crystal shutters has been described. The method of viewing 3D video images, however, is not limited to this method.

For example, a left-view picture and a right-view picture may be lined up in alternate rows within one screen to be displayed, and the pictures may pass through a hog-backed lens, referred to as lenticular lens, on the display screen so that pixels constituting the left-view picture form an image for only the left eye, whereas pixels constituting the right-view picture form an image for only the right eye, thereby showing the left and right eyes a parallax picture perceived as 3D video images. Instead of using a lenticular lens, a device with a similar function, such as a liquid crystal element, may be used.

Another method referred to as a polarization method may be used. In the polarization method, a longitudinal polarization filter is provided for left-view pixels, and a lateral polarization filter is provided for right-view pixels, and the viewer looks at the display while wearing polarization glasses provided with a longitudinal polarization filter for the left eye and a lateral polarization filter for the right eye.

In implementing stereoscopic viewing using parallax images, a depth map that indicates a depth value for each pixel in a 2D video image may separately be prepared when a right-view image and a left-view image are prepared, and parallax images consisting of a left-view image and a right-view image may be generated based on the 2D video image and the depth map.

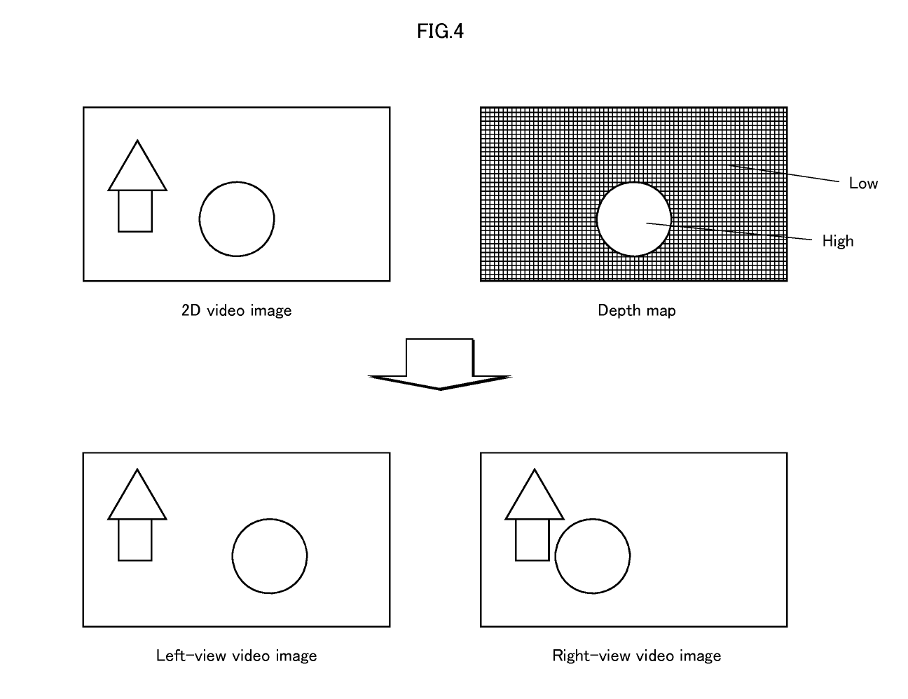

FIG. 4 schematically illustrates an example of generating parallax images consisting of a left-view image and a right-view image from a 2D video image and a depth map.

The depth map contains a depth value for each pixel in the 2D video image. In the example in FIG. 4, the depth map includes information indicating that the circular object in the 2D video image is on a near side (with a high depth value), whereas other regions are further than the circular object (with a low depth value). This information may be represented as a bit string for each pixel, or as a video image (such as a video image that is “black” to indicate a low depth value and “white” to indicate a high depth value). The parallax images can be created by adjusting the parallax amount of the 2D video image in accordance with the depth values in the depth map. In the example in FIG. 4, since the depth value of the circular object in the 2D video image is high, the parallax amount of the pixels for the circular object is set high when creating the parallax images. By contrast, since the depth value of the region other than the circular object is low, the parallax amount of the pixels is set low. A left-view image and a right-view image are then created. Stereoscopic viewing is possible by displaying these left-view and right-view images using the alternate frame sequencing method or the like.

<1-5. Supplemental Note>

<Video Compression Technology>

<2D Video Compression Technology>

The following briefly describes a method for encoding 2D video images in the MPEG-2 format and in the MPEG-4 AVC format (a compression encoding method based on which MPEG-4 MVC is achieved), which are the standards for compression encoding on 2D video images used in the data creation device and the playback device pertaining to the present embodiment.

These compression encoding methods utilize spatial and temporal redundancy in video in order to perform compression encoding on the amount of data.

One method for using redundancy to perform compression encoding is inter-picture predictive encoding. When a certain picture is encoded with inter-picture predictive encoding, a picture that has an earlier or later presentation time is used as a reference picture. The amount of motion as compared to the reference picture is detected, motion compensation is performed, and the difference between the motion compensated picture and the picture that is to be encoded is compressed.

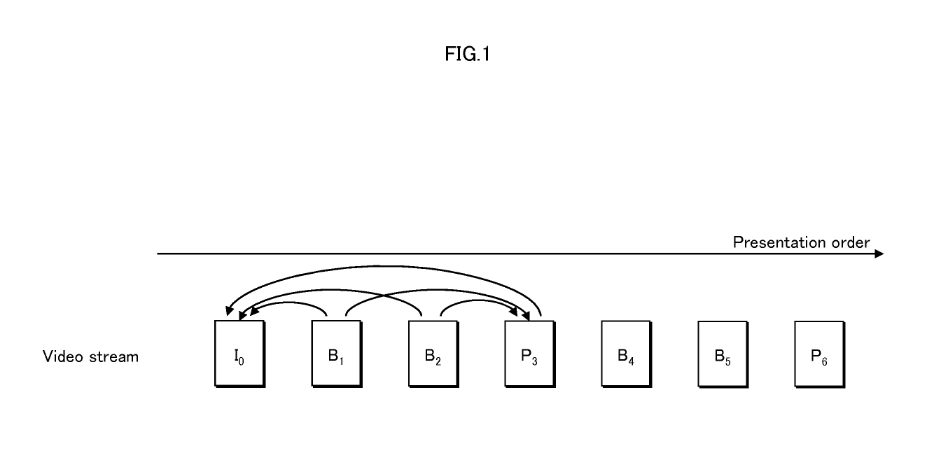

FIG. 1 illustrates reference relationships among pictures in a video stream. In FIG. 1, picture P3 is compression-encoded with reference to M. Pictures B1 and B2 are compression-encoded with reference to both I0 and P3. Using this sort of temporal redundancy allows for highly efficient compression encoding.

<3D Video Compression Technology>

The following briefly describes a method for playing back 3D video images on a display or the like by using parallax images, specifically a compression encoding method in the MPEG-4 MVC format as the multi-view encoding method.

In a method for stereoscopic viewing using parallax images, right-view images (R images) and left-view images (L images) are prepared, and stereoscopic viewing is achieved by presenting corresponding pictures to each of the right eye and the left eye.

Video constituted by left-view images is referred to as left-view video, and video constituted by right-view images is referred to as right-view video.

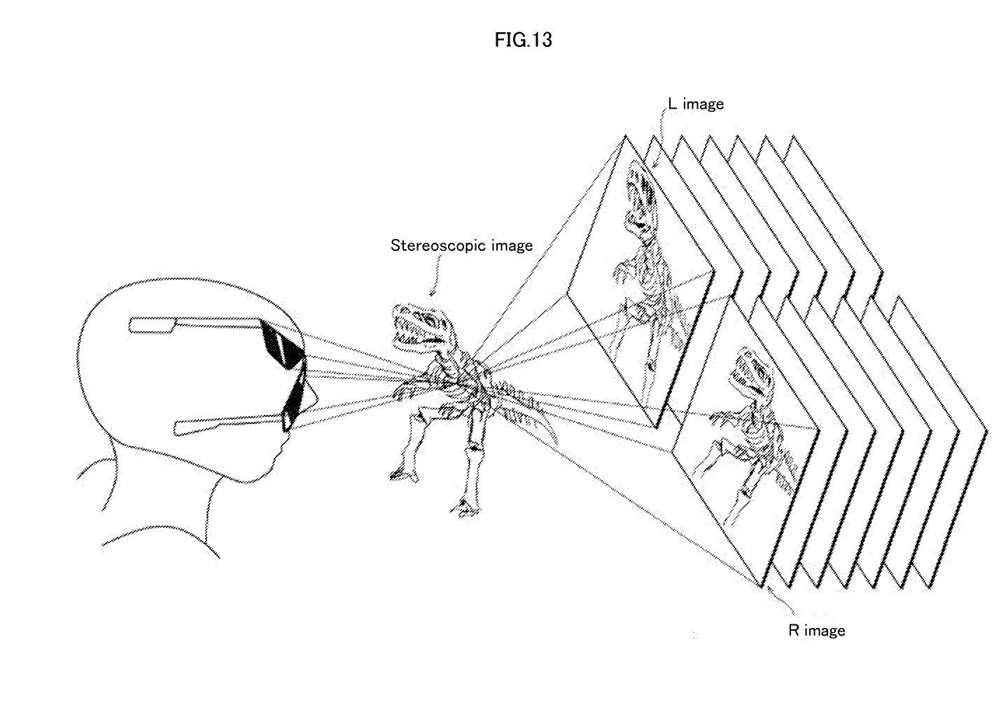

FIG. 13 illustrates an example of display of a stereoscopic video image. FIG. 13 illustrates an example of displaying left-view images and right-view images of the skeleton of a dinosaur as a target object. By repeatedly transmitting and blocking light to the right and left eyes using 3D glasses, the left and right scenes are overlaid within the viewer's brain due to the afterimage phenomenon of the eyes, causing the viewer to perceive a stereoscopic image as existing along a line extending from the user's face.

3D video methods to perform compression encoding on left-view video and right-view video include a frame alternating method and a multi-view encoding method.

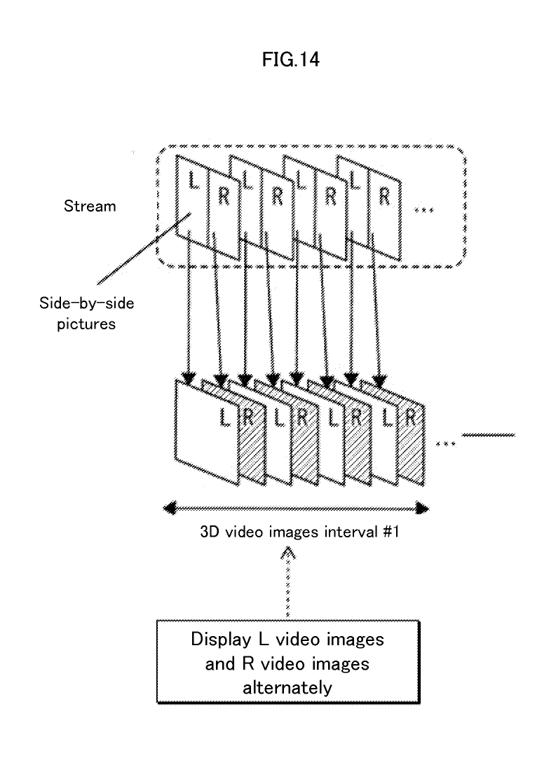

In a frame alternating method, pictures corresponding to the left-view video and the right-view video showing a view at the same presentation time are selectively discarded or compressed and combined into one picture to perform compression encoding. As an example, FIG. 14 illustrates the Side-by-Side method. In the Side-by-Side method, pictures corresponding to the left-view video and the right-view video showing a view at the same presentation time are compressed horizontally by a factor of ½ and are then placed side-by-side to form one picture. Video composed of the combined pictures is compression-encoded in the 2D video image compression encoding method (e.g. MPEG-2), thus yielding a video stream. At the time of playback, the video stream is decoded based on the same compression encoding method as that used to generate the video stream. Each decoded picture is separated into left and right images, which are horizontally expanded by a factor of two to yield pictures corresponding to the left-view video and the right-view video. The resulting pictures of the left-view video (L images) and of the right-view video (R images) are alternately displayed to achieve stereoscopic images, as shown in FIG. 13.

In contrast, the multi-view encoding method is a method in which pictures of the left-view video and of the right-view video are separately compression-encoded without being combined into a single picture.

In contrast, the multi-view encoding method is a method in which pictures of the left-view video and of the right-view video are separately compression-encoded without being combined into a single picture.

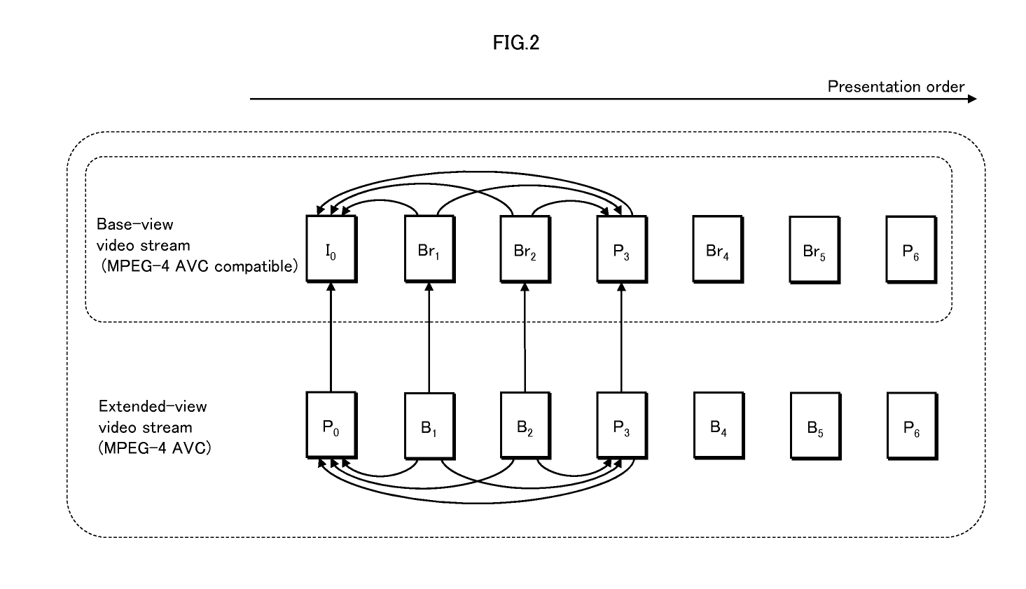

FIG. 2 illustrates encoding in the MPEG-4 MVC format, which is the multi-view encoding method.

The video stream in the MPEG-4 MVC format includes a base-view video stream that can be played back by conventional devices for playing back video streams in the MPEG-4 AVC format and a dependent-view video stream that, when processed simultaneously with the base-view video stream, allows for playback of images from a different viewpoint.

The base-view video stream is compression-encoded by inter-picture predictive encoding that only uses redundancy between images from the same viewpoint without referring to images from a different viewpoint, as shown by the base-view video stream in FIG. 2.

On the other hand, the dependent-view video stream is compression-encoded by, in addition to the inter-picture predictive encoding that uses reference to an image from the same viewpoint, inter-picture predictive encoding that uses redundancy between images from different viewpoints.

Pictures in the dependent-view video stream are compression-encoded with reference to pictures in the base-view video stream having the same presentation time.

The arrows in FIG. 2 show reference relationships. A picture P0, which is the top P picture in the dependent-view video stream, refers to a picture I0, which is an I picture in the base-view video stream. A picture B1, which is a B picture in the dependent-view video stream refer to a picture Br1, which is a Br picture in the base-view video stream. A picture P3, which is the second P picture in the dependent-view video stream, refers to a picture P3, which is a P picture in the base-view video stream.

Since the base-view video stream does not refer to pictures in the dependent-view video stream, the base-view video stream can be decoded and played back alone.

On the other hand, the dependent-view video stream is decoded with reference to the base-view video stream, and therefore the dependent-view video stream cannot be played back alone. The dependent-view video stream, however, is subjected to inter-picture predictive encoding by using a picture showing a view at the same time from a different viewpoint. Since right-view images and left-view images with the same presentation time generally have a similarity (are highly correlated with each other), and compression encoding is performed on the difference between the right-view images and left-view images, the amount of data in the dependent-view video stream can be greatly reduced as compared to the base-view video stream.

<Explanation of Stream Data>

Digital streams in the MPEG-2 transport stream format are used to transmit digital television broadcast waves or the like.

The MPEG-2 transport stream is a standard for transmission by multiplexing a variety of streams, such as video and audio. The MPEG-2 transport stream is standardized in ISO/IEC 13818-1 as well as ITU-T Recommendation H222.0.

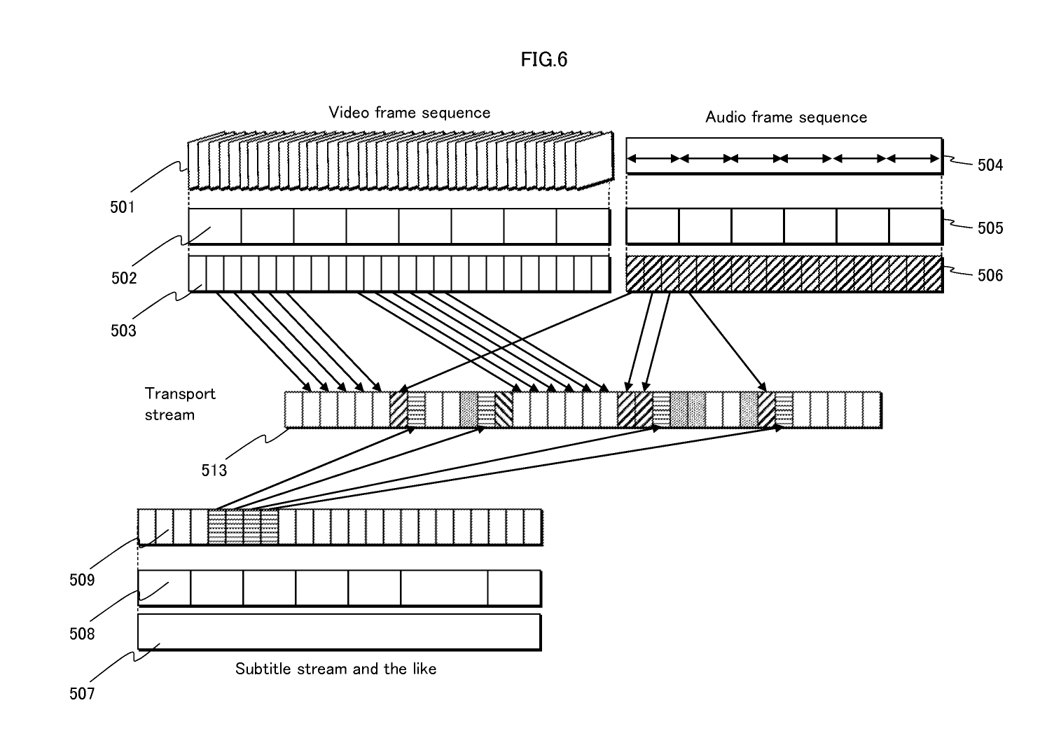

FIG. 6 illustrates the structure of a digital stream in the MPEG-2 transport stream format.

As illustrated in FIG. 6, a transport stream 513 is obtained by multiplexing a video TS (Transport Stream) packet 503, an audio TS packet 506, a TS packet 509 of a subtitle stream, and the like. Primary video for a program is stored in the video TS packet 503. Primary and secondary audio for the program is stored in the audio TS packet 506. Subtitle information for the program is stored in the TS packet 509 of the subtitle stream.

A video frame sequence 501 is compression-encoded with a method such as MPEG-2, MPEG-4 AVC, or the like. An audio frame sequence 504 is compression-encoded with an audio encoding method such as Dolby AC-3, MPEG-2 AAC, MPEG-4 AAC, HE-AAC, or the like.

Each stream stored in the transport stream is identified by a stream ID called a PID. A playback device can extract a target stream by extracting packets with the corresponding PID. The correspondence between PIDs and streams is stored in the descriptor of a PMT packet as described below.

In order to generate a transport stream, a video stream 501 composed of a plurality of video frames and an audio stream 504 composed of a plurality of audio frames are respectively converted into PES packet sequences 502 and 505. The PES packet sequences 502 and 505 are respectively converted into TS packets 503 and 506. Similarly, the data for a subtitle stream 507 is converted into a PES packet sequence 508, and then converted into TS packets 509. An MPEG-2 transport stream 513 is formed by multiplexing these TS packets into one stream. The PES packets and TS packets are described later.

<Data Structure of Video Stream>

The following describes the data structure of a video stream obtained by performing compression encoding on a video in the above-mentioned encoding method.

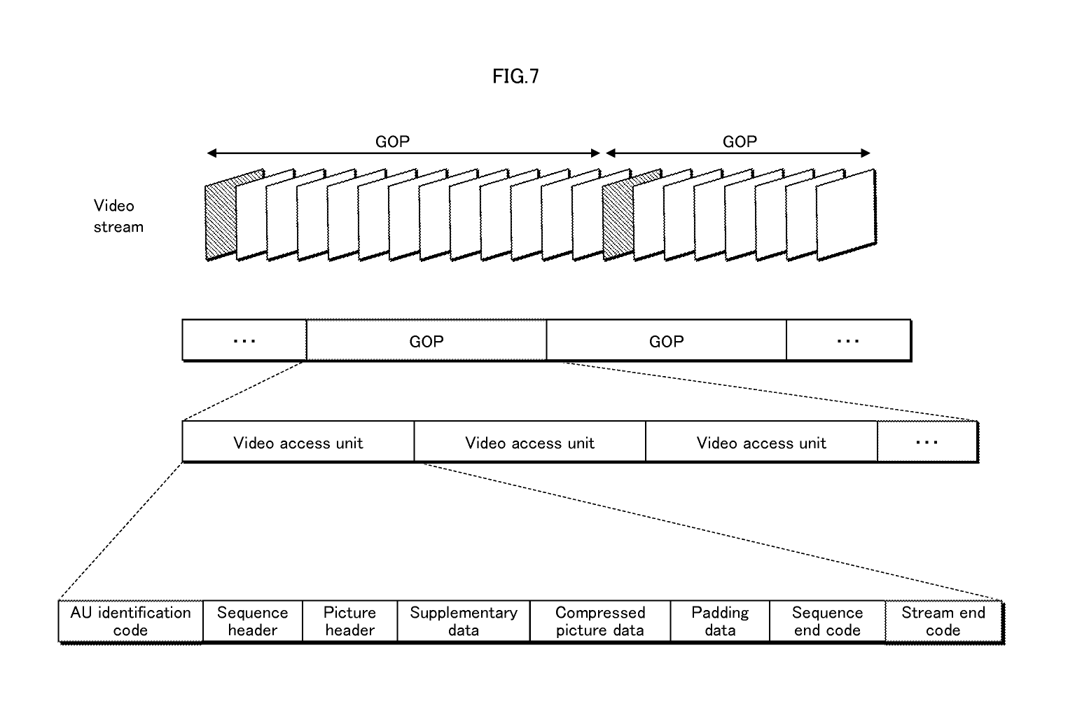

A video stream has a hierarchical structure as shown in FIG. 7. A video stream is composed of a plurality of Groups of Pictures (GOP). Using GOPs as the primary unit of encoding allows for moving images to be edited or randomly accessed.

A GOP is composed of one or more video access units. A video access unit is a unit of storage of compression-encoded data in a picture, storing one frame in the case of a frame structure, and one field in the case of a field structure. Each video access unit includes an AU identification code, a sequence header, a picture header, supplementary data, compressed picture data, padding data, a sequence end code, a stream end code, and the like. In the case of MPEG-4 AVC, each piece of data is stored in a unit called an NAL unit.

The AU identification code is a starting code indicating the top of an access unit.

The sequence header stores information that is shared across a playback sequence composed of a plurality of video access units, specifically information such as a resolution, a frame rate, an aspect ratio, a bit rate, and the like.

The picture header stores information such as the encoding method of the entire picture.

The supplementary data is additional information not necessary for decoding of compressed picture data and for example stores closed caption text information to be displayed on a television in synchronization with a video, information on the GOP structure, and the like.

The compressed picture data stores data of a picture that has been compression-encoded.

The padding data stores data for maintaining the format. For example, the padding data is used as stuffing data for maintaining a determined bit rate.

The sequence end code is data indicating the end of a playback sequence.

The stream end code is data indicating the end of the bit stream.

The structure of the AU identification code, the sequence header, the picture header, the supplementary data, the compressed picture data, the padding data, the sequence end code, and the stream end code varies by video encoding method.

For example, in the case of MPEG-4 AVC, the AU identification code corresponds to an AU (Access Unit) Delimiter, the sequence header to an SPS (Sequence Parameter Set), the picture header to a PPS (Picture Parameter Set), the compressed picture data to a plurality of slices, the supplementary data to SEI (Supplemental Enhancement Information), the padding data to Filler Data, the sequence end code to an End of Sequence, and the stream end code to an End of Stream.

For example, in the case of MPEG-2, the sequence data corresponds to sequence_Header, sequence_extension, and group_of_picture_header. The picture header corresponds to picture_header and picture_coding_extension. The compressed picture data corresponds to a plurality of slices. The supplementary data corresponds to user_data, and the sequence end code to sequence_end_code. There is no AU identification code, but the dividing line between access units can be determined using the start code of the various headers.

Not all of these data on attributes are always necessary. For example, a structure may be adopted in which the sequence header is only necessary in a video access unit at the top of a GOP and may be omitted from other video access units. A picture header may be omitted from a video access unit, with reference being made to the picture header of the previous video access unit in the encoding order.

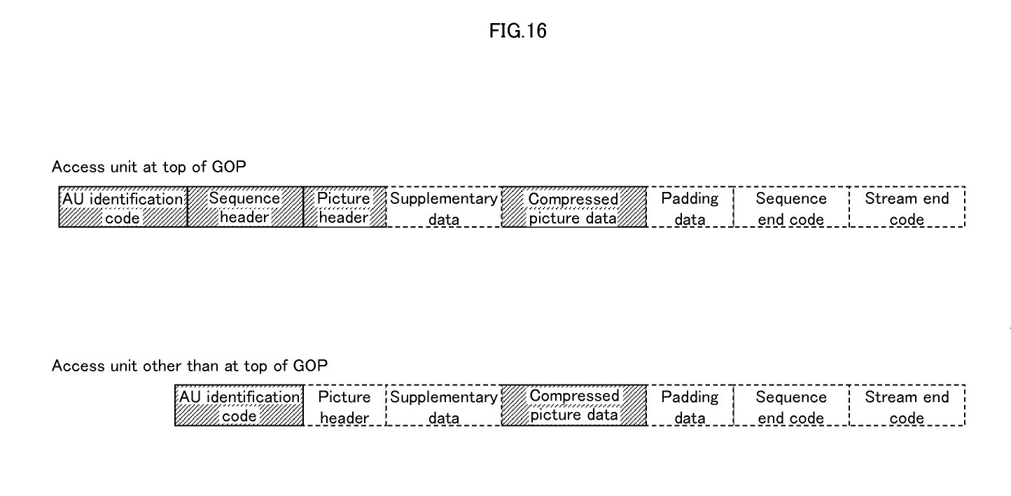

As shown in FIG. 16, the video access unit at the top of a GOP stores data of an I picture as compressed picture data and always includes the AU identification code, the sequence header, the picture header, and the compressed picture data. The video access unit at the top of a GOP may also store the supplementary data, the padding data, the sequence end code, and the stream end code if necessary. Video access units other than at the top of a GOP always store the AU identification code and the compressed picture data and may store the supplementary data, the padding data, the sequence end code, and the stream end code if necessary.

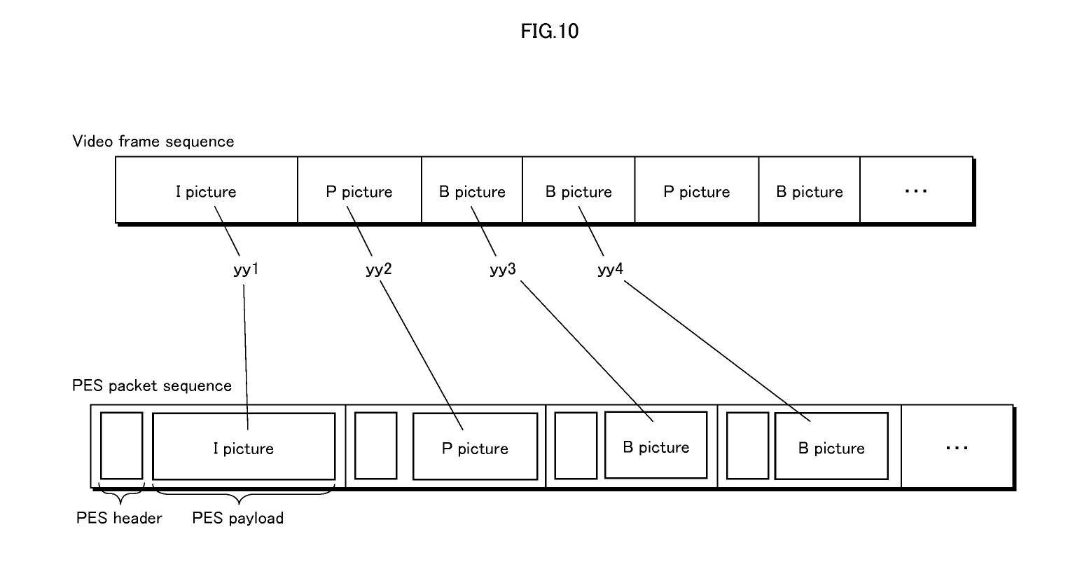

FIG. 10 illustrates how video streams are stored in a PES packet sequence.

The first tier in FIG. 10 illustrates a video frame sequence in the video stream. The second tier illustrates a PES packet sequence.

As shown by the arrows yy1, yy2, yy3, and yy4 in FIG. 10, the I picture, B pictures, and P pictures, which are a plurality of Video Presentation Units in the video stream, are separated picture by picture and stored in the payload of a PES packet.

Each PES packet has a PES header storing a PTS, which is the presentation time of the picture, and a DTS, which is the decoding time of the picture.

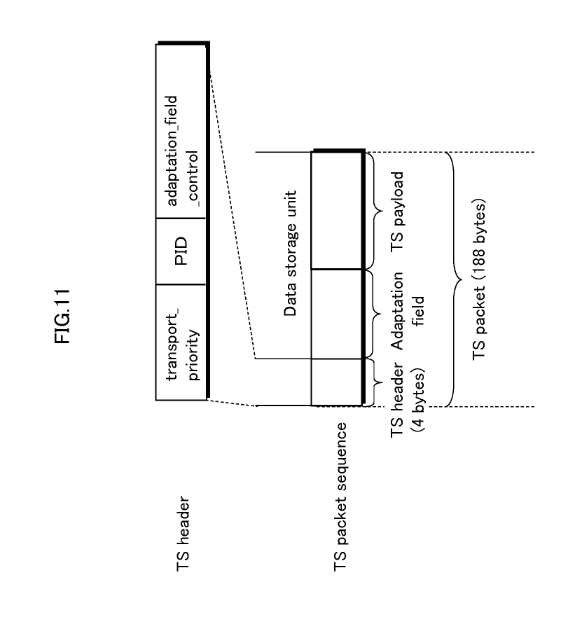

FIG. 11 illustrates the data structure of TS packets constituting a transport stream.

Each TS packet has a fixed length of 188 bytes and is composed of a 4-byte TS header, an adaptation field, and a TS payload. The TS header is composed of a transport_priority, a PID, an adaptation_field_control, and the like. The PID is an ID identifying the stream multiplexed in the transport stream, as described above.

The transport_priority identifies the type of packet among TS packets with the same PID.

The adaptation_field_control is information for controlling the structure of the adaptation_field_and the TS payload. It may be the case that only one of the adaptation field and the TS payload exists, or that both exist. The adaptation_field_control indicates which is the case.

When the adaptation_field_control is “1”, only the TS payload exists. When the adaptation_field_control is “2”, only the adaptation field exists. When the adaptation_field_control is “3”, both the TS payload and the adaptation field exist.

The adaptation field is a storage area for information such as a PCR (Program Clock Reference) and for data for stuffing the TS packet to reach the fixed length of 188 bytes. A PES packet is divided up and stored in a TS payload.

Other than TS packets of the video, audio, subtitle, and other streams, the transport stream also includes TS packets of a PAT (Program Association Table), a PMT, a PCR, and the like. These packets are referred to as Program Specific Information (PSI).

The PAT indicates what the PID of a PMT used in the transport stream is. The PID of the PAT itself is registered as “0”.

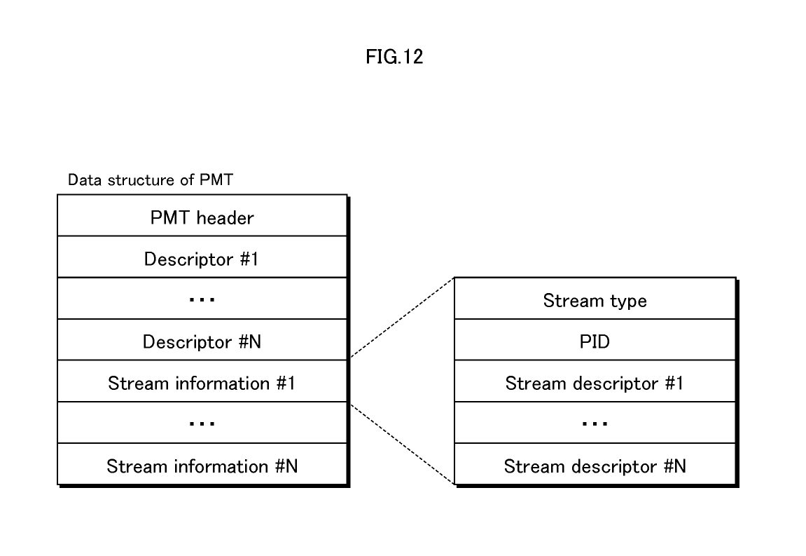

FIG. 12 illustrates the data structure of a PMT.

The PMT lists a PMT header, various descriptors related to the transport stream, and stream information related to each video, audio, subtitle, and other streams included in the transport stream.

Information of the length of data included in the PMT and the like are recorded on the PMT header.

The descriptors related to the transport stream include, for example, copy control information indicating whether or not copying of each video and audio stream is permitted.

Each piece of stream information is composed of a stream type indicating the compression encoding method or the like of the stream, the PID of the stream, and stream descriptors listing attribute information of the stream (the frame rate, the aspect ratio, and the like).

In order to synchronize the arrival time of TS packets to the decoder with the STC (System Time Clock), which is the time axis for the PTS/DTS, the PCR includes information on the STC time corresponding to the time at which the PCR packet is transferred to the decoder.

In the encoding in the MPEG-2 format and in the MPEG-4 MVC format, a region actually displayed within a compression-encoded frame region may be changed.

When pictures of the dependent-view video stream in the MPEG-4 MVC format are decoded while referring to pictures of the video stream in the MPEG-2 format by inter-view reference, it is necessary to adjust the attribute information so that the same cropping region and scaling are shown in a view at the same presentation time.

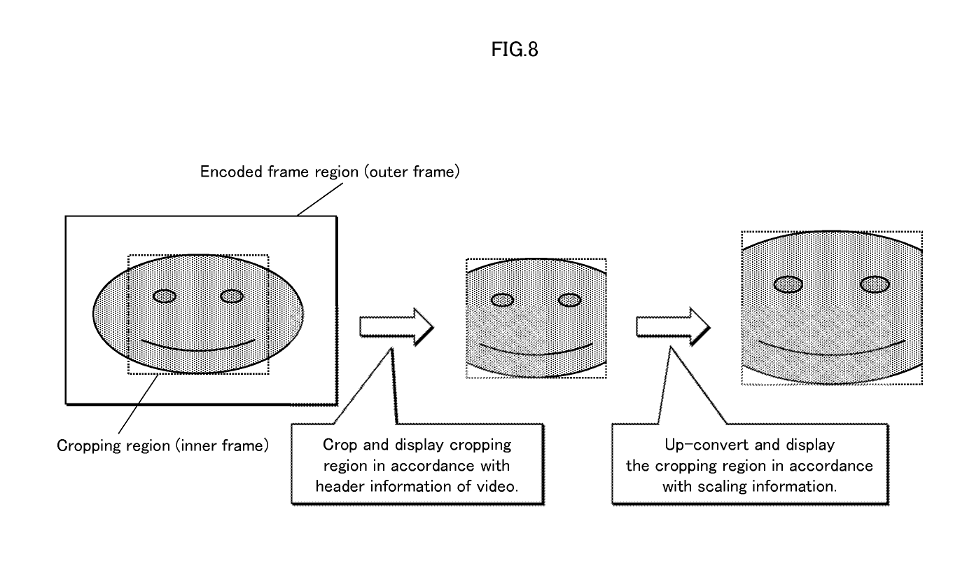

Next, the cropping region information and the scaling information are described with reference to FIG. 8.

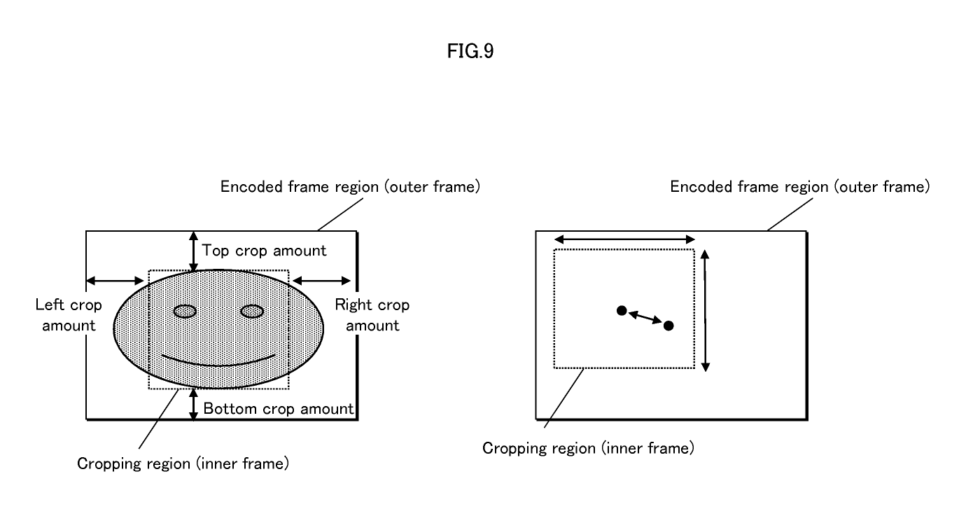

As shown in FIG. 8, the region actually displayed may be specified as a cropping region within the compression-encoded frame region. For example, in the case of MPEG-4 AVC, this region is specified using the frame_cropping information stored in the SPS. As shown to the left in FIG. 9, the frame_cropping information specifies the top, bottom, left, and right crop amounts as a top line, bottom line, left line, and right line in the cropping region and the offset from the compression-encoded frame region of the top line, bottom line, left line, and right line. In more detail, the cropping region is specified by setting a frame_cropping_flag to “1” and specifying the top, bottom, left, and right crop amounts respectively as a frame_crop_top_offset, frame_crop_bottom_offset, frame_crop_left_offset and frame_crop_right_offset.

In the case of MPEG-2, as shown to the right in FIG. 9, the cropping region is specified using the horizontal and vertical sizes of the cropping region (display_horizontal_size and display_vertical_size of sequence_display_extension) and information on the offset of the center of the cropping region from the center of the compression-encoded frame region (frame_centre_horizontal_offset and frame_centre_vertical_offset of picture_display_extension). Furthermore, scaling information indicating a scaling method when a cropping region is actually displayed on the television or the like is set as an aspect ratio. The playback device uses the information on the aspect ratio to up-convert and display the cropping region. For example, in the case of MPEG-4 AVC, information on the aspect ratio (aspect_ratio_idc) is stored in the SPS as scaling information. For example, an aspect ratio 4:3 is specified to expand a 1440×1080 cropping region to 1920×1080 and then display the region. In this case, the region is horizontally up-converted by a factor of 4/3 (1440×4/3=1920) to be expanded to 1920×1080 and then displayed.

In the case of MPEG-2 as well, information on the aspect ratio (aspect_ratio_information) is stored in the attribute information referred to as the sequence_header. By appropriately setting a value of the attribute information, processing similar to the above processing is realized.

<Data Structure of Video Stream in MPEG-4 MVC Format>

Next, the video stream in the MPEG-4 MVC format is described.

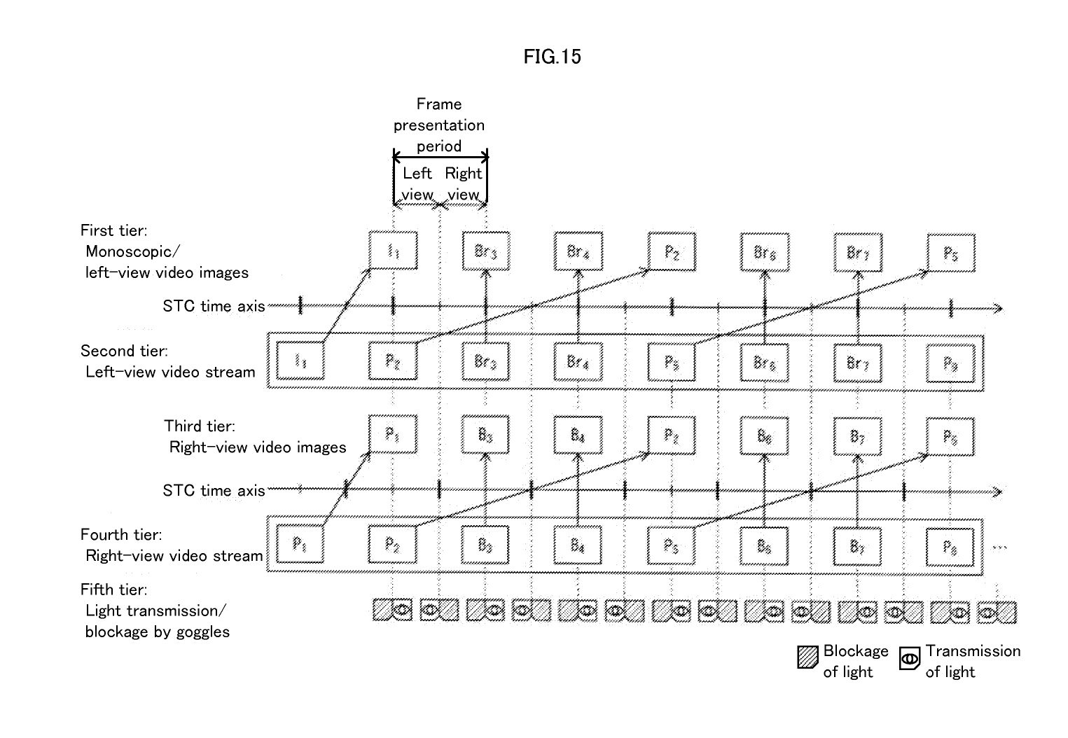

FIG. 15 illustrates an example of the internal structure of the video stream in the MPEG-4 MVC format.

In FIG. 15, pictures in the right-view video stream are compression-encoded with reference to pictures having the same presentation time in the left-view video stream. Pictures P1 and P2 in the right-view video stream respectively refer to pictures I1 and P2 in the left-view video stream. Pictures B3, B4, B6, and B7 in the right-view video stream respectively refer to pictures Br3, Br4, Br6, and Br7 in the left-view video stream.

The second tier in FIG. 15 illustrates the internal structure of the left-view video stream. The left-view video stream includes pictures I1, P2, Br3, Br4, P5, Br6, Br7, and P9. These pictures are decoded in accordance with the time set to the DTSs.

The first tier indicates left-view video images to be displayed on a display and the like. The left-view video images are displayed in accordance with the time set to the PTSs of the decoded pictures I1, P2, Br3, Br4, P5, Br6, Br7, and P9 in the second tier, i.e. in the order of I1, Br3, Br4, P2, Br6, Br7, and P5.

The fourth tier in FIG. 15 illustrates the internal structure of the right-view video stream. The right-view video stream includes pictures P1, P2, B3, B4, P5, B6, B7, and P8. These pictures are decoded in accordance with the time set to the DTSs.

The third tier indicates right-view video images to be displayed on a display and the like. The right-view video images are displayed in accordance with the time set to the PTSs of the decoded pictures P1, P2, B3, B4, P5, B6, B7, and P8 in the fourth tier, i.e. in the order of P1, B3, B4, P2, B6, B7, and P5. Presentation of one of the pair of a left-view video image and a right-view video image having the same PTS, however, is delayed by half of the interval between PTSs.

The fifth tier illustrates how the state of the 3D glasses 200 changes. As shown in the fifth tier, when a left-view video image is viewed, the shutter for the right eye closes, and vice-versa.

The following describes the relationship between access units in the base-view video stream and the dependent-view video stream.

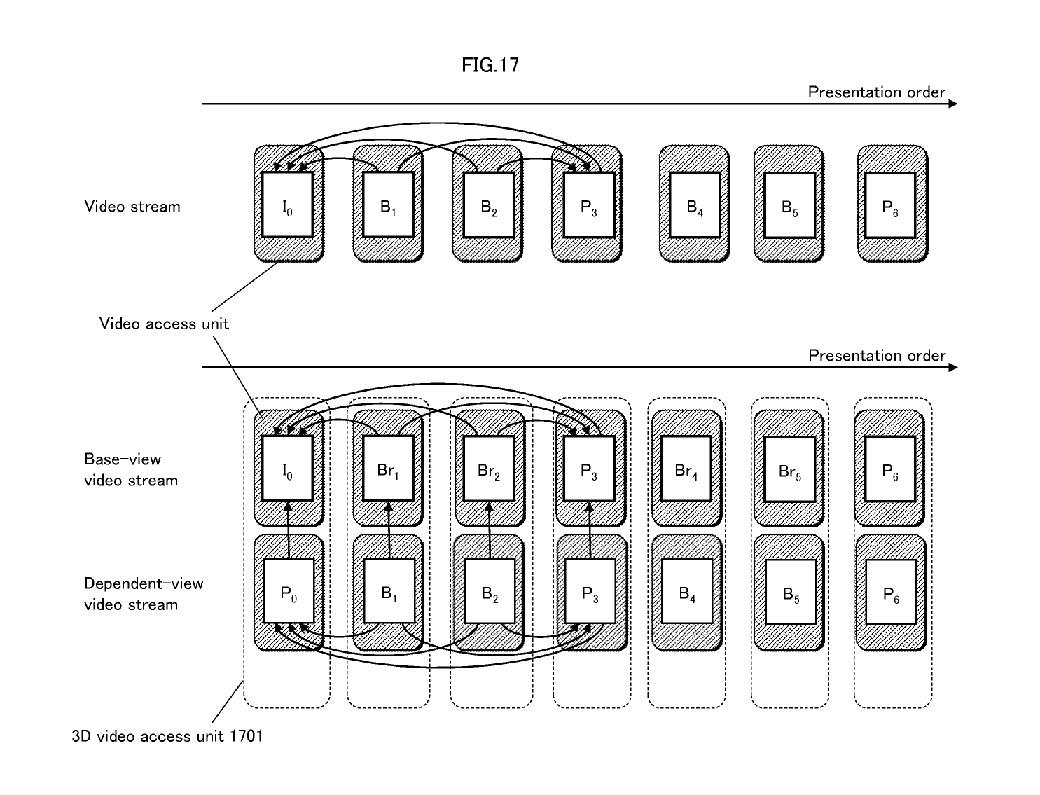

FIG. 17 illustrates the structure of video access units for pictures in the base-view video stream and in the dependent-view video stream. As described above, the base-view video stream is configured such that one picture corresponds to one video access unit, as shown in the upper tier of FIG. 17.

Similarly, as shown in the lower tier of FIG. 17, the dependent-view video stream is configured such that one picture corresponds to one video access unit. The data structure differs, however, than that of the video access unit in the base-view video stream.

A video access unit in the base-view video stream and a video access unit in the dependent-view video stream with the same PTS constitute a 3D video access unit 1701. The playback device performs decoding of one 3D video access unit at a time.

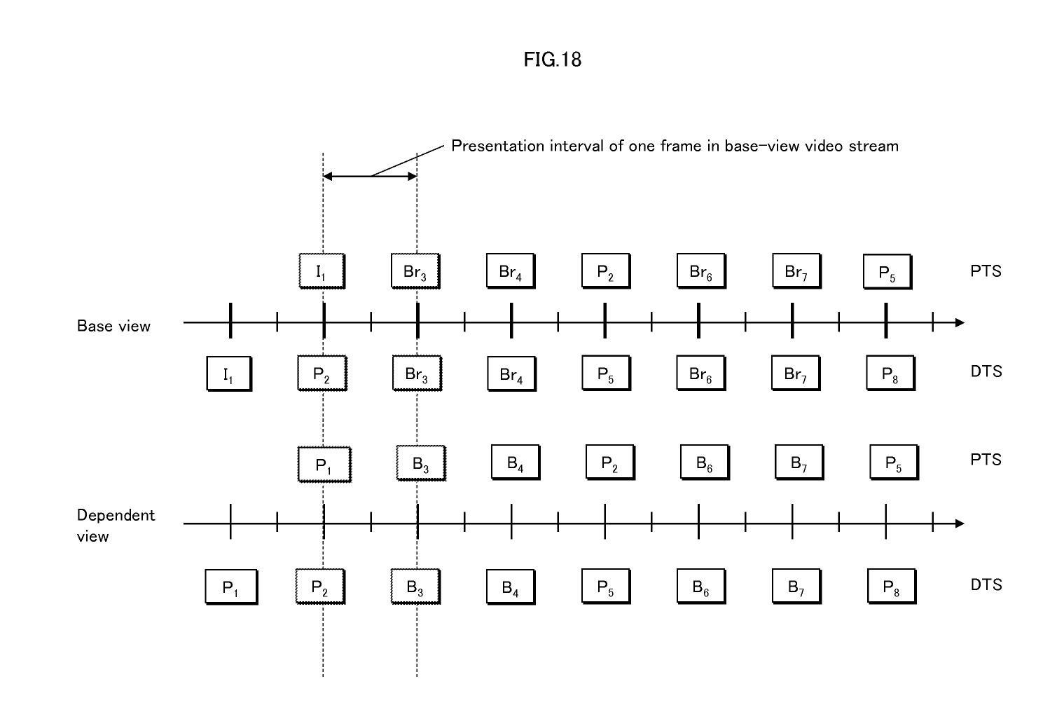

FIG. 18 illustrates an example of the relationship between the PTS and the DTS allocated to each video access unit in the base-view video stream and the dependent-view video stream within the video stream.

A picture in the base-view video stream and a picture in the dependent-view video stream that store parallax images showing a view at the same presentation time are set to have the same DTS/PTS.

With this structure, the playback device that decodes pictures in the base-view video stream and pictures in the dependent-view video stream can decode and display one 3D video access unit at a time.

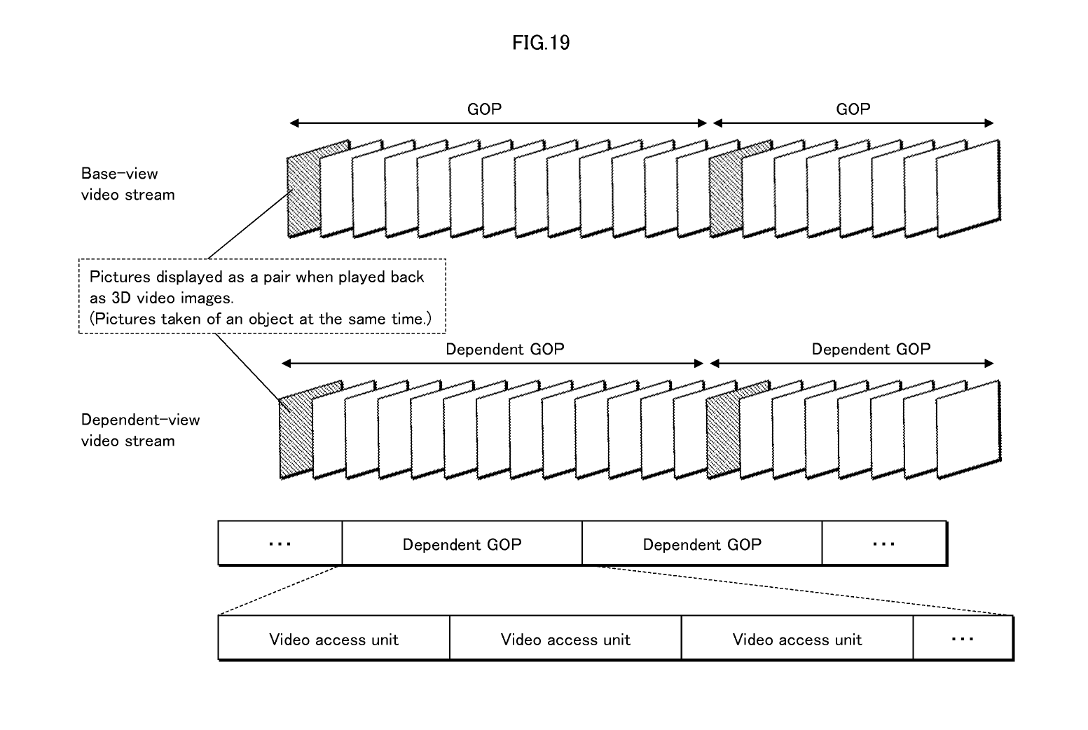

FIG. 19 illustrates the GOP structure of the base-view video stream and the dependent-view video stream.

The GOP structure of the base-view video stream is the same as the structure of a conventional video stream and is composed of a plurality of video access units.

The dependent-view video stream is also composed of a plurality of dependent GOPs.

When playing back 3D video images, the top picture in a dependent GOP is the picture displayed as a pair with the I picture in the top GOP of the base-view video stream and has the same PTS as the PTS of the I picture in the top GOP of the base-view video stream.

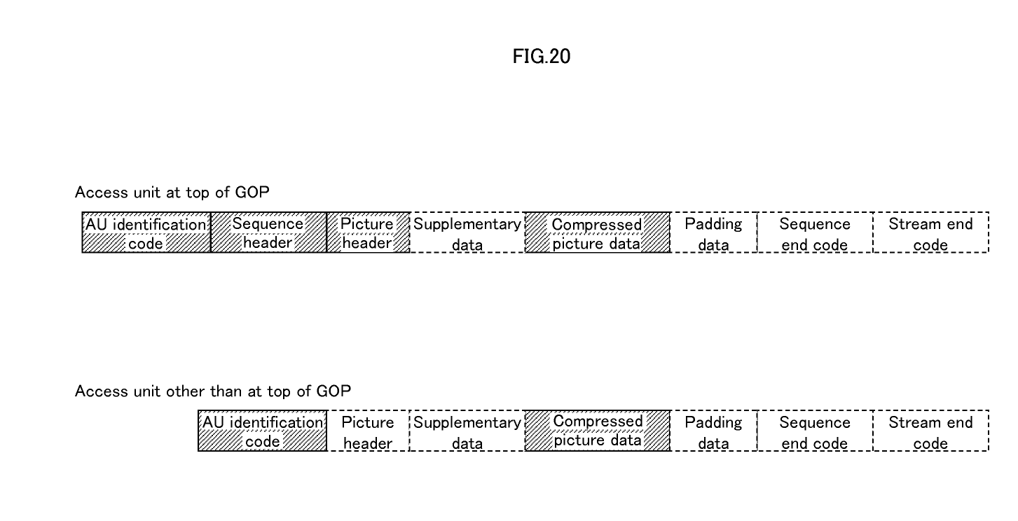

FIG. 20 illustrates the data structures of video access units included in the dependent GOP.

As shown in FIG. 20, the compressed picture data stored in the video access unit at the top of a dependent GOP is data for a picture displayed at the same time as the I picture at the top of a GOP in the base-view video stream. The video access unit at the top of the dependent GOP always stores a sub-AU identification code, a sub-sequence header, a picture header, and compressed picture data. The video access units other than at the top of the GOP may store the supplementary data, the padding data, the sequence end code, and the stream end code.

The sub-AU identification code is a starting code indicating the top of an access unit.

The sub-sequence header stores information that is shared across a playback sequence composed of a plurality of video access units, specifically information such as a resolution, a frame rate, an aspect ratio, a bit rate, and the like. The values for the frame rate, the resolution, and the aspect ratio in the sub-sequence header are the same as the frame rate, the resolution, and the aspect ratio of the sequence header included in the video access unit at the top of a GOP in the corresponding base-view video stream.

Video access units other than at the top of the GOP always store the sub-AU identification code and the compressed picture data. The video access units other than at the top of the GOP may store the supplementary data, the padding data, the sequence end code, and the stream end code.

### 2. Embodiment 2

<2-1. Outline>

In Embodiment 1, inter-view reference is performed between streams in which video images are compression-encoded with different codecs, whereby the multi-view video stream has a low bit rate. In the Embodiment, left-view video images are transferred as a 2D compatible video stream, and differential video images between the left-view video images and right-view video images are transferred as an extended video stream, so as to realize playback of 3D video images while maintaining the playback compatibility with conventional 2D video images.

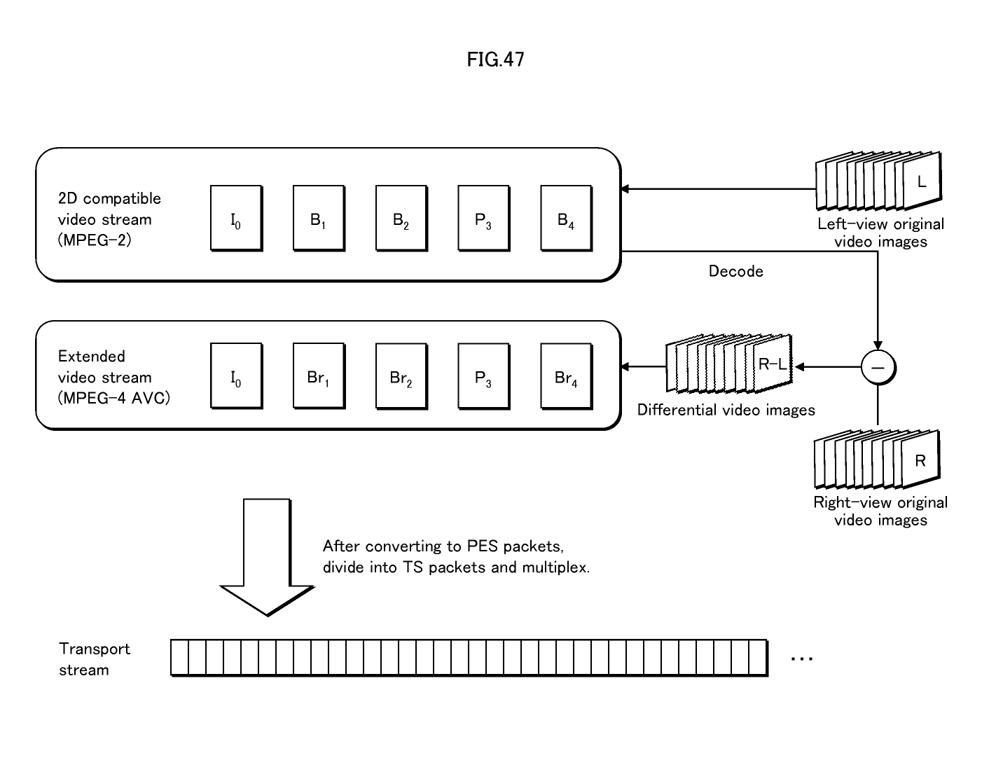

FIG. 47 illustrates the relationship between (i) video images constituting 3D video images and (ii) video streams which transmit the video images, according to the present Embodiment.

The 2D compatible video stream and the extended video stream are each a video stream configured in a format that allows a playback device for playing back 2D video images to play back 2D video images, as described in FIG. 7, and so on. 3D original video images are composed of left-view original video images (hereinafter “left-view video images”) and right-view original video images (hereinafter “right-view video images”). Differential video images represent the difference between the left-view video images and the right-view video images. In the 2D compatible video stream, left-view video images are stored in a state of being compression-encoded with use of an MPEG-2 video codec. In the extended video stream, differential video images representing the difference between (i) video images obtained by decoding the 2D compatible video stream and (ii) the right-view video images are stored in a state of being compression-encoded with use of an MPEG-4 AVC video codec. Each of the 2D compatible video stream and the extended video stream are converted into PES packets. The PES packets are then divided into TS packets. The TS packets are multiplexed as a transport stream and transmitted.

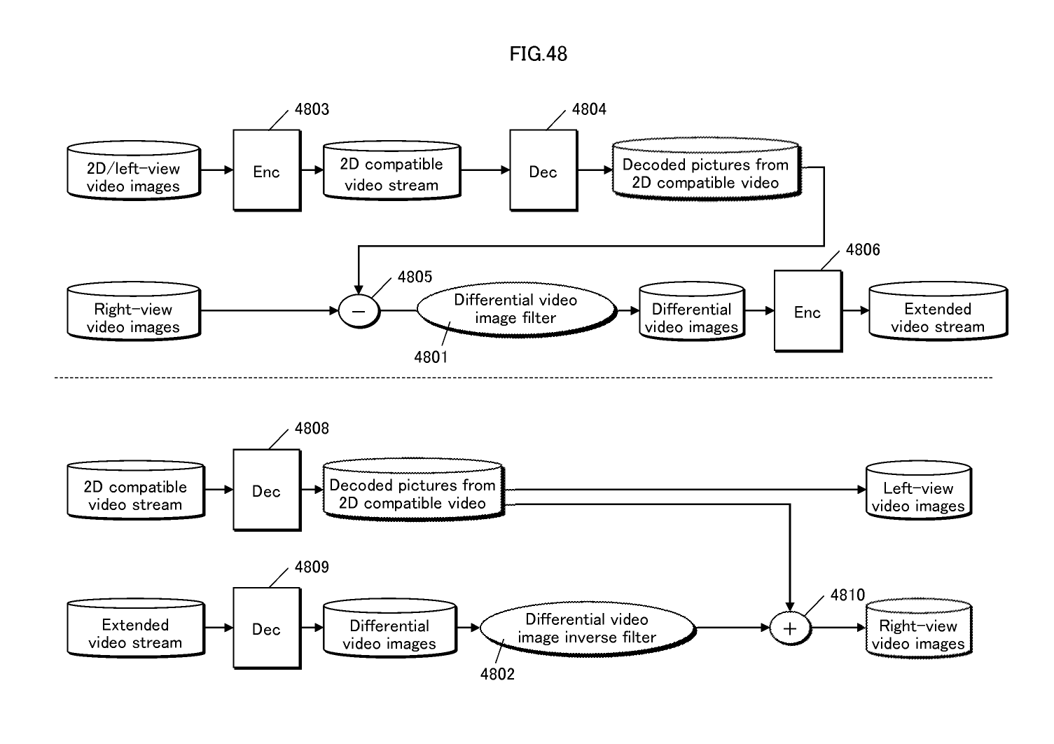

FIG. 48 illustrates an outline of a generation procedure and a decompression procedure of a 2D compatible video stream and an extended video stream. The upper tier of FIG. 48 illustrates the generation procedure.

First, a 2D compatible video stream is generated by compression-encoding (4803) left-view video images with use of the MPEG-2 video codec. The 2D compatible video stream is then decoded (4804) to obtain decoded pictures from the 2D compatible video stream.

Then, the differential values between pixels of each decoded picture from the 2D compatible video stream and pixels of each picture in the right-view video images are calculated (4805), and the differential values are filtered by a differential video image filter 4801.

Here, the differential video image filter 4801 is used to reduce the number of bits of each differential value. This is because simply calculating (4805) the differential value for each pixel yields signed information (e.g., in the case of eight-bit color, the signed information is information in nine bits between −255 and +255), which requires an extra bit indicating a sign. In order to encode the differential value into a video stream without the original bit length being increased, the number of bits indicating the differential value needs to be reduced. There are various methods for reducing the number of bits of a differential value. Here, the differential video image filter 4801 reduces the gradation accuracy to half. The differential video image filter 4801 outputs an output F(x)=(x+255)/2 when the differential video image filter 4801 receives input of a differential value x between pixels. In this way, the differential value is always converted into a positive number, enabling a regular video encoder to generate a video stream. Since the pixel values of differential video images are close to zero due to the redundancy of stereo images, the differential video images can be compressed with high compression efficiency.

Differential video images generated by the differential video image filter 4801 are compression-encoded (4806) according to the MPEG-4AVC video codec, whereby an extended video stream is generated.

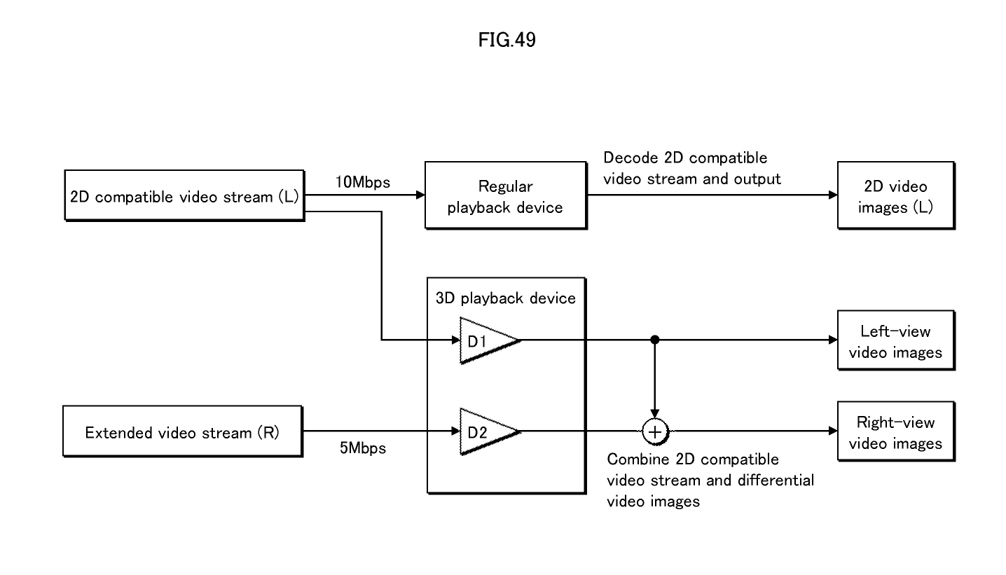

FIG. 49 illustrates an outline of the usage form of the streams generated as described above.

A regular playback device is capable of playing back only a 2D compatible video stream. It is assumed that the regular playback device has been widely commercially available and can play back a stream distributed by broadcast waves or the like. A 3D playback device according to an embodiment of the present embodiment is capable of decoding and playing back not only the 2D compatible video stream but also the extended video stream. It is assumed that the transport stream in FIG. 47 is broadcast when these two types of playback devices are present. The regular playback device decodes the 2D compatible video stream in the transport stream, and plays back 2D video images. On the other hand, the 3D playback device decodes the 2D compatible video stream in the transport stream, and thereby obtains left-view video images. Also, the 3D playback device refers to decoded pictures from the 2D compatible video stream, decodes the extended video stream, and thereby obtains right-view video images. The lower tier of FIG. 48 illustrates the playback procedure of 3D video images.

As for left-view video images, decoded pictures (4808) from the 2D compatible video stream are used as they are. As for right-view video images, pictures of differential video images are generated first by decoding (4809) the extended video stream. The pictures thus generated are then filtered by a differential video image inverse filter 4802. The differential video image inverse filter 4802 performs processing inverse to the processing of the differential video image filter 4801. For example, in a case where the differential video image filter 4801 reduces the gradation accuracy to half as described above (calculates F(x)=(x+255)/2), the differential video image inverse filter 4802 performs processing for calculating F(x)=2*x−255. Then, combination processing (4810) is performed pixel-by-pixel on (i) the pictures of the differential video images filtered by the differential video image inverse filter 4802 and (ii) decoded pictures (4808) from the 2D compatible video stream, whereby right-view video images are generated.

The above structure allows for broadcasting of 3D video images, which are to be played back by the 3D playback device, while maintaining playback compatibility with the 2D playback device widely commercially available. Concerning the differential video images between the left-view video images and the right-view video images, the pixel values constituting the differential video images are close to zero. This allows for configuration of the extended video stream at a low bit rate. Furthermore, the decoders for decoding the video streams can have the same structure as those for decoding regular video streams.

<2-2 Data>

The following describes the structure of each piece of data used in the present embodiment.

<2-2-1. PMT>

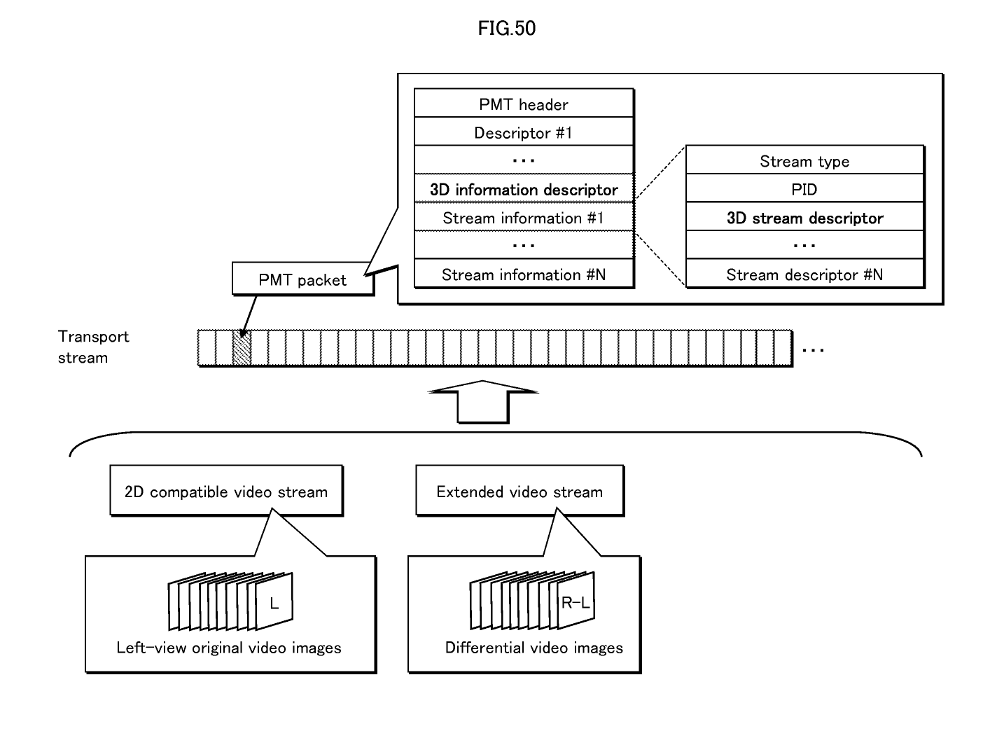

FIG. 50 illustrates PMT packets included in a transport stream. In a transport stream in which 3D video images are multiplexed, signaling information is added to system packets, such as PMT packets. The signaling information is used during decoding of the 3D video images. The signaling information includes a 3D information descriptor for signaling the relationship between video streams, the start and end of playback of 3D video images under present format, etc., and a 3D stream descriptor which is set for each video stream.

(1) 3D Information Descriptor

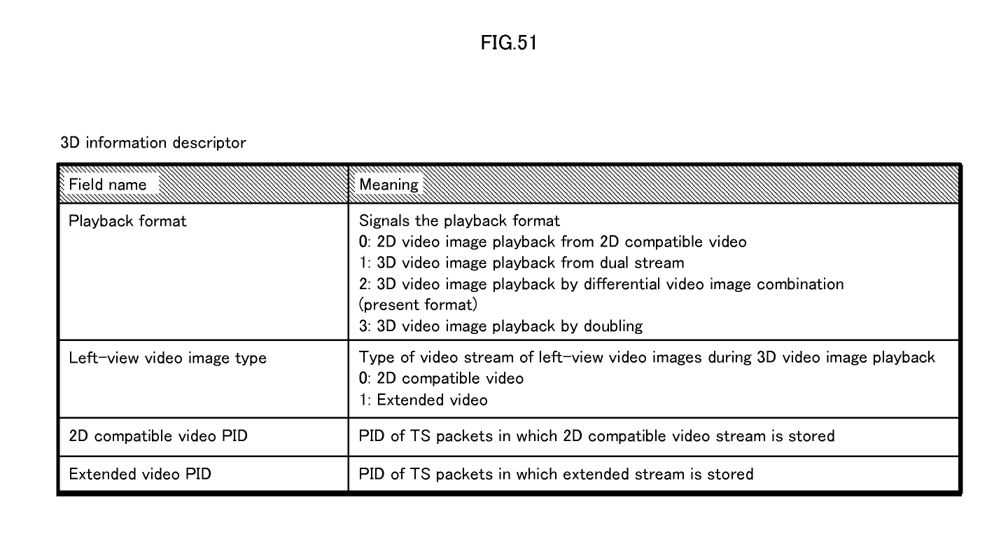

FIG. 51 illustrates the structure of the 3D information descriptor.

The 3D information descriptor includes fields for a playback format, a left-view video image type, a 2D compatible video PID, and an extended video PID.

The playback format defined in the 3D information descriptor is information for signaling the playback method of the playback device. A playback format of “0” indicates playback of 2D video images from the 2D compatible video stream. A playback format of “1” indicates playback of 3D video images from a dual stream. A playback format of “2” indicates playback of 3D video images according to the present embodiment. A playback format of “3” indicates doubling playback of the 2D compatible video stream. Here, doubling playback refers to outputting one picture at a given time A as both a left-view image and a right-view image. Doubling playback is equivalent to 2D video image playback in terms of the screen the viewer sees. Since no change occurs in the frame rate during 3D video image playback, however, no reauthentication of HDMI or the like occurs. This allows for a seamless playback connection with a 3D video playback section.

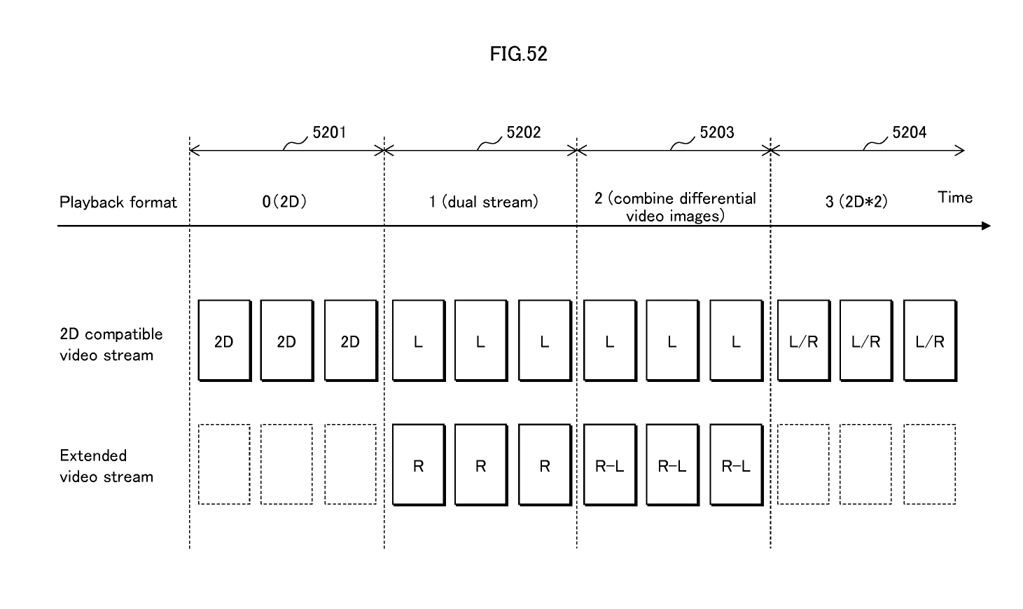

FIG. 52 illustrates an example of signaling regarding a playback format.

When the playback format in the 3D information descriptor, which is acquired from the stream, is “0” (section 5201), the playback device decodes only the 2D compatible video stream and plays back 2D video images. When the playback format indicates “1” (5202), it indicates that the 2D compatible video stream transmits either left-view video images or right-view video images, and the dual stream transmits the other. Accordingly, the playback device decodes and outputs the left-view video images and the right-view video images, and plays back 3D video images. When the playback format indicates “2”, the 2D compatible video stream is composed of either left-view video images or right-view video images, and the extended video stream is composed of differential video images. Accordingly, the playback device decodes the 2D compatible video stream to obtain left-view video images, decodes the extended video stream to obtain differential video images, and combines the left-view video images with the differential video images to obtain right-view video images (or left-view video images). When the playback format indicates “3”, the playback device decodes the 2D compatible video stream to perform doubling playback.

The left-view video image type in the 3D information descriptor indicates which of the two video streams is composed of left-view video images (and the other is composed of right-view video images), and this information is used together with the aforementioned playback format.

The left-view video image type may be ignored when the aforementioned playback format indicates “0” or “3”. When the playback format indicates “1”, the left-view video image type indicates which of the 2D compatible video stream and the extended video stream is composed of left-view video images. When the playback format indicates “2”, the left-view video image type indicates which of (i) the “2D compatible video stream” and (ii) the “combination video images, which are a combination of the decoded video images from the 2D compatible video stream and the differential video images from the extended video stream” is composed of left-view video images.

The 2D compatible video PID and the extended video PID in the 3D information descriptor indicate the PID of each video stream stored in the transport video stream. The playback device uses this information to specify the PID of a stream to be decoded.

(2) 3D Stream Descriptor

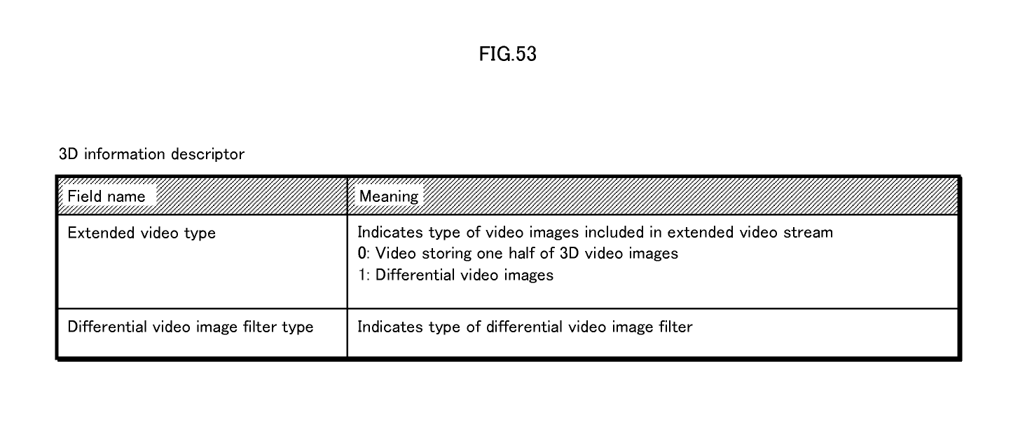

FIG. 53 illustrates the structure of a 3D stream descriptor.

The 3D stream descriptor includes fields for an extended video type and a differential video image filter type.

The extended video type indicates the type of video images constituting the extended video stream. When the extended video type indicates “0”, the extended video stream is composed of either left-view video images or right-view video images in 3D video images. When the extended video type indicates “1”, the extended video stream is composed of differential video images.

The differential video image filter type indicates, in a case where the extended video stream is composed of differential video images, the type of filter to be executed before decoded pictures from the extended video stream are combined with decoded pictures from the 2D compatible video stream. This allows for signaling to the playback device which filter to be executed from among multiple types of filters.

Note that all or a portion of the information in the 3D information descriptor and the 3D stream descriptor may be stored as supplementary data or the like for each video stream rather than being stored in PMT packets.

<2-2-2. PTS, DTS, GOP, and Others>

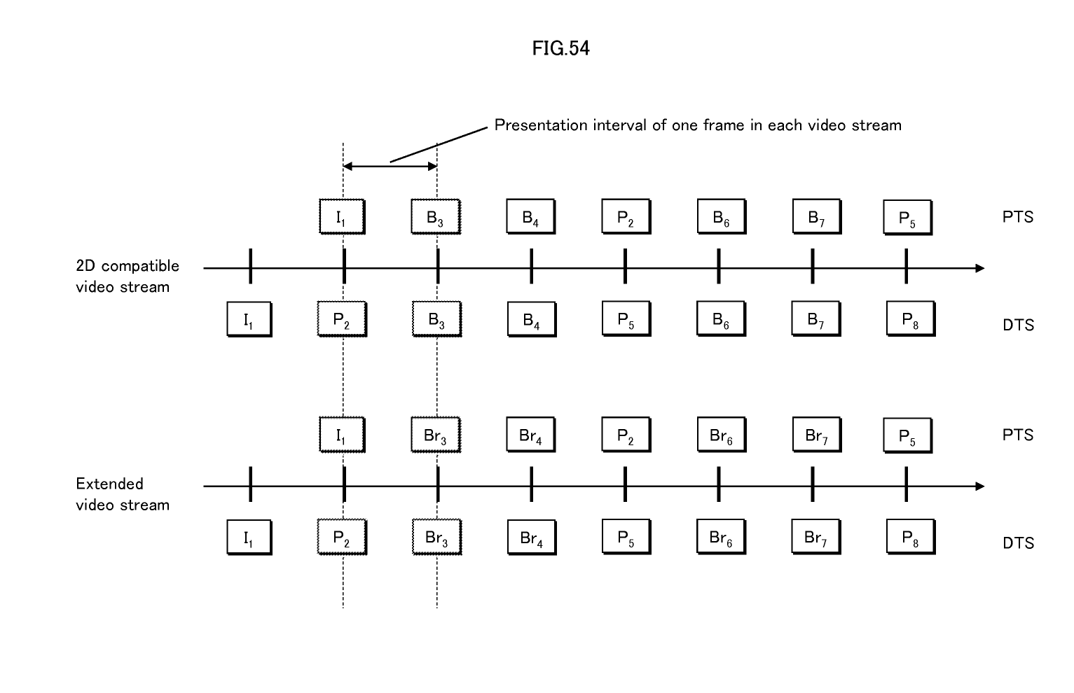

FIG. 54 illustrates an example of the relationship between a presentation time (PTS), a decoding time (DTS), and a picture type, which are allocated to each video access unit in the 2D compatible video stream and the extended video stream. A picture in the 2D compatible video stream and a picture in the extended video stream that constitute parallax images to be presented at the same time are each provided with the PTS having the same value. The DTS may not necessarily be the same since decoding of the 2D compatible video stream is performed independently from decoding of the extended video stream. In a case where a picture in the 2D compatible video stream is an I picture, a picture in the extended video stream having the same PTS as the picture in the 2D compatible video stream may also be an I picture. If a picture in the 2D compatible video stream at the time of interrupt playback is an I picture, decoding of all of the video streams is possible starting from that time. This facilitates processing of interrupt playback.

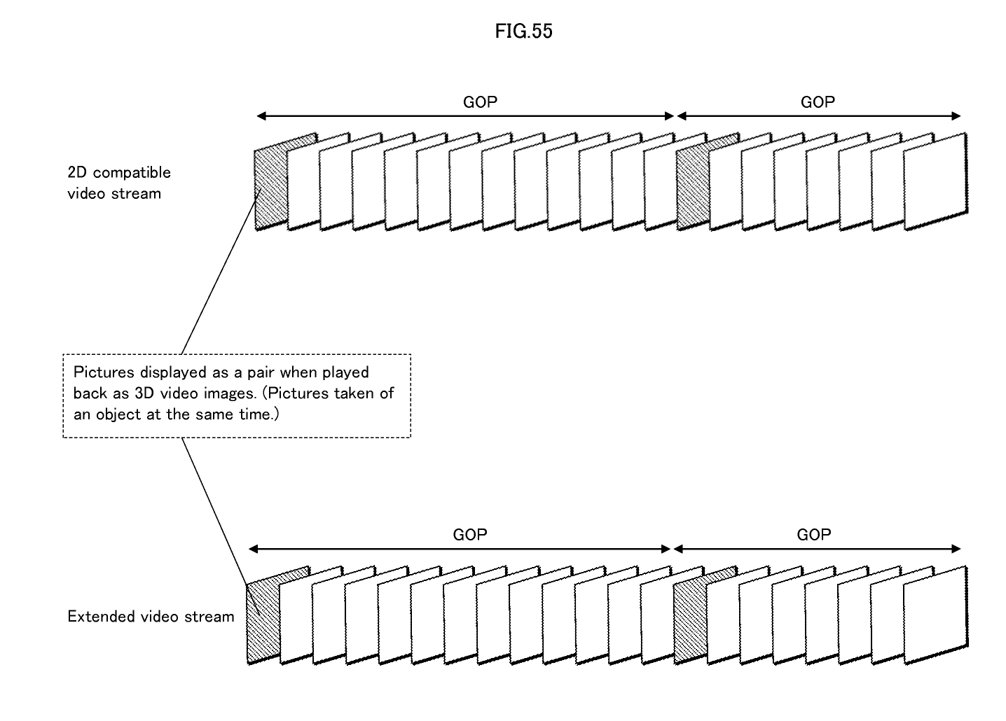

FIG. 55 illustrates the GOP structure of the 2D compatible video stream and the extended video stream. A GOP in the 2D compatible video stream has the same number of pictures as a GOP in the extended video stream. When a picture in the 2D compatible video stream is positioned at the top of a GOP, a picture in the extended video stream with the same presentation time (same PTS) is also positioned at the top of a GOP. With this structure, if, at the time of interrupt playback, a picture in the 2D compatible video stream targeted for decoding is an I picture, decoding of all video streams is possible starting from that time. This facilitates processing of interrupt playback. The interrupt playback refers to starting of playback at a certain point in a digital stream encoded with a variable-length coding scheme.

In a case where the transport stream is stored as a file, entry map information may be stored as management information to indicate where the picture at the top of a GOP is stored in the file. For example, in the Blu-ray Disc format, this entry map information is stored in a separate file as a management information file. In the transport stream of the present embodiment, if the position of the picture at the top of the GOP in the 2D compatible video stream is registered in an entry map, the position of the picture in the extended video stream with the same presentation time is also registered in the entry map. With this structure, interrupt playback of 3D video images is made simple by referring to the entry map.

As described above, since the 2D compatible video stream needs to be combined with the extended video stream, the attribute values in these video streams, such as the values of “resolution”, “aspect ratio”, “frame rate”, and “progressive or interlace”, are configured to be the same.

<2-3. Structure and Operations of Each Device>

The following describes the structures and operations of a data creation device and a playback device according to the present embodiment.

<2-3-1. Data Creation Device>

A data creation device receives input of left-view video images and right-view video images for 3D video images, encodes these video images to generate a transport stream described in FIG. 47, and outputs the transport stream thus generated.

<Structure>

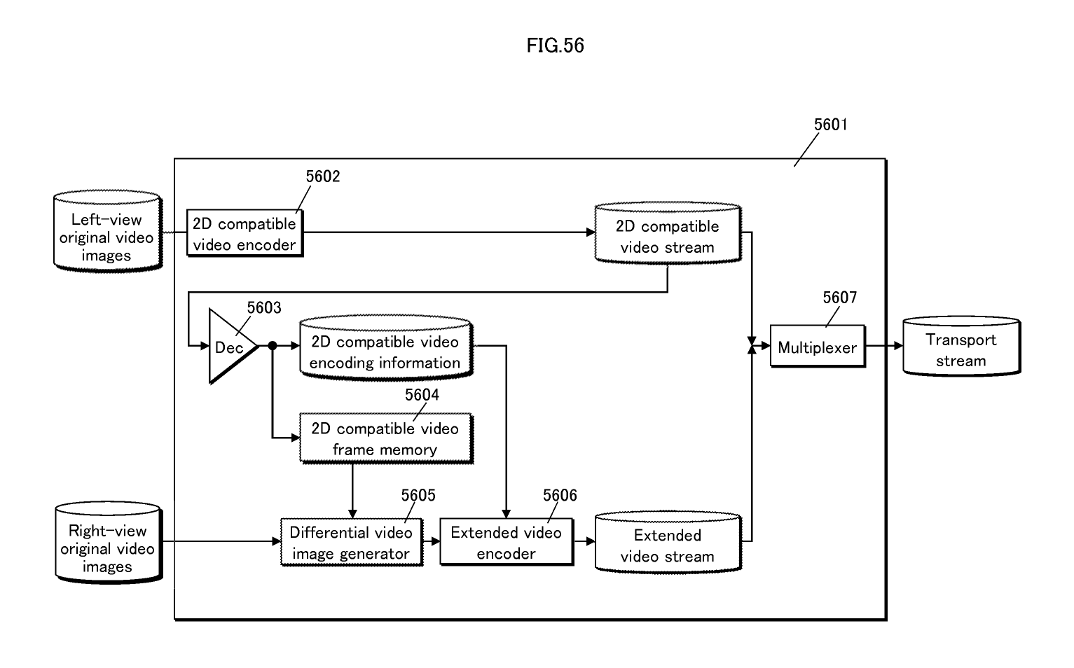

FIG. 56 illustrates the structure of a data creation device 5601 according to the present embodiment.

The data creation device 5601 includes a 2D compatible video encoder 5602, a 2D compatible video decoder 5603, a 2D compatible video frame memory 5604, a differential video image generator 5605, an extended video encoder 5606, and a multiplexer 5607.

The 2D compatible video encoder 5602 receives input of left-view video images, compression-encodes the left-view video images according to a 2D compatible video codec, and outputs a 2D compatible video stream. In the present embodiment, the codec is for MPEG-2 video codec.

The 2D compatible video decoder 5603 decodes the 2D compatible video stream, stores decoded picture data resulted from the decoding into the 2D compatible video frame memory 5604, and outputs 2D compatible video encoding information to the extended video encoder 5606. The 2D compatible video encoding information relates to the decoded video stream, and is composed of attribute information (resolution, aspect ratio, frame rate, progressive/interlaced, etc.), a picture type, a GOP structure, and so on.

The differential video image generator 5605 generates differential video images between decoded picture data stored in the 2D compatible video frame memory 5604 and received right-view video images, and outputs the differential video images to the extended video encoder 5606. As described above with reference to FIG. 48, the differential video images are generated by calculating the difference pixel-by-pixel for each picture, and applying the differential video image filter to the differences. The differential video image filter is the differential video image filter 4801 described in FIG. 48.

With reference to the 2D compatible video encoding information, the extended video encoder 5606 determines a video attribute, a picture structure, etc., for the differential video images output from the differential video image generator 5605. Then, the extended video encoder 5606 compression-encodes the differential video images according to the MPEG-4 AVC video codec, and thereby generates an extended video stream. This codec is not necessarily dependent on a 2D compatible video codec.

The multiplexer 5607 converts the 2D compatible video stream and the extended video stream into PES packets, divides the PES packets into TS packets, multiplexes the TS packets into a transport stream, and outputs the transport stream. The 2D compatible video stream and the extended video stream are set to have different PIDs.

<Operations>

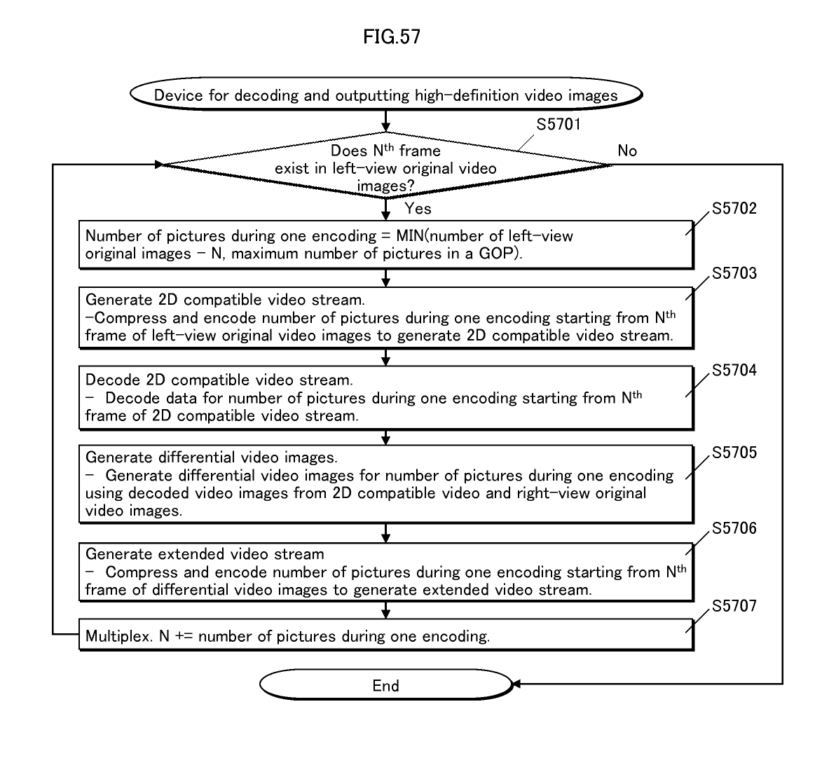

FIG. 57 is a flowchart showing data creation processing by the data creation device 5601 having the above structure.

In FIG. 57, the value N denotes the number of frames already compression-encoded. The value N is initialized to “0” before the processing shown in this flowchart.

The 2D compatible video encoder 5602 checks whether the N^{th} frame exists in the left-view video images (S5701). If not (step S5701: No), the 2D compatible video encoder 5602 determines that no more frame requires compression encoding, and terminates processing. If the N^{th} frame does exist (step S5701: Yes), processing proceeds to step S5702.

In step S5702, the 2D compatible video encoder 5602 determines the number of pictures to be compression-encoded in one compression encoding flow (steps S5702 to S5706). In the present embodiment, one GOP is compression-encoded during one compression encoding flow. Also, the smaller value between the number of pictures in the largest GOP and the remaining number of pictures to be compression-encoded in the original video images is set as the number of pictures during one encoding. Processing then proceeds to step S5703.

In step S5703, the 2D compatible video encoder 5602 generates a portion of the 2D compatible video stream for the number of pictures during one encoding. Specifically, the 2D compatible video encoder 5602 generates the 2D compatible video stream by compression-encoding the number of pictures during one encoding, starting from the N^{th} frame of the left-view video images, according to the 2D compatible video stream codec.

In step S5704, the 2D compatible video decoder 5603 decodes a portion of the 2D compatible video stream for the number of pictures during one encoding. Specifically, the 2D compatible video decoder 5603 decodes the number of pictures during one encoding starting from the N^{th} frame in the 2D compatible video stream generated in step S5703, and outputs (i) decoded picture data generated as a result of the decoding and (ii) 2D compatible video encoding information relating to the decoded picture data.

In step S5705, the differential video image generator 5605 generates differential video images for the number of pictures during one encoding. Specifically, the differential video image generator 5605 calculates the difference, pixel-by-pixel, between pictures in the decoded video images in the 2D compatible video stream and pictures in the right-view video images, the calculation being performed for the number of pictures during one encoding. Then, the differential video image generator 5605 applies the differential video image filter to the difference to generate differential video images.

In step S5706, the extended video encoder 5606 generates a portion of the extended video stream for the number of pictures during one encoding. Specifically, the extended video encoder 5606 determines a video attribute, a picture structure, etc., with reference to the 2D compatible video encoding information, compression-encodes the differential video images to generate the extended video stream.

In step S5707, the multiplexer 5607 converts the 2D compatible video stream and the extended video stream into PES packets, divides the PES packets into TS packets, and multiplexes the TS packets to generate a transport stream. N is then incremented by the number of pictures during one encoding, and processing returns to step S5701. This concludes the explanation of the flowchart.

Note that the number of pictures to be encoded in one compression encoding flow may be varied as necessary according to an encoding method or the like. Suppose, for example, that in the encoding method, the number of pictures reordered is two, and that the picture types are I1, P4, B2, B3, P7, B5, B6, . . . (the numbers indicating presentation order). If the number of pictures during one encoding is two, then the P4 picture cannot be processed, thus preventing encoding of B2 and B3. If on the other hand the number of pictures during one encoding is set to four, then the P4 picture can be processed, thus allowing encoding of B2 and B3. In other words, if the number of pictures reordered during video encoding is two, it is possible to eliminate the effect of reordering by setting the number of pictures during one encoding to four.

<2-3-2. Playback Device>

<Structure>

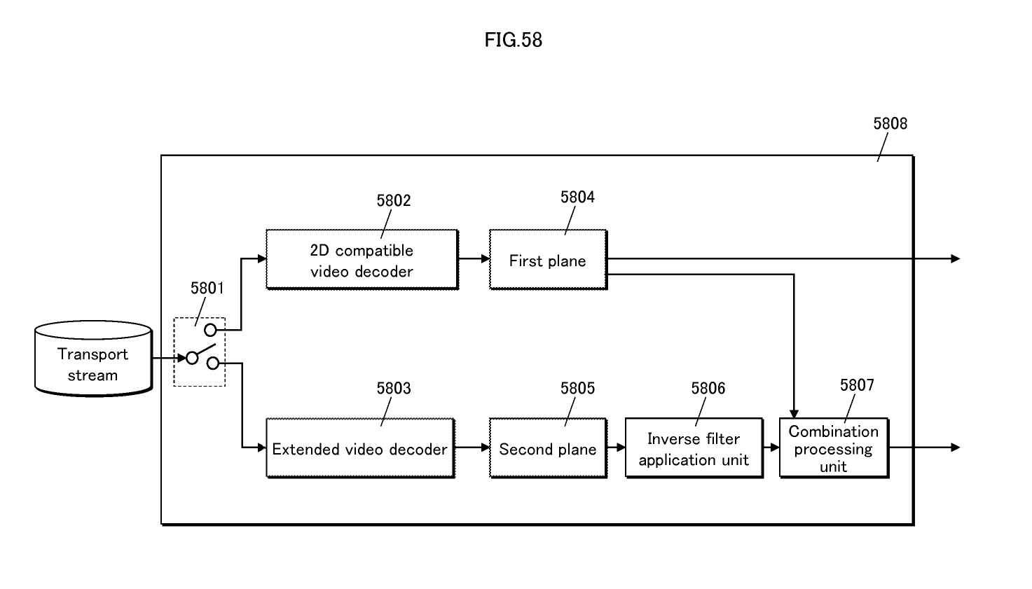

FIG. 58 illustrates the structure of a playback device 5808 for 3D images according to the present embodiment.

The playback device 5808 includes a PID filter 5801, a 2D compatible video decoder 5802, an extended video decoder 5803, a first plane 5804, a second plane 5805, an inverse filter application unit 5806, and a combination processing unit 5807.

The PID filter 5801 filters the packets of an input transport stream. Specifically, from among TS packets, the PID filter 5801 extracts TS packets whose PID matches any of PIDs necessary for playback, and transfers the TS packets thus extracted to the 2D compatible video decoder 5802 and the extended video decoder 5803 that need the TS packets. A PMT packet indicates which stream has which PID.

For example, suppose that the PID of the 2D compatible video stream is 0x1011, and the PID of the extended video stream is 0x1012. In this case, the PID filter 5801 extracts TS packets whose PID is 0x1011 and transfers the TS packets to the 2D compatible video decoder 5802. Also, the PID filter 5801 extracts TS packets whose PID is 0x1012, and transmits the TS packets to the extended video decoder 5803.

The first plane 5804 is a plane memory storing picture data that is decoded by the 2D compatible video decoder 5802 and output at the timing of the PTS.

The second plane 5805 is a plane memory storing picture data that is decoded by the extended video decoder 5803 and output at the timing of the PTS.

The 2D compatible video decoder 5802 and the extended video decoder 5803 have the same structure as a general decoder for a video codec of 2D video images (MPEG-2, MPEG-4 AVC, and the like). The 2D compatible video decoder 5802 and the extended video decoder 5803 do not differ in structure from the video decoder 2901 in Embodiment 1.

The inverse filter application unit 5806 applies a differential video image inverse filter to the decoded pictures in the second plane output from the extended video decoder 5803 at the timing of the PTS, and thereby generates differential pictures. The differential video image inverse filter used here is the differential video image inverse filter 4802 in FIG. 48.

The combination processing unit 5807 combines (adds), pixel-by-pixel, a differential picture generated by the inverse filter application unit 5806 and a decoded picture output to the first plane that have the same PTS, and thereby generates a combined picture.

The picture output to the first plane and the combined picture output by the combination processing unit 5807 are output appropriately according to the content of the stream. For example, when the 2D compatible video stream represents left-view video images, the picture stored in the first plane 5804 is output as a left-view video image, and the combined picture is output as a right-view video image. When the 2D compatible video stream represents right-view video images, the picture stored in the first plane 5804 is output as a right-view video image, and the combined picture is output as a left-view video image.

<Operations>

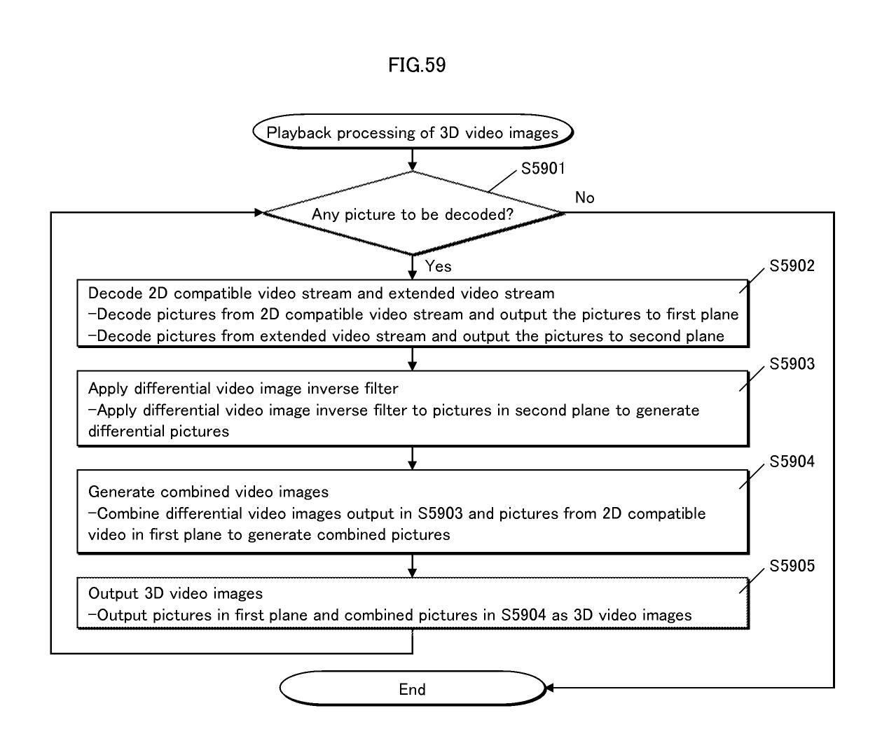

FIG. 59 is a flowchart showing the processing for decoding and outputting 3D video images performed by the playback device 5808 having the above structure.

In step S5901, the PID filter 5801 judges whether any transport stream to be decoded is input. If such a transport stream is input (step S5901: Yes), the PID filter 5801 filters TS packets to be decoded based on the PIDs, and transfers the TS packets to either the 2D compatible video decoder 5802 or the extended video decoder 5803. Processing then proceeds to step S5902. If there is no transport stream to be decoded (S5901: No), processing terminates.

In step S5902, the 2D compatible video decoder 5802 decodes pictures from the 2D compatible video stream and outputs the pictures to the first plane 5804. The extended video decoder 5803 decodes pictures from the extended video stream and outputs the pictures to the second plane 5805.

In step S5903, the inverse filter application unit 5806 applies the differential video image inverse filter to data stored in the second plane 5805, and thereby generates differential pictures.

In step S5904, the combination processing unit 5807 combines, pixel-by-pixel, the differential pictures output in step S5903 and the pictures from the 2D compatible video stored in the first plane 5804, and thereby generates combined pictures.

In step S5905, the playback device outputs the pictures stored in the first plane 5804 as 3D left-view video images, and outputs the combined pictures generated in step S5904 as 3D right-view video images.

<2-4. Modifications>

Although the present invention has been described based on the above embodiments, the present invention is not limited to such and can be modified without departing from the scope of the present invention.

(1) In the present embodiment, the 3D information descriptor shown in FIG. 51 includes the field for the playback format, whereby one playback format is selected from among the multiple playback formats. The following structure simplifies implementation of the switching method for the playback formats.

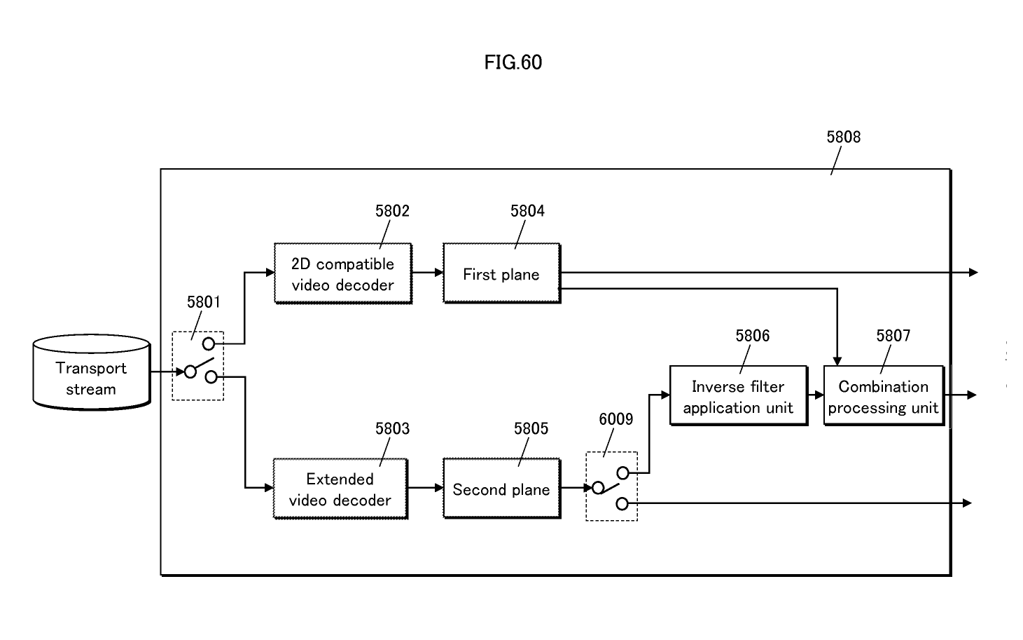

FIG. 60 is a block diagram showing the structure of a playback device according to the present modification.

The playback device shown in FIG. 60 basically has the same structure as the playback device shown in FIG. 58, but differs therefrom with respect to a differential video image combination switch 6009.

When the differential video image combination switch 6009 is ON, an input of the switch 6009 is connected to the inverse filter application unit 5806. In this way, output data from the second plane 5805 is transferred to the inverse filter application unit 5806. When the differential video image combination switch 6009 is OFF, the input of the switch 6009 is directly connected to an output of the playback device 5808. As a result, output data from the second plane 5805 is output as is.

According to the description in the field for the playback format, the playback device 5808 switches the differential video image combination switch 6009 between ON and OFF. This makes it possible to easily change a playback mode according to the playback format.

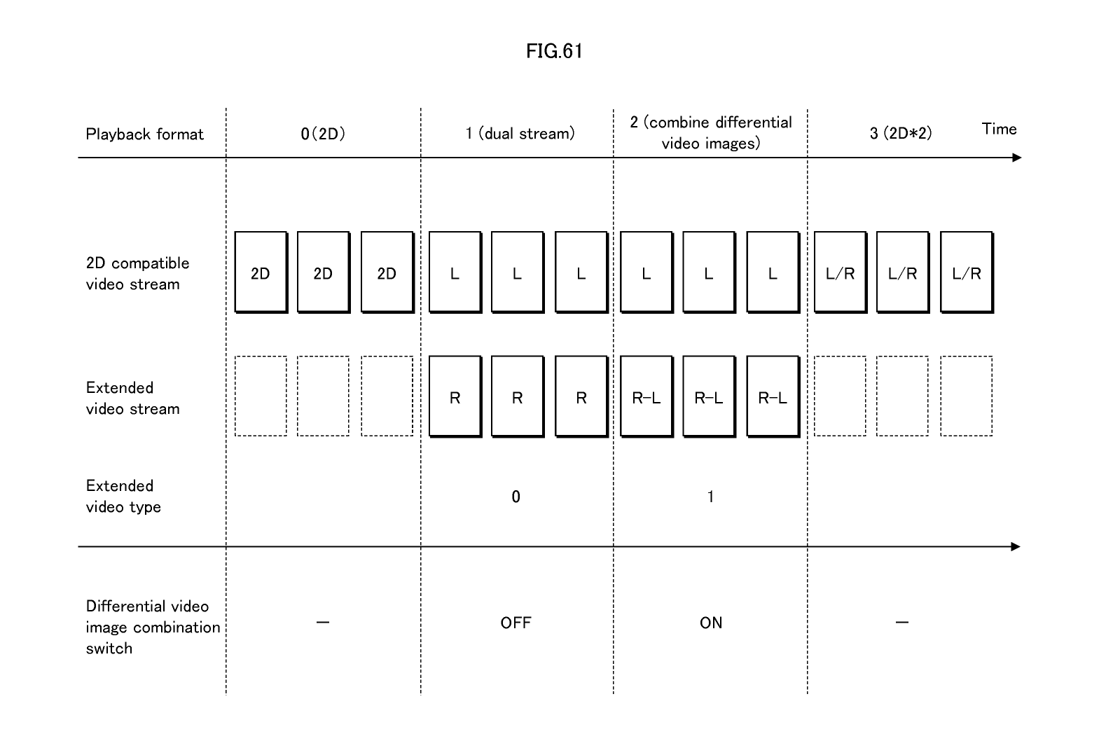

FIG. 61 illustrates an example of switching of the differential video image combination switch 6009.

FIG. 61 illustrates the “extended video type” and the “differential video image combination switch”, in addition to the content of FIG. 52. The “extended video type” in FIG. 61 indicates the value of the extended video type in the 3D stream descriptor as described with reference to FIG. 53. When the “playback format” is set to “0” or “3”, the playback device 5808 does not cause the extended video decoder 5803 to operate. The differential video image combination switch 6009 may be either ON or OFF. When the playback format is “1”, the extended video decoder 5803 operates, and the differential video image combination switch 6009 is set to OFF. This causes the pictures stored in the second plane 5805 to be output as right-view video images. When the playback format is set to “2”, the extended video decoder 5803 operates, and the differential video image combination switch is set to ON. In this way, the pictures stored in the second plane 5805 are transferred to the inverse filter application unit 5806. Subsequently, the combination processing unit 5807 combines the pictures to which the differential video image inverse filter is applied with the pictures stored in the first plane 5804. As described above, the playback device 5808 can easily switch the playback format by simply switching on and off the differential video image combination switch 6009.

(2) In the present embodiment, the difference between the decoded pictures from the 2D compatible video and the pictures of the right-view (or left-view) video images is calculated to generate the differential video images, as shown in the upper tier of FIG. 48. Instead, however, it is possible to calculate the difference between the pictures of the right-view video images and the pictures of the left-view video images.

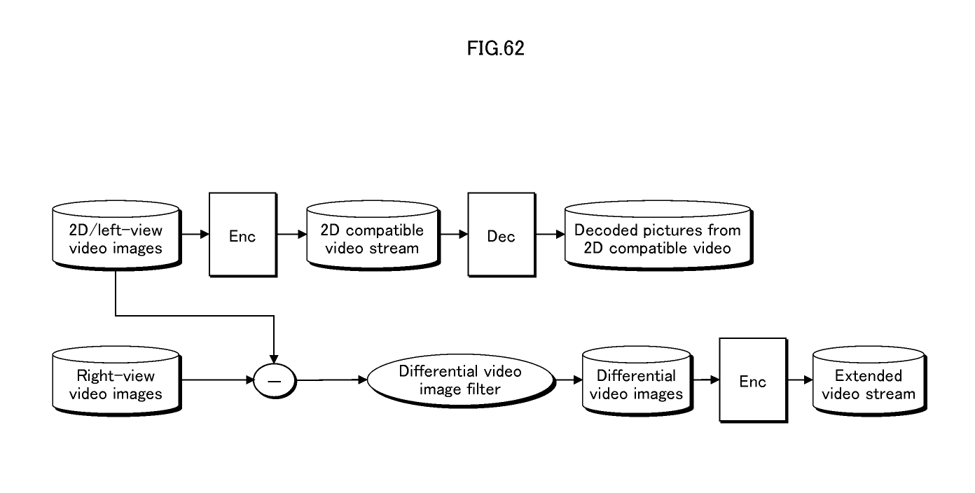

FIG. 62 illustrates an outline of a generation procedure of the 2D compatible video stream and the extended video stream, when the difference between the pictures of the right-view video images and the pictures of the left-view video images is calculated according to the present modification. First, the difference between the pictures of the left-view video images and the pictures of the right-view video images is calculated to generate differential video images. In this case, although compression distortion of the 2D compatible video stream at the time of combination processing cannot be avoided, data can be created more easily. Also, the decoding processing by the 2D compatible video decoder 5603 in the data creation device in FIG. 56 can be omitted. In this case, the 2D compatible video encoding information is generated by analyzing the 2D compatible video stream (only analyzing the syntax elements without decoding the pictures). Also, the pictures from the left-view video images are stored in the 2D compatible video frame memory 5604.

(3) Concerning the data creation device 5601 in FIG. 56 and the playback device 5808 in FIG. 58, a high-definition filter may be applied to the results of decoding the 2D compatible video stream.

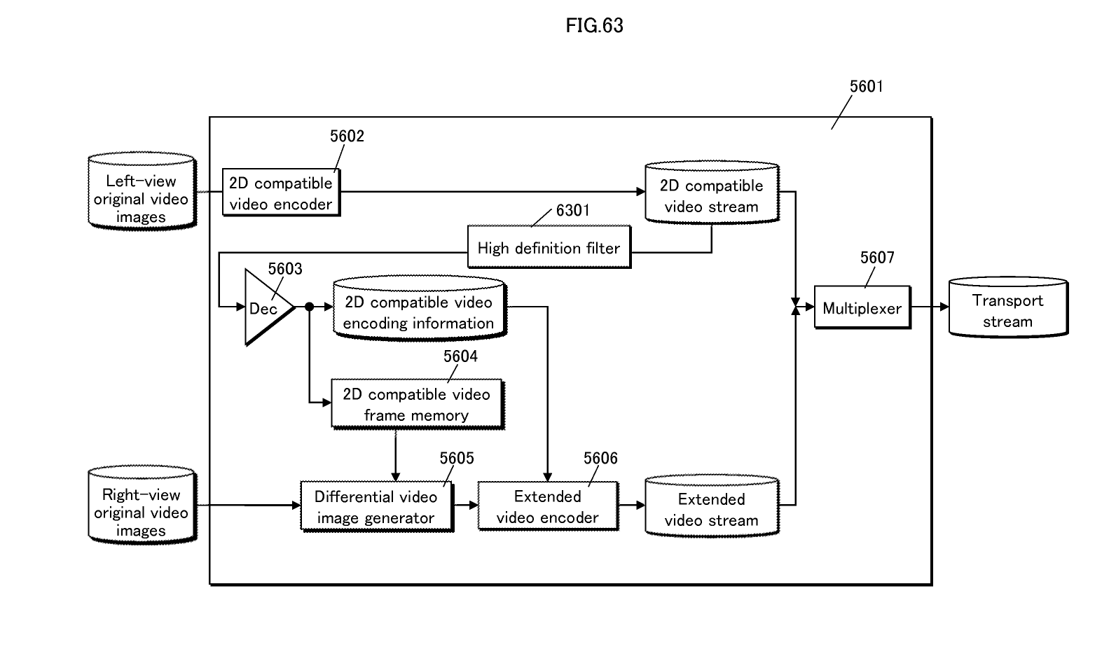

FIG. 63 illustrates the structure in which a high-definition filter 6301 is added to the data creation device 5601 in FIG. 56.

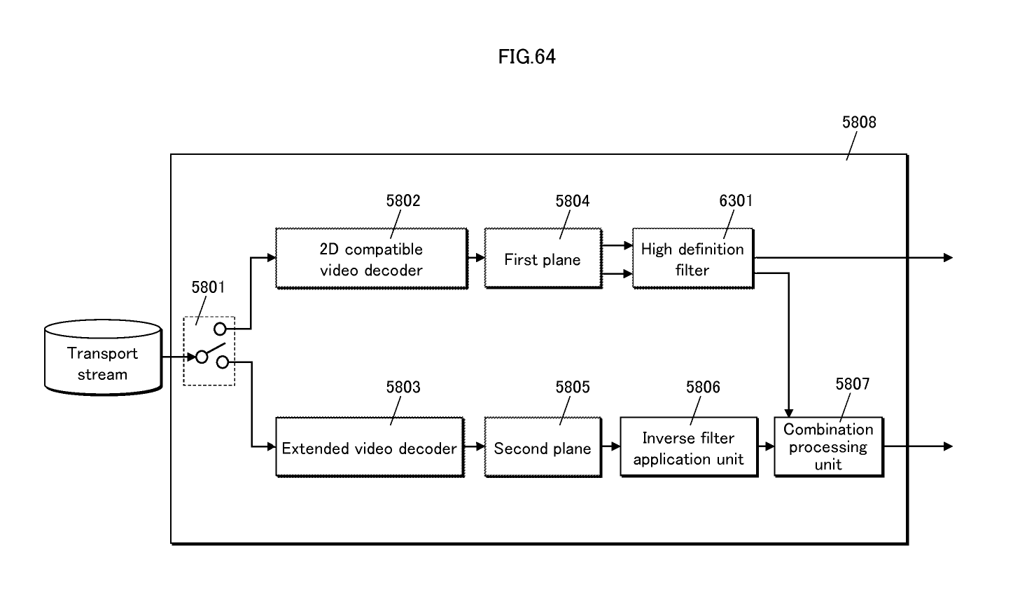

FIG. 64 illustrates the structure in which the high-definition filter 6301 is added to the playback device 5808 in FIG. 58. The high-definition filter 6301 is, for example, a deblocking filter to reduce block noise as stipulated by MPEG-4 AVC. Then, a field for an application flag indicating whether to apply (ON) the high-definition filter 6301 or not (OFF) is provided within a descriptor in the PMT, the supplementary data of a stream, or the like. When the high-definition filter 6301 is applied to the data creation device 5601 according to the present modification, the application flag is set to ON and included in a descriptor in the PMT, the supplementary data of a stream, or the like. The playback device 5808 according to the present modification receives a stream, and if the application flag in the stream indicates “ON”, the playback device 5808 applies the high-definition filter to the results of decoding the 2D compatible video stream. Adopting this structure increases definition of 3D video images, as well as definition of 2D video images in the 2D compatible video stream.

It is possible to provide a plurality of high-definition filters 6301, which are selectable based on the usage. In this case, an indicator other than the flag may be used to specify the type of the filter to be used.

(4) In the present embodiment, simply calculating the differential value for each pixel creates the necessity of adding a plus sign or a minus sign. As a result, the number of the numeral values represented by the same bit length (8 bits) is reduced by half. To avoid this problem, the differential video image filter for reducing the gradation accuracy of the pixels is applied to obtain 8-bit data. However, another method may be used so as not to reduce the amount of information.

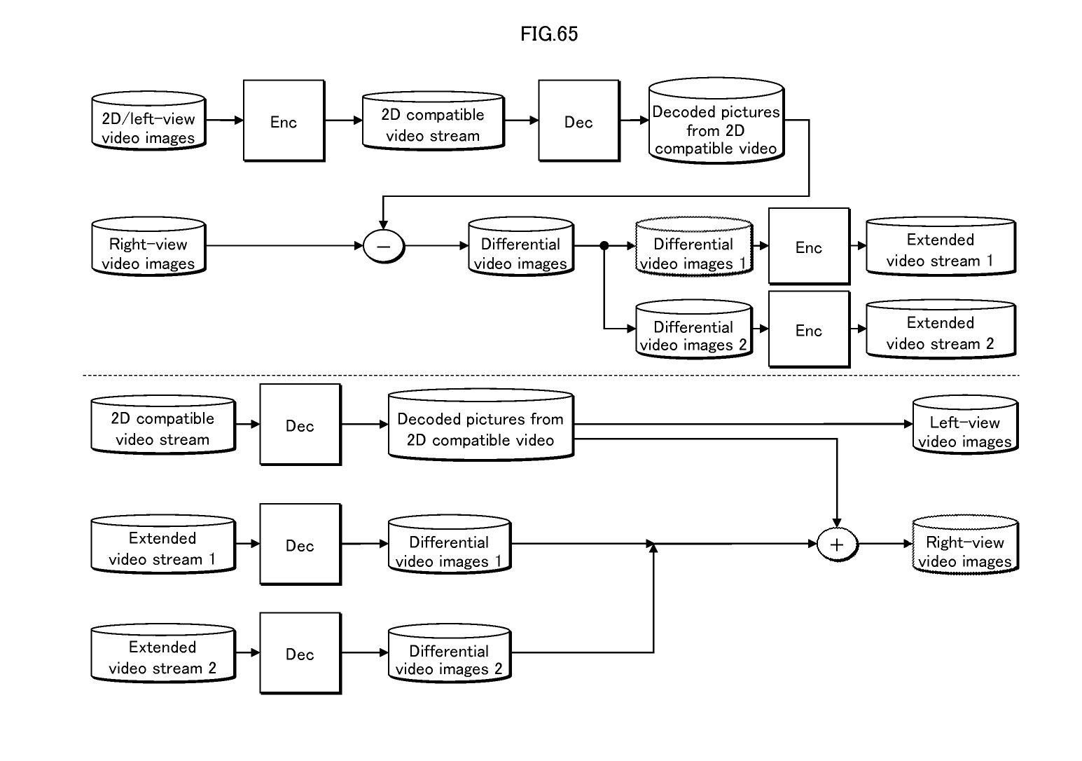

The upper tier of FIG. 65 illustrates an example of such a method. In this method, the differential video images are divided into two sets to be transferred.

Specifically, the differential video images are divided into two sets of video images (i.e., differential video images 1 and 2). These sets of video images are separately encoded into streams (i.e., extended video streams 1 and 2), and are then transferred.

Examples of a method for dividing into two different streams include the following: (a) dividing the differential video images into video images representing absolute values and video images representing sign values; (b) dividing the differential video images into video images made up of eight most significant bits of each pixel of the differential video images and video images made up of eight least significant bits of each pixel of the differential video images; (c) dividing the differential video images into video images of positive values (=MAX(R−L, 0)) and video images of negative values (=MIN (R−L, 0)); and (d) dividing the differential video images into video images having a value between −127 to +127 and video images having a value between −255 to −128 or between +128 to +255.

A method for combining the divided differential video images is shown in the lower tier of FIG. 65. First, the extended video streams 1 and 2 are decoded into the differential video images 1 and 2. Then, combination processing, which is the inverse processing to the above method for dividing into two streams, is performed to generate differential video images. Finally, the differential video images thus generated are combined with the decoded pictures from the 2D compatible video.

In the present embodiment, the differential video images are compressed by video encoding. However, the differential video images may be compressed by using a different method other than video encoding. For example, run-length compression or JPEG may be employed. In the case of video images representing only the sign values as described in the aforementioned method (a) for dividing, it is sufficient to use the run-length compression to compress the video images as the amount of information is small.

(5) There are other ways of not reducing the amount of information, other than those described in the modification (4) above. For example, the following structure allows for generation of the differential video images without reducing the gradation accuracy of pixels.

Suppose that the differential value between a decoded picture from the 2D compatible video stream and a right-view video image is calculated to generate a differential video image as described in the upper tier of FIG. 48, and that the value is negative. Then, in the case of 8-bit color, the value 256, which is the eighth power of two, is added to the negative differential value. Then, after the decoded picture from the 2D compatible video stream is combined with the decoded picture from the extended video stream as described in the lower tier of FIG. 48, 8-bit masking is applied to the resultant combined picture.

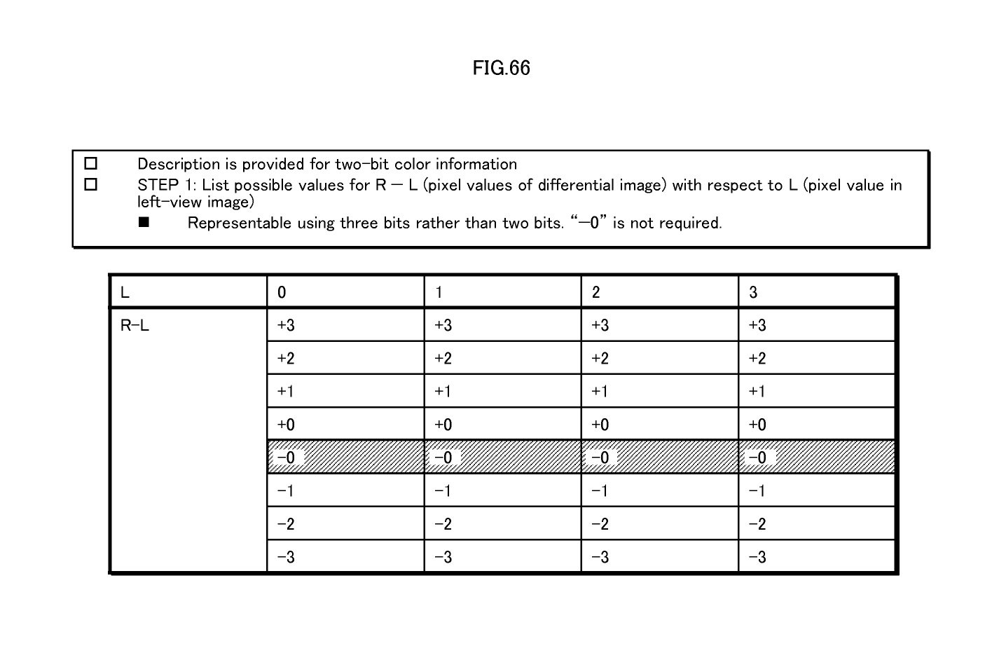

The following is a detailed description of the operation in the above structure, with reference to FIGS. 66 to 69.

To simplify the description, color information is assumed to be two bits instead of eight bits.

Provided that L denotes the value of a pixel in a left-view image and R denotes the value of a pixel in a right-view image, possible values that L and R can take are 0, 1, 2, and 3.

FIG. 66 illustrates the correspondence between the possible values for L and the possible values for R−L.

(STEP1)

There are seven possible values, i.e., −3 to +3, for the value of R−L. Accordingly, the value of R−L is representable using three bits.

(STEP2)

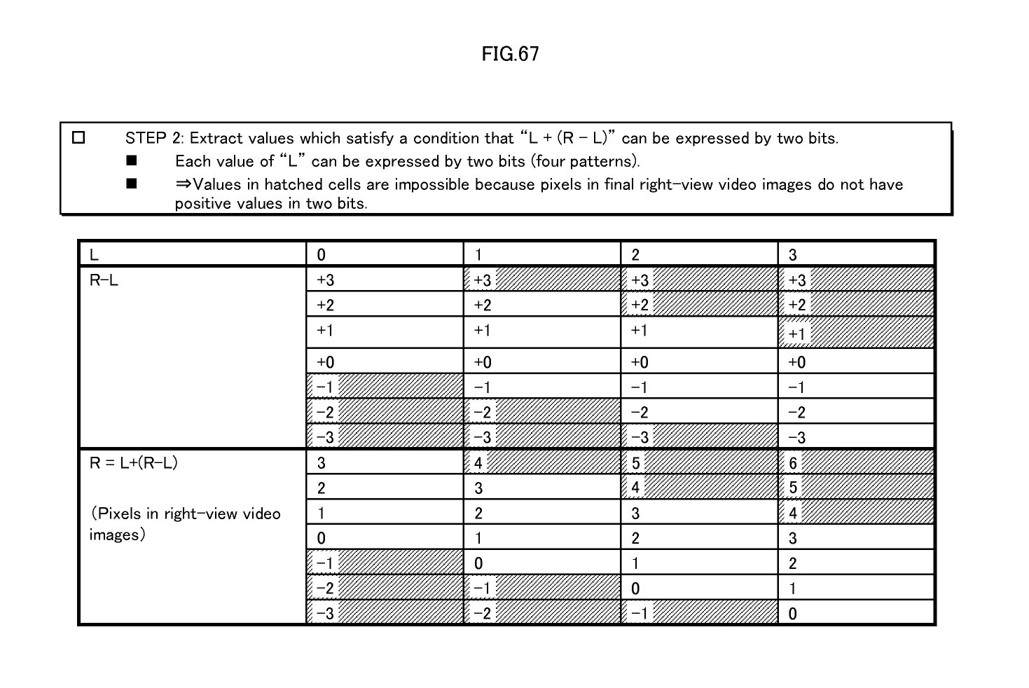

FIG. 67 illustrates the correspondence between the possible values for L and the possible values for R−L and R.

Here, possible values for R (=L+(R−L)) are 0 to 3. Accordingly, when L is 0, R−L takes a value from 0 to +3. When L is 1, R−L takes a value from −1 to +2. When L is 2, R−L takes a value from −2 to +1. When L is 3, R−L takes a value from −3 to 0.

(STEP3)

To represent R−L by two bits, in a case where the value of R−L is negative, 4 (=2²) is added to R−L and R so that the value of R−L is converted to a positive value.

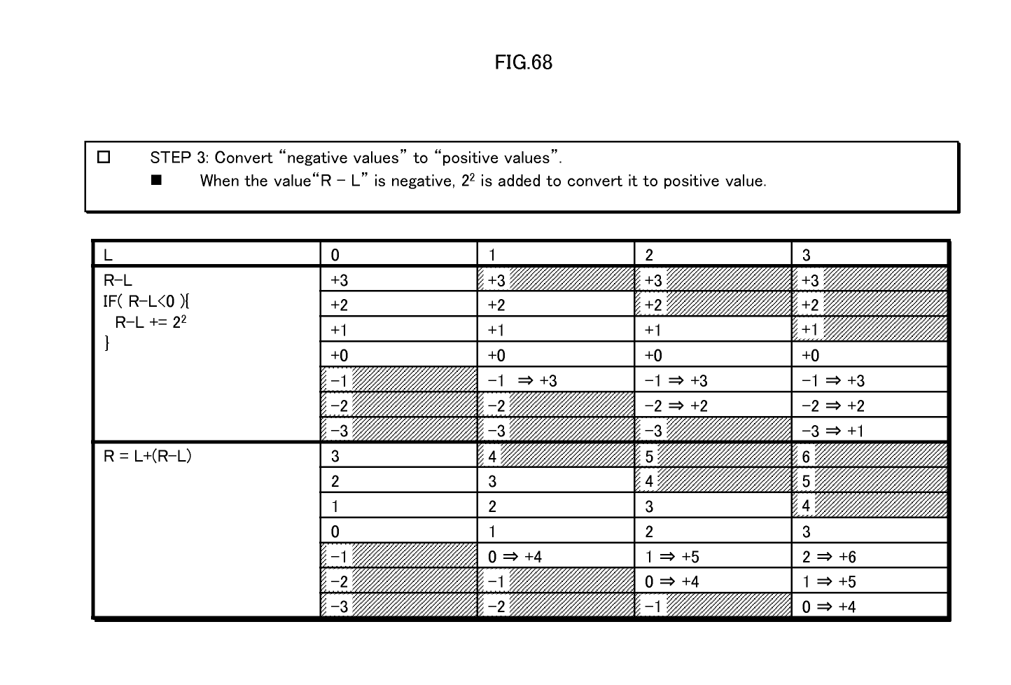

FIG. 68 illustrates the correspondence between the possible values for L, and the possible values for R-L and R when the above conversion is applied thereto.

(STEP4)

Next, R is masked with (2²−1). As a result, R is represented by two bits.

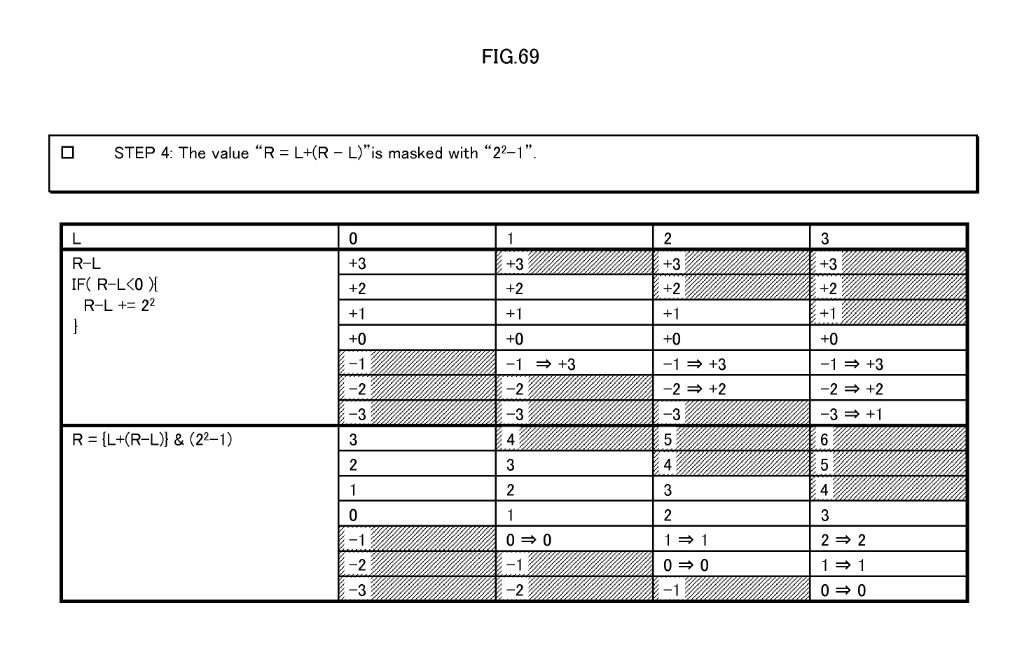

FIG. 69 illustrates the correspondence between the possible values for L, and the possible values for R−L and R when the above conversion is applied thereto.

With the above operation, L, R−L, and R are each represented by two bits, without increasing the number of bits and without missing any information.

(6) In the above embodiment, when the differential video images are generated, the differential video image filter collectively halves the color gradation accuracy. However, it is merely an example, and the color gradation accuracy may vary depending on a pixel value.

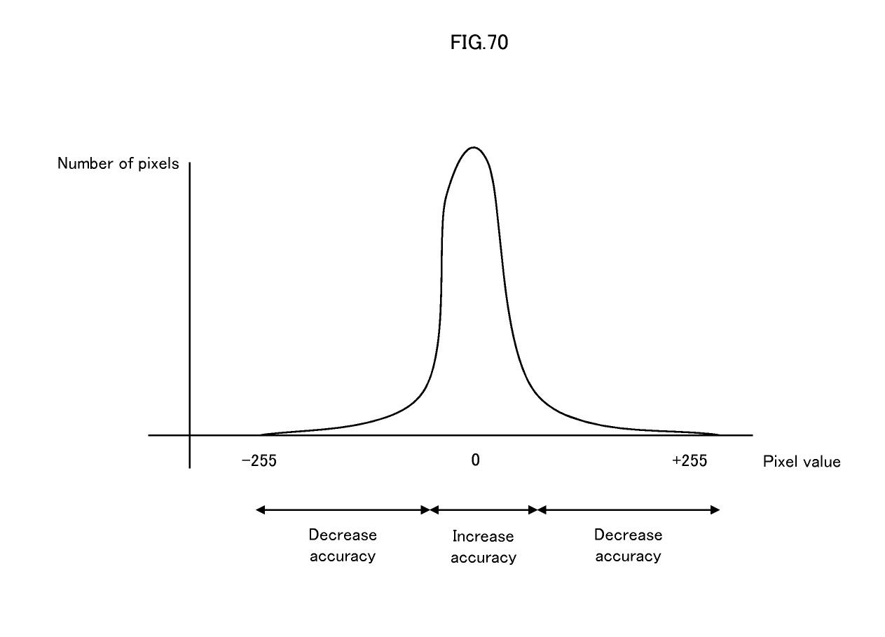

FIG. 70 is an example of a graph showing the correspondence between a pixel value within a picture in the differential video images and the number of pixels having the pixel value. The left-view video images tend to be highly similar to the right-view video images. Accordingly, as shown in the graph of FIG. 70, in a picture of the differential video images, a large number of pixels have a small absolute value.

Accordingly, the differential video image filter may increase the color gradation accuracy in a range in which the number of pixels having the same pixel value is large and the pixels have small absolute values (e.g., −50 to +50), and may decrease the color gradation accuracy in a range in which the number of pixels having the same pixel value is small and the pixels have large absolute values (e.g., −255 to −51, +51 to +255). More specifically, with respect to pixels having small absolute values (e.g., in a range of −50 to +50), color gradation accuracy is adjusted on a 1-step basis, and with respect to pixels having large absolute values (e.g., in a range of −255 to −50 or +51 to +255), color gradation accuracy is adjusted on a 3-step basis”.

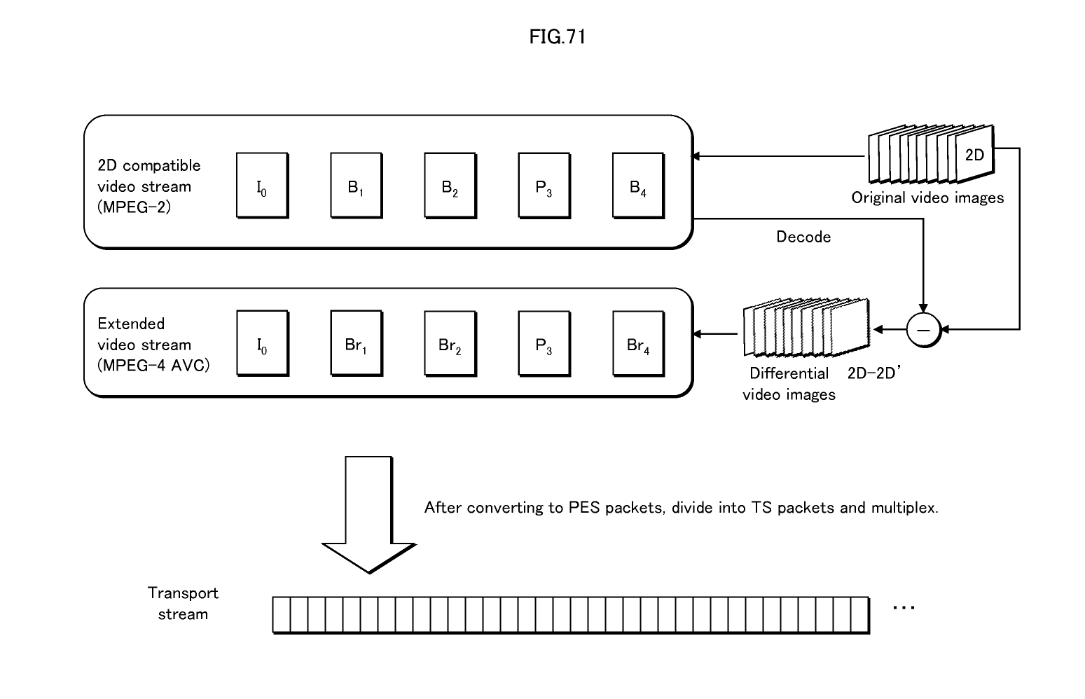

(7) In the present embodiment, the differential video images are the difference between the decoded pictures (left-view) from the 2D compatible video stream and the right-view video images. However, the differential video images may be the difference between the decoded pictures from the 2D compatible video stream and the original video images in the 2D compatible video stream, as shown in FIG. 71. In this case, the differential video images store distortion caused by the compression of the 2D compatible video stream. Variations in pixel values are small. Accordingly, in the case of eight-bit color, for example, a one-bit sign and a seven-bit value (−128 to +128) can sufficiently represent color, thus eliminating the need of the differential video image filter. The playback device can play back high-definition video images by combining video images obtained by decoding the 2D compatible video stream and differential video images obtained by decoding the extended video stream.

(8) In the present embodiment, the differential video images are the difference between the decoded pictures (left-view) from the 2D compatible video stream and the right-view video images. However, in parallax video images, the position of an object in a right-view video image is horizontally offset from the position of the object in a left-view video image. Accordingly, calculating the difference between the right-view video image and the left-view video image as they are may result in the range of pixel values in a differential video image becoming wider. Accordingly, the range of pixel values may be narrowed as follows.

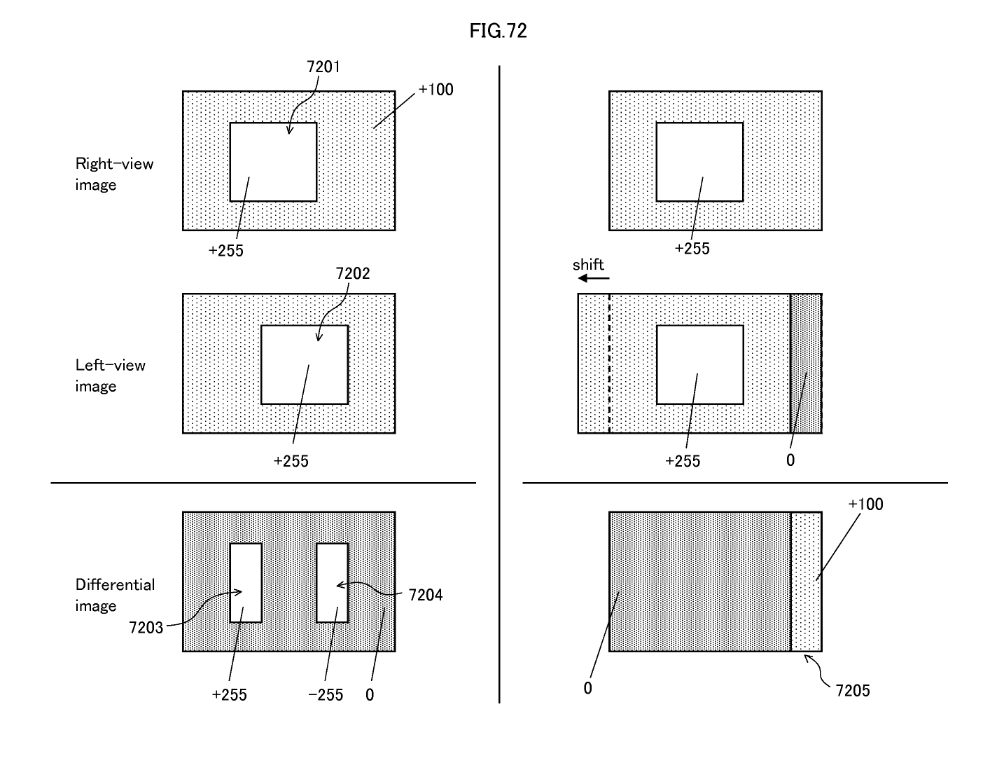

The left side of FIG. 72 illustrates a case where the range of pixel values is wide.

In the left side of FIG. 72, the right-view image and the left-view image each include the background (represented by dots) having a pixel value of 100. Also, the right-view image and the left-view image respectively include an object 7201 and an object 7202 (shown in white rectangles) that each have a pixel value of +255. When the difference between the left-view image and the right-view image is calculated, two portions shown in rectangles in the differential image, i.e., portions 7203 and 7204, have a differential value of +255 and a differential value −255, respectively. As a result, the range of pixel values becomes wide.

Accordingly, as shown in the right side of FIG. 72, an image (e.g., left-view image) is shifted according to the offset of the position of the object so as to correct the offset, and thereafter the image is combined. In this case, a rectangle 7205 in the differential image has a differential value of +100, but all the other portions in the differential image have a differential value of 0. This narrows the range of pixel values.

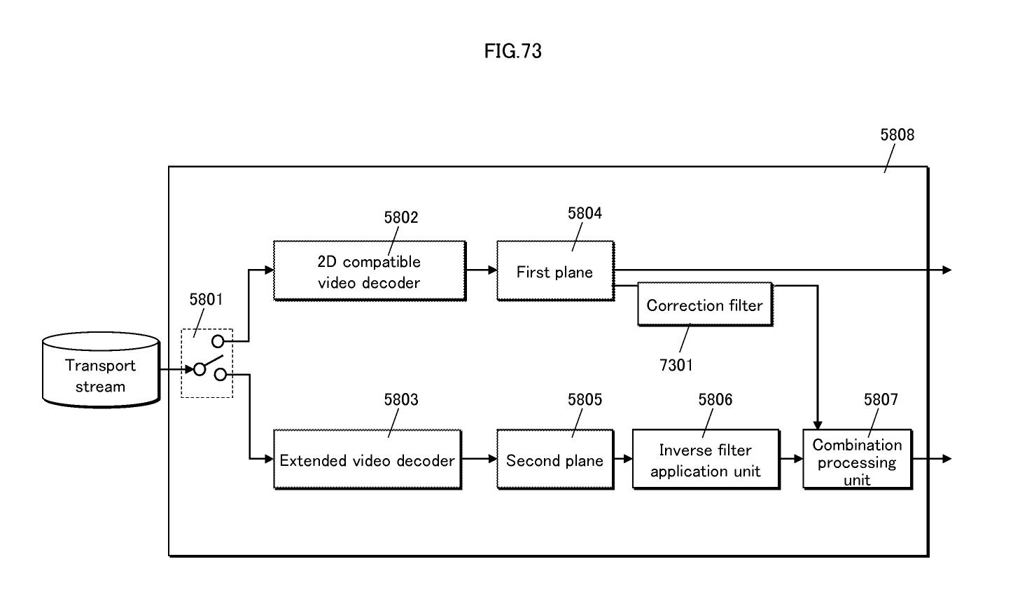

FIG. 73 illustrates the structure of a playback device according to the present modification, which includes a correction filter 7301 for narrowing the range of pixel values as described in FIG. 72.

As described in FIG. 72, the correction filter 7301 calculates a shift amount between images represented by pictures stored in the first plane 5804 and images represented by pictures stored in the second plane 5805, and shifts the pictures in the first plane 5804 by the shift amount. The shift amount may be determined with use of a parameter such as the parallax between a left-eye view point and a right-eye view point. Also, instead of simple shifting, pictures from the 2D compatible video stream may be corrected by image processing which is effective to narrow the range of pixel values. Thereafter, the differential video images may be generated. In this case, the correction filter 7301 in the playback device as shown in FIG. 73 is replaced with an image processing unit for performing image processing.

(9) In the present embodiment, a differential video image is the difference between a decoded picture (left-view) from the 2D compatible video stream and a right-view original video image with the same presentation time. However, the decoded picture may be selected from among a plurality of pictures along the time axis of the 2D compatible video stream. In this case, the combination processing unit 5807 of the playback device 5808 may include a buffer that stores the plurality of pictures of the 2D compatible video stream, so that the playback device 5808 can select, from among the pictures, a picture to be combined with the differential video image.

(10) As a modification of the present embodiment, it is possible to use the 2D compatible video stream and an extended video stream having the double-speed frame rate.

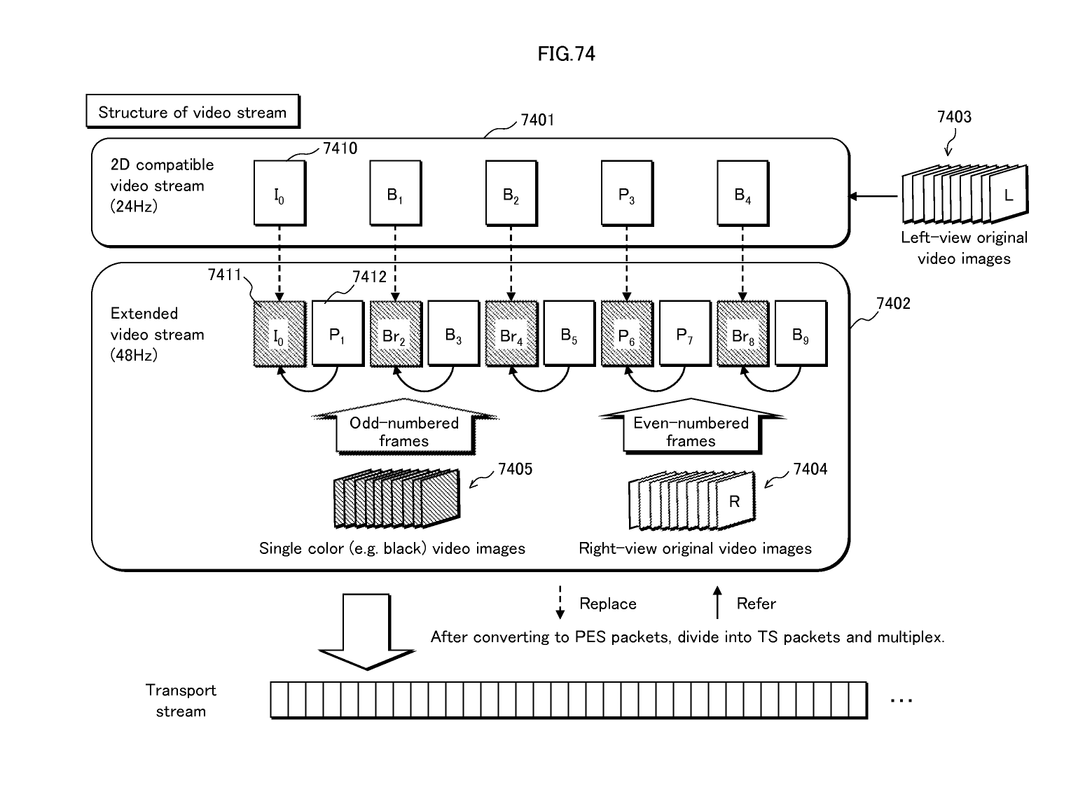

FIG. 74 illustrates the structure of video streams in the present modification.

In this case, left-view original video images 7403 are stored in the 2D compatible video stream 7401. Then, single-color video images 7405, such as black screens, are compression-encoded into odd-numbered frames in an extended video stream 7402, and right-view original video images 7404 are compression-encoded into even-numbered frames in the extended video stream 7402.

Compression-encoding of an even-numbered frame of the extended video stream is performed with reference to a decoded picture from the 2D compatible video stream corresponding to a frame time immediately before the frame time of the even-numbered frame itself (own presentation time (PTS)−half frame time). For example, when a frame 7412 is compression-encoded, a frame 7410 of the 2D compatible video stream, which corresponds to a frame 7411 immediately before the frame 7412, is referred to.

The syntax elements specify that the pictures in the even-numbered frames compression-encoded in the extended video stream 7402 refer to the pictures of odd-numbered frames. The PTS/DTS of an odd-numbered frame of the 2D compatible video stream is the same as the PTS/DTS of a corresponding odd-numbered frame in the extended video stream.

When receiving the streams having the aforementioned structure, the playback device replaces the decoded pictures of the odd-numbered frames in the extended video stream 7402 with the decoded pictures from the 2D compatible video stream 7401 having the same DTSs and PTSs. In this way, during decoding of the pictures of the even-numbered frames in the extended video stream 7402, the playback device can refer to the decoded pictures in the 2D compatible video stream 7401 which are coded with a different codec. Then, the playback device outputs the decoded video images from the 2D compatible video stream 7401 as left-view video images, and outputs the decoded video images of the even-numbered frames from the extended video stream 7402 as right-view video images, thereby playing back 3D video images.

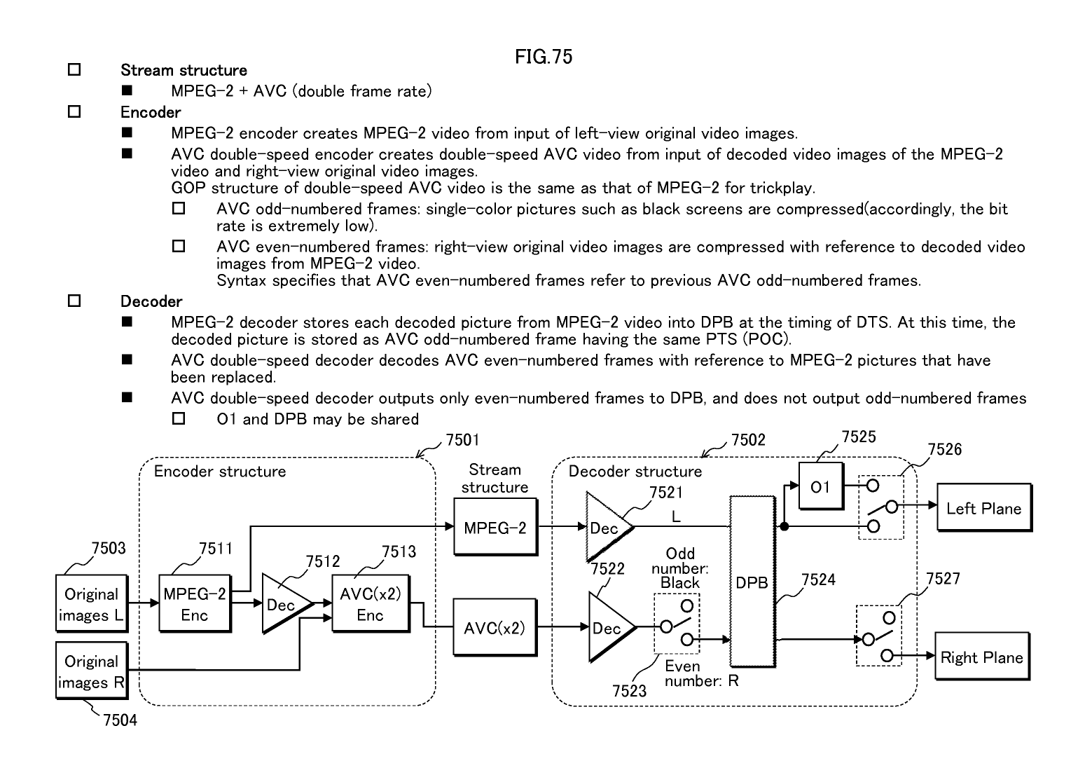

FIG. 75 illustrates a specific example with the 2D compatible video stream being MPEG-2 video and the double-speed extended video stream being MPEG-4 AVC video.

An encoder 7501 includes an MPEG-2 encoder 7511, a decoder 7512, and an AVC double-speed encoder 7513.

The MPEG-2 encoder 7511 creates MPEG-2 video from input of left-view original video images 7503.

The AVC double-speed encoder 7513 creates double-speed AVC video from input of (i) decoded video images of the MPEG-2 video decoded by the decoder 7512 and (ii) right-view original video images 7504. The double-speed AVC video has the same GOP structure as the MPEG-2 video to facilitate the realization of trickplay. As the odd-numbered frames of the AVC video, single-color pictures, such as black screens, are compressed. When the single-color pictures are compressed, the resultant compressed data can be represented at an extremely low bit rate. As the even-numbered frames of the AVC video, the right-view original video images are compressed with reference to the decoded video images from the MPEG-2 video. The syntax elements specify that each of the even-numbered frames refers to the odd-numbered frame immediately before the even-numbered frame.

A decoder 7502 includes a MPEG-2 decoder 7521, a AVC double-speed decoder 7522, a selector 7523, a DPB 7524, a reordering buffer O1 (7525), a selector 7526, and a selector 7527.

The MPEG-2 decoder 7521 stores each decoded picture from the MPEG-2 video into the DPB 7524 at the timing of the DTS. At this time, the decoded picture is stored as the AVC odd-numbered frame having the same PTS (POC).

The AVC double-speed decoder 7522 decodes the AVC even-numbered frames with reference to the MPEG-2 pictures that have been replaced. Then, the AVC double-speed decoder outputs only the even-numbered frames to the DPB 7524, and does not output the odd-numbered frames. Note that the O1 (7525) and the DPB 7524 may be shared.

Also, instead of 3D video images, video images at a high frame rate may be simply output. In that case, out of the video images at a high frame rate, the odd-numbered video images may be stored in the 2D compatible video stream and the even-numbered video images may be stored in the dependent-view video stream in the extended video stream. The decoded pictures from the 2D compatible video stream and the decoded pictures from the base-view video stream can be switched around in the same manner as described above. Playback of all the frames of the extended video stream enables playback of video images at a high frame rate.

### 3. Modifications

Embodiments of the data creation device and the playback device pertaining to the present invention have been described thus far, but the present invention is in no way limited to the data creation device and the playback device as described in the aforementioned embodiments. The exemplified data creation device and the playback device may be modified as described below.

(1) The following describes structures and effects of a data creation device as a video encoding device in one embodiment of the present invention and a playback device as a video playback device in one embodiment of the present invention.

One aspect of the present invention is a video encoding device for compression-encoding multi-view video images including first view video images and second view video images, comprising: a first encoding unit configured to generate a stream in an MPEG-2 format by compression-encoding the first view video images; a second encoding unit configured to generate a stream conforming to an MPEG-4 AVC format by compression-encoding pictures of the second view video images, each picture of the second view video images being compression-encoded with reference to a picture, from among pictures in the stream in the MPEG-2 format, to be presented at the same time as the picture of the second view video images; and a transmission unit configured to transmit the streams generated by the first encoding unit and the second encoding unit.

In the generation of the stream conforming to the MPEG-4 AVC format, the second encoding unit may include, in the stream, information indicating that the pictures referenced during the compression encoding are included in the stream in the MPEG-2 format.

With this structure, when a playback device plays back the stream conforming to the MPEG-4 AVC format with reference to a descriptor, the playback device can refer to the pictures included in the stream in the MPEG-2 format.

Also, the second encoding unit may select, from among the pictures in the stream in the MPEG-2 format, a picture whose PTS (Presentation Time Stamp) has the same value as a PTS of a picture targeted for encoding in the second view video images, and may use the picture thus selected as the picture referenced during the encoding of the picture in the second view video images.

This structure allows a playback device to specify a picture to be referenced, from among the pictures in the stream in the MPEG-2 format, with reference to the PTS.

Also, the first encoding unit and the second encoding unit may compression-encode the first view video images and the second view video images with the same aspect ratio respectively, and may include information indicating the aspect ratio in the stream in the MPEG-2 format and in the stream conforming to the MPEG-4 AVC format respectively.

This structure allows a playback device to specify the aspect ratio of the first video images and the second video images with reference to a descriptor.

Also, the second encoding unit may store in advance an amount of parallax between a viewpoint pertaining to the first view video images and a viewpoint pertaining to the second view video images, and may shift each picture of the second view video images by the amount of parallax before compression-encoding the picture.

This structure allows for further reduction of the amount of information regarding the stream conforming to the MPEG-4 AVC format.

The stream generated by the second encoding unit may have a double frame rate as compared to the stream generated by the first encoding unit, may include odd-numbered frames and even-numbered frames, the odd-numbered frames being the second view video images that have been compression-encoded, and the second encoding unit may further compression-encode third view video images with reference to the pictures of the second view video images, and may store, as the even-numbered frames, the third view video images thus compression-encoded into the stream conforming to the MPEG-4 AVC format.

This structure allows for compression-encoding of original video images having a double frame rate as compared to a predetermined frame rate, while maintaining playback compatibility with the original video images having the predetermined frame rate played back by a playback device configured for the MPEG-2 standard and suppressing an increase in the band area necessary for transfer as compared to conventional technologies.

One aspect of the present invention is a video encoding method for compression-encoding multi-view video images including first view video images and second view video images, comprising: a first encoding step of generating a stream in an MPEG-2 format by compression-encoding the first view video images; a second encoding step of generating a stream conforming to an MPEG-4 AVC format by compression-encoding pictures of the second view video images, each picture of the second view video images being compression-encoded with reference to a picture, from among pictures in the stream in the MPEG-2 format, to be presented at the same time as the picture of the second view video images; and a transmission step of transmitting the streams generated in the first encoding step and the second encoding step.

One aspect of the present invention is a video encoding program for causing a computer to function as a video encoding device that compression-encodes multi-view video images including first view video images and second view video images, the video encoding program causing the computer to function as: a first encoding unit configured to generate a stream in an MPEG-2 format by compression-encoding the first view video images; a second encoding unit configured to generate a stream conforming to an MPEG-4 AVC format by compression-encoding pictures of the second view video images, each picture of the second view video images being compression-encoded with reference to a picture, from among pictures in the stream in the MPEG-2 format, to be presented at the same time as the picture of the second view video images; and a transmission unit configured to transmit the streams generated by the first encoding unit and the second encoding unit.

This structure allows for compression-encoding of multi-view video images (e.g., 3D video images) in a manner that suppresses an increase in the band necessary for transfer as compared to conventional technologies, while maintaining playback compatibility with first view video images (e.g., 2D video images) played back by a playback device configured for the MPEG-2 standard.

One aspect of the present invention is a video playback device for decoding multi-view video images including first and second view video images and playing back the decoded multi-view video images, the video playback device comprising: a first acquisition unit configured to acquire a stream in an MPEG-2 format generated as a result of compression-encoding of the first view video images; a second acquisition unit configured to acquire a stream conforming to an MPEG-4 AVC format generated as a result of compression-encoding of pictures of the second view video images, each picture of the second view video images having been compression-encoded with reference to a picture, from among pictures of the stream in the MPEG-2 format, presented at the same time as the picture of the second view video images; a first decoding unit configured to obtain the first view video images by decoding the stream in the MPEG-2 format; a second decoding unit configured to obtain the second view video images by decoding each picture of the stream conforming to the MPEG-4 AVC format with reference to a picture, from among pictures decoded by the first decoding unit, to be presented at the same time as the picture of the stream conforming to the MPEG-4 AVC; and a playback unit configured to play back multi-view video images including the first view video images obtained by the first decoding unit and the second view video images obtained by the second decoding unit.

One aspect of the present invention is a video playback method for decoding multi-view video images including first and second view video images and playing back the decoded multi-view video images, the video playback method comprising: a first acquisition step of acquiring a stream in an MPEG-2 format generated as a result of compression-encoding of the first view video images; a second acquisition step of acquiring a stream conforming to an MPEG-4 AVC format generated as a result of compression-encoding of pictures of the second view video images, each picture of the second view video images having been compression-encoded with reference to a picture, from among pictures of the stream in the MPEG-2 format, presented at the same time as the picture of the second view video images; a first decoding step of obtaining the first view video images by decoding the stream in the MPEG-2 format; a second decoding step of obtaining the second view video images by decoding each picture of the stream conforming to the MPEG-4 AVC format with reference to a picture, from among pictures decoded in the first decoding step, to be presented at the same time as the picture of the stream conforming to the MPEG-4 AVC; and a playback step of playing back multi-view video images including the first view video images obtained in the first decoding step and the second view video images obtained in the second decoding step.

One aspect of the present invention is a video playback program for causing a computer to function as a video playback device that decodes multi-view video images including first and second view video images and plays back the decoded multi-view video images, the video playback program causing the computer to function as: a first acquisition unit configured to acquire a stream in an MPEG-2 format generated as a result of compression-encoding of the first view video images; a second acquisition unit configured to acquire a stream conforming to an MPEG-4 AVC format generated as a result of compression-encoding of pictures of the second view video images, each picture of the second view video images having been compression-encoded with reference to a picture, from among pictures of the stream in the MPEG-2 format, presented at the same time as the picture of the second view video images; a first decoding unit configured to obtain the first view video images by decoding the stream in the MPEG-2 format; a second decoding unit configured to obtain the second view video images by decoding each picture of the stream conforming to the MPEG-4 AVC format with reference to a picture, from among pictures decoded by the first decoding unit, to be presented at the same time as the picture of the stream conforming to the MPEG-4 AVC; and a playback unit configured to play back multi-view video images including the first view video images obtained by the first decoding unit and the second view video images obtained by the second decoding unit.

This structure allows for decoding and playback of a stream in which multi-view video images (e.g., 3D video images) are compression-encoded in a manner that suppresses an increase in the band necessary for transfer as compared to conventional technologies, while playback compatibility with first view video images (e.g., 2D video images) played back by a playback device configured for the MPEG-2 standard is maintained.

(2) A part or all of the components constituting each of the above-mentioned devices may be composed of a single system LSI. The system LSI is a super-multifunctional LSI manufactured by integrating a plurality of components on a single chip, and is specifically a computer system including a microprocessor, a ROM (Read Only Memory), and a RAM (Random Access Memory). A computer program is stored in the RAM. The microprocessor operates in accordance with the computer program, thereby enabling the system LSI to realize its functions.

The LSI may be referred to as an IC (Integrated Circuit), a system LSI, a super LSI or an ultra LSI in accordance with the degree of integration.

Also, an integrated circuit may not necessarily be manufactured as an LSI, but may be realized by a dedicated circuit or a general-purpose processor. It is possible to use an FPGA (Field Programmable Gate Array) that is programmable after an LSI is produced, or a reconfigurable processor that allows the reconfiguration of the connection and setting of circuit cells in an LSI.

Furthermore, if a technology of integration that can substitute for LSIs appears by a progress of semiconductor technology or another derivational technology, it is possible to integrate the function blocks with use of the technology.

(3) Each of the data creation device and the playback device described above may be a computer system including a microprocessor, a ROM, a RAM, and a hard disk unit. The RAM or the hard disk unit stores a computer program. The microprocessor operates in accordance with the computer program, thereby enabling the device to realize its functions. The computer program is composed of a plurality of instruction codes indicating instructions to the computer so as to realize a predetermined function.

(4) The present invention may be methods representing the procedures of the aforementioned processes. The present invention may be a computer program that allows a computer to realize the methods, or may be a digital signal representing the computer program.

Furthermore, the present invention may be a computer-readable recording medium storing thereon the computer program or the digital signal. Examples of such a recording medium include a flexible disk, a hard disk, a CD-ROM, an MO, a DVD, a DVD-ROM, a DVD-RAM, a BD (Blu-ray Disc), and a semiconductor memory. Furthermore, the present invention may be the computer program or the digital signal recorded on any of the aforementioned recording media.

Furthermore, the present invention may be the computer program or the digital signal transmitted via an electric communication line, a wireless or wired communication line, a network of which the Internet is representative, or a data broadcast.

(5) The above-mentioned embodiments and modifications may be appropriately combined with one another.

### INDUSTRIAL APPLICABILITY

The video encoding device and the video playback device according to the present invention are suitable as devices constituting a system that realizes encoding, transmission, and playback of 3D video images while maintaining playback compatibility with conventional playback devices that play back streams in MPEG-2 format.

### REFERENCE SIGNS LIST

5601 data creation device
5602 2D compatible video encoder
5603 2D compatible video decoder
5604 2D compatible video frame memory
5605 differential video image generator
5606 extended video encoder
5607 multiplexer
5801 PID filter
5802 2D compatible video decoder
5803 extended video decoder
5804 first plane
5805 second plane
5806 differential video image inverse filter
5807 combination processing unit
5808 playback device

1-11. (canceled)

12. A video encoding device for compression-encoding first video images and second video images, comprising:
a first encoding unit configured to generate a stream in a first encoding format by compression-encoding the first video images;
a decoding unit configured to obtain decoded pictures by decoding the stream in the first encoding format, the decoded pictures constituting a compatible video stream;
a generation unit configured to calculate differential values indicating differences between the decoded pictures constituting the compatible video stream and pictures of the second video images, and to generate differential signals indicating the differential values; and
a second encoding unit configured to generate a stream in a second encoding format by compression-encoding the differential signals.

13. A video encoding method for compression-encoding video images including first video images and second video images, comprising:
a first encoding step of generating a stream in a first encoding format by compression-encoding the first video images;
a decoding step of obtaining decoded pictures by decoding the stream in the first encoding format, the decoded pictures constituting a compatible video stream;
a generation step of calculating differential values indicating differences between the decoded pictures constituting the compatible video stream and pictures of the second video images, and generating differential signals indicating the differential values; and
a second encoding step of generating a stream in a second encoding format by compression-encoding the differential signals.

14. A video encoding program for causing a computer to function as a video encoding device that compression-encodes video images including first video images and second video images, the video encoding program causing the computer to function as:
a first encoding unit configured to generate a stream in a first encoding format by compression-encoding the first video images;
a decoding unit configured to obtain decoded pictures by decoding the stream in the first encoding format, the decoded pictures constituting a compatible video stream;
a generation unit configured to calculate differential values indicating differences between the decoded pictures constituting the compatible video stream and pictures of the second video images, and to generate differential signals indicating the differential values; and
a second encoding unit configured to generate a stream in a second encoding format by compression-encoding the differential signals.

15. A video playback device for decoding video images including first and second video images and playing back the decoded video images, the video playback device comprising:
an acquisition unit configured to acquire a stream in a first encoding format generated as a result of compression-encoding of the first video images and a stream in a second encoding format generated as a result of compression-encoding of differential signals, the differential signals indicating differences between decoded pictures constituting a compatible video stream and pictures of the second video images, the decoded pictures being obtained by decoding of the stream in the first encoding format;
a first decoding unit configured to obtain the first video images by decoding the stream in the first encoding format;
a second decoding unit configured to obtain the differential signals by decoding the stream in the second encoding format;
a combining unit configured to obtain the second video images by combining pictures of the first video images obtained by the first decoding unit and pictures represented by the differential signals obtained by the second decoding unit; and
an output unit configured to output video images including the first video images obtained by the first decoding unit and the second video images obtained by the combining unit.

16. A video playback method for decoding video images including first and second video images and playing back the decoded video images, the video playback method comprising:
an acquisition step of acquiring a stream in a first encoding format generated as a result of compression-encoding of the first video images and a stream in a second encoding format generated as a result of compression-encoding of differential signals, the differential signals indicating differences between decoded pictures constituting a compatible video stream and pictures of the second video images, the decoded pictures being obtained by decoding of the stream in the first encoding format;
a first decoding step of obtaining the first video images by decoding the stream in the first encoding format;
a second decoding step of obtaining the differential signals by decoding the stream in the second encoding format;
a combining step of obtaining the second video images by combining pictures of the first video images obtained in the first decoding step and pictures represented by the differential signals obtained in the second decoding step; and
an output step of outputting video images including the first video images obtained in the first decoding step and the second video images obtained in the combining step.

17. A video playback program for causing a computer to function as a video playback device that decodes video images including first and second video images and plays back the decoded video images, the video playback program causing the computer to function as:
an acquisition unit configured to acquire a stream in a first encoding format generated as a result of compression-encoding of the first video images and a stream in a second encoding format generated as a result of compression-encoding of differential signals, the differential signals indicating differences between decoded pictures constituting a compatible video stream and pictures of the second video images, the decoded pictures being obtained by decoding of the stream in the first encoding format;
a first decoding unit configured to obtain the first video images by decoding the stream in the first encoding format;
a second decoding unit configured to obtain the differential signals by decoding the stream in the second encoding format;
a combining unit configured to obtain the second video images by combining pictures of the first video images obtained by the first decoding unit and pictures represented by the differential signals obtained by the second decoding unit; and
an output unit configured to output video images including the first video images obtained by the first decoding unit and the second video images obtained by the combining unit.
